(19) United States
(12) Patent Application Publication
(10) Pub. No.: US 2025/0132079 A1
(43) Pub. Date: Apr. 24, 2025

(54) MAGNETIC DEVICES WITH LOCALIZED DEMAGNETIZATION AND METHODS OF ASSEMBLING THE SAME

(71) Applicant: Quadrant International, Inc., San Diego, CA (US)

(72) Inventors: Christina H. Chen, San Jose, CA (US); George E. Mizzell, JR., Hoover, AL (US); Yan Shen, Cupertino, CA (US); Min Zou, San Jose, CA (US)

(21) Appl. No.: 18/718,280

(22) PCT Filed: Jun. 13, 2022
(86) PCT No.: PCT/US2022/033258

§ 371 Date: Jun. 10, 2024

Related U.S. Application Data
(60) Provisional application No. 63/265,205, filed on Dec. 10, 2021.

(51) Int. Cl. H01F 7/02; H01F 1/057; H01F 41/02

(52) U.S. Cl. CPC H01F 7/021; H01F 1/057; H01F 41/0253

(57) ABSTRACT

A vibrating magnetic assembly includes a housing, a first magnet positioned within the housing and having a first permeance coefficient (P_{c1}), a second magnet positioned within the housing and spaced from the first magnet, the second magnet having a second permeance coefficient (P_{c2}), and a third magnet positioned within the housing between the first and second magnets. The third magnet has a third permeance coefficient (P_{c3}) and is reciprocable between the first and second magnets to cause vibration. A ratio of P_{c3}:P_{c1} and P_{c3}:P_{c2} is greater than 1 such that the N pole of the third magnet is magnetically attracted to the N pole of the first magnet, and the S pole of the third magnet is magnetically attracted to the S pole of the second magnet when the third magnet is positioned within a threshold distance of the respective first or second magnet.

### CROSS-REFERENCE TO RELATED APPLICATIONS

This application claims priority to U.S. Provisional Patent Application Ser. No. 63/265,205, filed on Dec. 10, 2021, the disclosure of which is hereby incorporated by reference in its entirety.

### BACKGROUND

This disclosure is directed to magnetic assemblies, and, more specifically, to magnetic assemblies comprising unequally sized permanent magnet pairs or electromagnet pairs exhibiting unique behaviors of like poles or unlike poles.

A basic law of magnetism is that like poles repel one another, and unlike poles attract each other. Even though Gauss' law for magnetic flux density (B-field) indicates that there is no free magnetic charge, the effective bound magnetic charges can be defined locally from the magnetization of magnetic material. The distribution of positive magnetic charge can be defined as the “north pole”, and correspondingly, the negative magnetic charge can be defined as the “south pole”. The interaction between the local magnetic charges is governed by Coulomb's law so that like charges (e.g., north-north or south-south pole pairs) repel and unlike charges (e.g., north-south pole pairs) attract.

### BRIEF SUMMARY

In one aspect, a vibrating magnetic assembly includes a housing, a first magnet positioned within the housing, the first magnet having a first permeance coefficient (P_{c1}) and comprising a magnetic north (N) pole and a magnetic south (S) pole, a second magnet positioned within the housing and spaced from the first magnet, the second magnet having a second permeance coefficient (P_{c2}) and comprising an N pole and an S pole, where the second magnet is oriented such that the N pole of the first magnet faces the S pole of the second magnet, and a third magnet positioned within the housing between the first and second magnets. The third magnet has a third permeance coefficient (P_{c3}) and comprises an N pole and an S pole. The third magnet is reciprocable between the first and second magnets to cause vibration and is oriented such that the N pole of the third magnet faces the N pole of the first magnet. A ratio of P_{c3}:P_{c1} is greater than 1 and a ratio of P_{c3}:P_{c2} is greater than 1 such that the N pole of the third magnet is magnetically attracted to the N pole of the first magnet when positioned within a threshold distance of the first magnet, and the S pole of the third magnet is magnetically attracted to the S pole of the second magnet when positioned within a threshold distance of the second magnet.

In another aspect, an electric generator includes a housing, a first magnet positioned within the housing, the first magnet having a first permeance coefficient (P_{c1}) and comprising a magnetic north (N) pole and a magnetic south (S) pole, a second magnet positioned within the housing, the second magnet having a second permeance coefficient (P_{c2}) and comprising an N pole and an S pole, where the second magnet is moveable within the housing relative to the first magnet and oriented such that like poles of the first magnet and the second magnet face one another, and an electrically conductive coil extending around a path of motion traversed by the second magnet when the second magnet is moved relative to the first magnet, where the second magnet generates an electrical current through the electrically conductive coil when the second magnet is moved relative to the first magnet. A ratio of P_{c2}:P_{c1} is greater than 1 such that the like poles of the first magnet and second magnet are magnetically attracted to one another when the second magnet is positioned within a threshold distance of the first magnet.

In yet another aspect, a method of assembling a vibrating magnetic assembly includes positioning a first magnet within a housing, the first magnet having a first permeance coefficient (P_{c1}) and comprising a magnetic north (N) pole and a magnetic south (S) pole, positioning a second magnet within the housing such that the second magnet is spaced from the first magnet, the second magnet having a second permeance coefficient (P_{c2}) and comprising an N pole and an S pole, where the second magnet is oriented such that the N pole of the first magnet faces the S pole of the second magnet, providing a third magnet having a third permeance coefficient (P_{c3}) and comprising an N pole and an S pole, wherein a ratio of P_{c3}:P_{c1} is greater than 1 and a ratio of P_{c3}:P_{c2} is greater than 1, and positioning the third magnet within the housing adjacent the first magnet such that the N pole of the third magnet faces the N pole of the first magnet and the N poles of the first magnet and the third magnet are magnetically attracted to one another, where the third magnet is reciprocable between the first magnet and the second magnet to cause vibration.

In yet another aspect, a magnetic assembly includes a first plate comprising at least one tapered magnet having a base secured to the first plate and extending outward from the first plate to a tip, the at least one tapered magnet having a first permeance coefficient (P_{c1}) and comprising a magnetic north (N) pole and a magnetic south (S) pole, and a second plate comprising at least one ring magnet defining an opening sized and shaped to receive the tip of the at least one tapered magnet therein, the at least one ring magnet having a second permeance coefficient (P_{c2}) and comprising an N pole and an S pole. The at least one tapered magnet and the at least one ring magnet are oriented with like poles facing one another. A ratio of P_{c1}:P_{c2} is greater than 1 such that, when the tip of the at least one tapered magnet is inserted into the opening of the at least one ring magnet beyond a threshold depth, a magnetic repulsive force between the at least one ring magnet and the at least one tapered magnet transitions to a magnetic attractive force to releasably secure the second plate to the first plate.

In yet another aspect, a magnetic assembly includes at least one tapered magnet having a base and extending to a tip, the at least one tapered magnet having a first permeance coefficient (P_{c1}) and comprising a magnetic north (N) pole and a magnetic south (S) pole, and at least one ring magnet having an opening sized and shaped to receive the tip of the at least one tapered magnet therein, the at least one ring magnet having a second permeance coefficient (P_{c2}) and comprising an N pole and an S pole. The at least one tapered magnet and the at least one ring magnet are oriented with like poles facing one another. A ratio of P_{c1}:P_{c2} is greater than 1 such that, when the tip of the at least one tapered magnet is inserted into the opening of the at least one ring magnet beyond a threshold depth, a magnetic repulsive force between the at least one ring magnet and the at least one tapered magnet transitions to a magnetic attractive force to releasably secure the at least one ring magnet to the at least one tapered magnet.

In yet another aspect, a method of assembling a magnetic assembly includes providing a first plate comprising at least one tapered magnet having a base secured to the first plate and extending outward from the first plate to a tip, the at least one tapered magnet having a first permeance coefficient (P_{c1}) and comprising a magnetic north (N) pole and a magnetic south (S) pole, and securing a second plate to the first plate, the second plate comprising at least one ring magnet defining an opening sized and shaped to receive the tip of the at least one tapered magnet therein, the at least one ring magnet having a second permeance coefficient (P_{c2}) and comprising an N pole and an S pole. The at least one tapered magnet and the at least one ring magnet are oriented with like poles facing one another, and a ratio of P_{c1}:P_{c2} is greater than 1. Securing the second plate to the first plate comprises inserting the tip of the at least one tapered magnet into the opening of the at least one ring magnet beyond a threshold depth such that a magnetic repulsive force between the at least one ring magnet and the at least one tapered magnet transitions to a magnetic attractive force to releasably secure the second plate to the first plate.

In yet another aspect, a magnetic assembly includes a first magnet having a first permeance coefficient (P_{c1}) and comprising a magnetic north (N) pole and a magnetic south (S) pole, where the first magnet includes a center axis, and a moveable magnetic body comprising a second magnet moveable relative to the first magnet, the moveable magnetic body having a second permeance coefficient (P_{c2}) and comprising an N pole and an S pole. The first magnet and the moveable magnetic body are oriented with like poles facing one another, and a ratio of P_{c2}:P_{c1} is greater than 1. The moveable magnetic body is moveable between a first position, in which the second magnet is located adjacent the first magnet and the second magnet is axially aligned with the center axis of the first magnet such that the second magnet is magnetically attracted to the first magnet, and a second position, in which the second magnet is axially offset from the center axis of the first magnet such that the first magnet magnetically repels the second magnet.

In yet another aspect, a magnetic assembly includes a housing extending from a first end to a second end, a first magnet positioned within the housing, the first magnet having a first permeance coefficient (P_{c1}) and comprising a magnetic north (N) pole and a magnetic south (S) pole, wherein the first magnet includes a center axis, a moveable magnetic body positioned within the housing between the first magnet and the second end and moveable relative to the first magnet, the moveable magnetic body comprising a second magnet, wherein the moveable magnetic body has a second permeance coefficient (P_{c2}) and comprises an N pole and an S pole, the moveable magnetic body oriented such that like poles of the first magnet and the moveable magnetic body face one another, and a guide positioned within the housing and extending longitudinally from the first magnet to the second end, the guide defining a first channel aligned with the center axis of the first magnet and a second channel that is axially offset from the center axis, where the first channel and the second channel are sized and shaped to allow the moveable magnetic body to move therethrough. A ratio of P_{c2}:P_{c1} is greater than 1 such that the like poles of the first magnet and the moveable magnetic body are magnetically attracted to one another when the second magnet is positioned within a threshold distance of the first magnet.

In yet another aspect, a method of assembling a magnetic assembly includes providing a first magnet having a first permeance coefficient (P_{c1}) and comprising a magnetic north (N) pole and a magnetic south (S) pole, where the first magnet includes a center axis, providing a moveable magnetic body including a second magnet, the moveable magnetic body having a second permeance coefficient (P_{c2}) and including an N pole and an S pole, where a ratio of P_{c2}:P_{c1} is greater than 1, and positioning the moveable magnetic body at a first position adjacent the first magnet such that like poles of the first magnet and the moveable magnetic body face each other and the second magnet is axially aligned with the center axis of the first magnet such that the second magnet is magnetically attracted to the first magnet. The moveable magnetic body is moveable relative to the first magnet from the first position to a second position in which the second magnet is axially offset from the center axis of the first magnet such that the first magnet magnetically repels the second magnet.

In yet another aspect, a container assembly includes a container extending from a first end to a second end, the container defining an opening at the first end and comprising a first set of magnets spaced circumferentially about the opening, each magnet of the first set having a first permeance coefficient (P_{c1}) and comprising a magnetic north (N) pole and a magnetic south (S) pole, and a cap comprising a second set of magnets spaced circumferentially about a central axis of the cap, each magnet of the second set of magnets having a second permeance coefficient (P_{c2}) and comprising an N pole and an S pole, where a ratio of P_{c2}:P_{c1} is greater than 1. The cap is releasably couplable to the container via magnetic interaction between the first set of magnets and the second set of magnets, where each magnet of the second set is axially aligned with a respective magnet of the first set to form a pair of aligned magnets when the cap is releasably coupled to the container. For each pair of aligned magnets, the magnet of the first set and the magnet of the second set are oriented with like poles facing one another.

In yet another aspect, a container assembly includes a container extending from a first end to a second end, the container defining an opening at the first end and comprising at least one first magnet positioned adjacent the opening, the at least one first magnet having a first permeance coefficient (P_{c1}) and comprising a magnetic north (N) pole and a magnetic south (S) pole, and a cap comprising at least one second magnet having a second permeance coefficient (P_{c2}) and comprising an N pole and an S pole, where a ratio of P_{c2}:P_{c1} is greater than 1. The at least one first magnet and the at least one second magnet of the second set are oriented with like poles facing one another. The cap is rotatable relative to the container between a first position, in which the at least one second magnet is axially aligned with and magnetically attracted to the at least one first magnet to secure the cap to the container, and a second position, in which the at least one second magnet is axially offset from and magnetically repels the at least one first magnet to release the cap from the container.

In yet another aspect, a method of assembling a container assembly includes coupling a first set of magnets to a container, the container extending from a first end to a second end and defining an opening at the first end, where the magnets of the first set of magnets are spaced circumferentially about the opening, each magnet of the first set of magnets having a first permeance coefficient (P_{c1}) and including a magnetic north (N) pole and a magnetic south (S) pole, coupling a second set of magnets to a cap such that the magnets of the second set are spaced circumferentially about a central axis of the cap, where each magnet of the second set of magnets has a second permeance coefficient (P_{c2}) and includes an N pole and an S pole, where a ratio of P_{c2}:P_{c1} is greater than 1, and releasably coupling the cap to the container via magnetic interaction between the first set of magnets and the second set of magnets by axially aligning each magnet of the second set of magnets with a respective magnet of the first set to form a pair of aligned magnets where, for each pair of aligned magnets, the magnet of the first set and the magnet of the second set are oriented with like poles facing one another.

In yet another aspect, a method includes positioning a first magnetic patterner relative to a second magnetic patterner to define a space therebetween, where the first magnetic patterner includes a first non-magnetic holder and at least one first magnet supported by the first holder and the second magnetic patterner includes a second non-magnetic holder and at least one second magnet supported by the second holder. The at least one first magnet extends longitudinally from a first end including a magnetic north (N) pole to a second end including a magnetic south (S) pole, and the at least one second magnet extends longitudinally from a first end including an N pole to a second end including an S pole. The first magnetic patterner and the second magnetic patterner are positioned with the N pole of the at least one first magnet oriented facing the S pole of the at least one second magnet. The method further includes positioning a third magnet within the space between the first magnetic patterner and the second magnetic patterner, where the third magnet extends from a first surface including an N pole to a second surface including an S pole, and the third magnet is oriented with the N pole of the third magnet facing the N pole of the at least one first magnet and the S pole of the third magnet facing the S pole of the at least one second magnet. The method further includes creating a localized area of reversed magnetic polarity on the third magnet by positioning the first magnetic patterner adjacent the first surface of the third magnet and the second magnetic patterner adjacent the second surface of the third magnet such that the at least one first magnet is axially aligned with the at least one second magnet.

In yet another aspect, a magnetic assembly includes a first magnetic patterner comprising a first non-magnetic holder and at least one first magnet supported by the first holder, the at least one first magnet extending longitudinally from a first end comprising a magnetic north (N) pole to a second end comprising a magnetic south (S) pole, a second magnetic patterner spaced from the first magnetic patterner and comprising a second non-magnetic holder and at least one second magnet supported by the second holder, the at least one second magnet extending longitudinally from a first end comprising an N pole to a second end comprising an S pole, where the first magnetic patterner and the second magnetic patterner are positioned with the N pole of the at least one first magnet oriented facing the S pole of the at least one second magnet, and a support plate positioned between the first patterner and the second patterner and adapted to receive a third magnet thereon. The at least one first magnet is axially aligned with the at least one second magnet and at least one of the first magnetic patterner and the second magnetic patterner is moveable towards the support plate such that, when the first and second magnetic patterners are positioned adjacent the support plate, the at least one first magnet and the at least one second magnet create a localized area of reversed magnetic polarity on the third magnet positioned on the support plate.

In yet another aspect, a magnetic assembly includes a first set of magnets, each magnet of the first set extending longitudinally from a first end comprising a magnetic north (N) pole and a second end comprising a magnetic south (S) pole, a second set of magnets spaced from the first set of magnets, each magnet of the second set extending longitudinally from a first end comprising an N pole and a second end comprising an S pole, where each magnet of the first set is axially aligned with one of the magnets of the second set and where the first set of magnets and the second set of magnets are oriented such that, for each pair of aligned magnets, the N pole of the magnet of the first set faces the S pole of the magnet of the second set, and a support plate positioned between the first set of magnets and the second set of magnets and adapted to receive a third magnet thereon. At least one of the first set of magnets and the second set of magnets is moveable towards the support plate such that, when the first set of magnets and the second set of magnets are positioned adjacent the support plate, the first set of magnets and the second set of magnets create a multipole-pattern on the third magnet by creating a plurality of localized areas of reversed magnetic polarity on the third magnet.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a graph illustrating B-H curves of N55 magnets, N48SH magnets, and SmCo30 magnets, in the 2^{nd} quadrant and part of the 3^{rd} quadrant of the graph.

FIG. 2 is a schematic illustrating a testing process for determining force v. gap behavior of a pair of magnets, where four forces, F₁, F₂, F₃, and F₄, are recorded sequentially against a respective gap d₁, d₂, d₃, and d₄ between the pair of magnets, and where the forces F₁ and F₄ correspond to a magnetic north (N) pole→magnetic south (S) pole pairing of the pair of magnets and the forces F₂ and F₃ correspond to an N pole→←N pole pairing (i.e., like poles oriented facing one another) of the pair of magnets.

FIG. 3 is a schematic of a testing sequence for scanning the surface flux at an N-pole side and an S-pole side of a first magnet, where the N-pole side and the S-pole side of the first magnet are scanned at Step 1 after an N pole→S pole pairing of the first magnet with a second magnet, and the N-pole side and the S-pole side of the first magnet are scanned at Step 2 after an N pole→←N pole pairing of the first magnet with the second magnet.

FIG. 4 illustrates four graphs that each include several force (F₁, F₂, and F₄) v. gap (d) curves for a pair of unequally sized N55 magnets having a permeance coefficient ratio (P_{c1}/P_{c2} or P_{c1}:P_{c2}) as shown, where a negative force value indicates a magnetic repelling force and a positive force value indicates magnetic attractive force. The curves were generated using the testing process shown in FIG. 2.

FIGS. 5 and 6 are graphs illustrating force (F₂) v. gap (d) curves of N55 magnet pairs with varying permeance coefficient ratios (P_{c1}/P_{c2} or P_{c1}:P_{c2}).

FIGS. 7 and 8 are graphs illustrating force (F₂) v. gap (d) curves of N48SH magnet pairs with varying permeance coefficient ratios (P_{c1}/P_{c2} or P_{c1}:P_{c2}).

FIGS. 9 and 10 are graphs illustrating force (F₂) v. gap (d) curves of SmCo30 magnet pairs with varying permeance coefficient ratios (P_{c1}/P_{c2} or P_{c1}:P_{c2}).

FIG. 11 is a graph illustrating force (F₂) v. gap (d) curves of an equally-sized N55 magnet pair.

FIG. 12 is a graph illustrating force (F₂) v. gap (d) curves of an N55 magnet pair with a permeance coefficient ratio (P_{c1}/P_{c2} or P_{c1}:P_{c2}) of 4.69 in both center-aligned and edge-aligned orientations.

FIG. 13 illustrates magnetic field display film views of the N-pole side of two different N55 magnets, where the two magnets have a permeance coefficient ratio (P_{c1}/P_{c2} or P_{c1}:P_{c2}) of 4.69.

FIG. 14 illustrates magnetic field display film views of the N-pole side of each of the two N55 magnets shown in FIG. 13, after an N→←N pairing of the two magnets.

FIG. 15 illustrates magnetic field display film views of an S-pole side of each of the two N55 magnets shown in FIG. 13, after the N→←N pairing of the two magnets.

FIG. 16 is a graph illustrating plots of the ΔF₂ force difference v. permeance coefficient ratio (P_{c1}/P_{c2} or P_{c1}:P_{c2}) of the N55 magnet pairs shown in FIG. 5, the N48SH magnet pairs shown in FIG. 7, and the SmCo30 magnet pairs shown in FIG. 9. The ΔF₂ v. P_{c1}/P_{c2} of the magnet pairs having a P_{c1}/P_{c2}=1 is omitted.

FIG. 17 is a graph illustrating plots of the ΔF₂ force difference v. permeance coefficient ratio (P_{c1}/P_{c2} or P_{c1}:P_{c2}) of the N55 magnet pairs shown in FIG. 6, the N48SH magnet pairs shown in FIG. 8, and the SmCo30 magnet pairs shown in FIG. 10.

FIG. 18 is a graph illustrating a plot of the ΔF=|(F₄−F₁)/F₁| force difference v. permeance coefficient ratio (P_{c1}/P_{c2} or P_{c1}:P_{c2}) of the N55 magnet pairs shown in FIG. 5. The ΔF=|(F₄−F₁)/F₁| v. P_{c1}/P_{c2} of the N55 magnet pair having a P_{c1}/P_{c2}=1 is omitted.

FIG. 19 is a graph illustrating a plot of the ΔF=|(F₄−F₁)/F₁| force difference v. permeance coefficient ratio (P_{c1}/P_{c2} or P_{c1}:P_{c2}) of the N55 magnet pairs shown in FIG. 6.

FIG. 20 illustrates the surface flux of the N-pole side of an N55 magnet and a SmCo30 magnet, before and after an N→←N pairing, where the permeance coefficient ratio (P_{c1}/P_{c2} or P_{c1}:P_{c2}) of the pair of N55 magnets and the pair of SmCo30 magnets is 4.69.

FIG. 21 illustrates the surface flux of the N-pole side of an N55 magnet and a SmCo30 magnet, before and after an N→←N pairing, where the permeance coefficient ratio (P_{c1}/P_{c2} or P_{c1}:P_{c2}) of the pair of N55 magnets and the pair of SmCo30 magnets is 185.

FIG. 22 illustrates the surface flux of the N-pole side of an N55 magnet and a SmCo30 magnet, before and after an N→←N pairing, where the permeance coefficient ratio (P_{c1}/P_{c2} or P_{c1}:P_{c2}) of the pair of N55 magnets and the pair of SmCo30 magnets is 17.

FIG. 23 is a graph illustrating the B-H curves of an N55 magnet with a permeance coefficient (P_{c}) of 0.13 before and after an N→←N pairing with an N55 magnet having a higher P_{c}.

FIG. 24 is a graph illustrating the B-H curves of an N48SH magnet with a permeance coefficient (P_{c}) of 0.13 before and after N→←N pairing with an N48SH magnet having a higher P_{c}.

FIG. 25 is a perspective view of an example magnetic assembly.

FIG. 26 is an exploded view of the magnetic assembly shown in FIG. 25.

FIGS. 27 and 28 are top and front views, respectively, of the magnetic assembly shown in FIG. 25, showing a moveable magnet positioned adjacent to and axially aligned with a first stationary magnet located at one end of the magnetic assembly.

FIGS. 29 and 30 are top and front views, respectively, of the magnetic assembly shown in FIG. 25, showing the moveable magnet positioned adjacent to and axially offset with the first stationary magnet.

FIGS. 31 and 32 are top and front views, respectively, of the magnetic assembly shown in FIG. 25, showing the moveable magnet positioned adjacent to and axially aligned with a second stationary magnet located at another end of the magnetic assembly.

FIG. 33 is a perspective view of the magnetic assembly shown in FIG. 25 in an assembled state within a housing.

FIG. 34 is a front view of the magnetic assembly shown in FIG. 33.

FIG. 35 is a bottom view of the magnetic assembly shown in FIG. 33, showing the moveable magnet positioned adjacent to and axially aligned with the second stationary magnet of the magnet assembly.

FIG. 36 is a perspective view of an example electric generator device.

FIG. 37 is a front view of the electric generator device shown in FIG. 36.

FIG. 38 is a top view of the electric generator device shown in FIG. 36, shown with a housing.

FIG. 39 is a front view of the electric generator device shown in FIG. 38.

FIG. 40 is a perspective view of the electric generator device shown in FIG. 38.

FIG. 41 is a perspective view of an example propulsion device, illustrating a moveable magnet of the propulsion device in a first position.

FIG. 42 is a perspective view of the propulsion device shown in FIG. 41, illustrating the moveable magnet in a second position.

FIG. 43 is a perspective view of an example quick-release platform assembly.

FIG. 44 is a perspective view of the quick-release platform assembly shown in FIG. 43, shown with a second plate partially released from a first plate.

FIG. 45 is a perspective view of another example propulsion device, illustrating a moveable magnet of the propulsion device in a first position.

FIG. 46 is a perspective view of the propulsion device shown in FIG. 45, illustrating the moveable magnet in a second position.

FIG. 47 is an exploded view of the propulsion device shown in FIGS. 45 and 46.

FIG. 48 is a perspective view of another example propulsion device.

FIG. 49 is a side view of the propulsion device shown in FIG. 48.

FIGS. 50 and 51 are front and top views, respectively, of the propulsion device shown in FIG. 48, illustrating a moveable magnet of the propulsion device positioned adjacent to and axially aligned with a stationary magnet of the propulsion device.

FIGS. 52 and 53 are front and top views, respectively, of the propulsion device shown in FIG. 48, illustrating the moveable magnet positioned adjacent to and axially offset from the stationary magnet.

FIGS. 54 and 55 are front and top views, respectively, of the propulsion device shown in FIG. 48, illustrating the moveable magnet positioned at an opposite end of the propulsion device from the stationary magnet.

FIG. 56 is a top view of an example container assembly including a magnetically-releasable cap.

FIG. 57 is a perspective, partially exploded view of the container assembly shown in FIG. 56.

FIG. 58 is a front, exploded view of the container assembly shown in FIGS. 56 and 57.

FIG. 59 is a graph of B-H curves for N55 magnets at varying temperatures.

FIG. 60 is a graph of B-H curves for N48SH magnets at varying temperatures.

FIG. 61 is a graph of an intrinsic magnetic hysteresis loop of an N52M magnet at 20° C.

FIG. 62 is a perspective view of an example in-situ magnetic patterner assembly for producing a multipole-patterned magnet without an external power source, illustrated in a first, idle position.

FIG. 63 is a perspective view of the magnetic patterner assembly shown in FIG. 62, illustrated in a second, magnetizing position.

FIG. 64 is a perspective view of the magnetic patterner assembly shown in FIGS. 62 and 63, shown with a multipole-patterned magnet produced by the magnetic patterner.

FIG. 65 is a perspective view of the example magnetic patterner assembly shown in FIGS. 62-64 including guide rails or rods.

FIG. 66 is a perspective view of the magnetic patterner shown in FIG. 65, shown in a magnetizing position.

FIG. 67 is a perspective view of the magnetic patterner shown in FIGS. 65 and 66, shown with a multipole-patterned magnet produced by the magnetic patterner.

FIG. 68 is a graph illustrating the B-H curve of N55 magnets, with various working points plotted along the curve.

### DETAILED DESCRIPTION

It has been observed that two like poles can attract each other near the central area for a pair of permanent magnets with significantly different dimensions. To explain this phenomenon, and the underlying physics governed by the fundamental laws of magnetism, a series of experiments were conducted and reported in Revealing the mystery of the cases where Nd-Fe-B magnetic like poles attract each other, H. Meng et al., Scientific Reports, (2021) 11:12555, the disclosure of which is hereby incorporated by reference in its entirety. The investigation identifies that for two unequally sized magnets, the north (N) or south (S) pole of the magnet with a higher permeance coefficient (P_{c}) causes localized demagnetization (LD) to the like pole (i.e., the like N pole or the like S pole) of the magnet with a lower P_{c}. The permeance coefficient (P_{c}) is defined as the ratio of magnetic induction or magnetic flux density B_{d} and magnetic field strength H_{d} inside a standalone magnet at the working point or operating point of the B-H curve, i.e., P_{c}=|B_{d}/H_{d}|, which depends on the geometry of the magnet. For example, in the case of cylindrical magnets with the same diameter and same magnetization along the axis, the longer the magnet is, the higher the P_{c} will be. Combined with the B-H curves, the P_{c} can determine how easily a magnet will be demagnetized, especially when the B-H curve in the 2^{nd} quadrant is nonlinear. It has been found that the P_{c} and B-H curves are key factors to explain the LD phenomena.

If the LD is large enough, the polarity of the like pole of the lower P_{c} magnet at a localized area can be reversed when the spacing or gap between the two unequally sized magnets is sufficiently small. The reversed polarity results in a magnetic attraction between the two like poles of the magnets in the LD area. Consequently, two unusual behaviors are observed: 1) A turning point TP appears on the force v. gap curves of like poles of the unequally sized magnets since they have a different P_{c} (also referenced herein as the “turning point (TP) rule”). Normally, the like poles' repelling force increases when the gap between the two magnets decreases, but this TP results in nonmonotonic curves, even an attractive force at a small gap between the two unequally sized magnets; 2) For some Nd—Fe—B magnets with a low coercivity and nonlinear B-H curve in the 2^{nd} quadrant, a repulsion can occur for the unlike poles (e.g., N pole and S pole) of the unequally sized magnets after previously pairing with their like poles that left an unrecoverable LD and a reversed polarity area. The relationship of the LD, the P_{c} ratio, and the B-H curve are discussed in more detail herein. It should be noted that, in the paper of H. Meng et al., incorporated by reference herein, the turning point or TP was termed the “Inflection Point” or IP. In this disclosure, the IP as used in that paper is termed the turning point or TP.

Further disclosed herein are devices and magnetic assemblies with magnetic components implementing the localized demagnetization (LD) phenomena and the turning point (TP) rule, which can make like poles of the magnetic components attract each other and unlike poles repel one another. The turning point (TP) is the extremum point on the curve of the force between the like N poles or S poles of the unequally sized magnets v. the gap between the like magnet poles, corresponding to the change of sign of the first derivative of the force v. gap curve. The LD is the cause of these unusual behaviors.

The demagnetizing field of a stand-alone magnet is determined by its geometry. For equally sized magnet pairs, like poles are repulsive and unlike poles are attractive. However, for those unequally sized magnet pairs, the forces can be manipulated by adjusting the relative dimensions of the pair, as well as the air gap between the pair, leading to unusual behaviors of like poles' attraction and unlike poles' repulsion. When the LD is large enough, the polarity of a localized region at the center of the magnet with a lower P_{c} can be temporarily or permanently reversed, leading to like poles attracting and unlike poles repelling at a small gap between the two unequally sized magnets. The magnets' P_{c} values and their linearity of the B-H curve affect the LD level and also the LD's recoverability. The LD can be fully recovered after taking the magnet pair apart, for the magnets with linear B-H curve in 2^{nd} and partial of 3^{rd} quadrant, as discussed in more detail herein. For magnets with a non-linear B-H curve in 2^{nd} and partial of 3^{rd} quadrant, the LD would not be fully recovered after taking the pair apart.

Embodiments disclosed herein include unequally sized permanent magnet pairs, and/or electromagnets with unequally sized coils, paired together by the like north poles (N→←N pairing), paired together by the like south poles (S→←S pairing), or paired together by unlike poles (N→S pairing or S→N pairing). In these embodiments, the pair of permanent magnets or electromagnets have a different permeance coefficient P_{c}, which causes a distinctive action based on the LD phenomenon and the TP rule. In some embodiments, a device or magnetic assembly includes movable parts that may have special functions based on the LD phenomenon and the TP rule including, for example and without limitation, locking, switching, vibrating, propelling, and combinations thereof. The principle of the actions is different compared to those equally sized magnetic pairs. The LD and TP make the like poles of the unequally sized magnet pairs attract each other when the magnets are axially aligned and the unequally sized magnets are spaced at a sufficiently small gap or distance. When an external force is applied that slides one magnet relative to the other (e.g., outside the LD area or out of axial alignment), the like poles repel one another and the repelling force causes one magnet to move away from the other magnet. This principle can be used to propel, launch, or otherwise move one of the magnets (e.g., the smaller of the two magnets). The TP also leads the magnet poles to have a uniform force at the distance near the TP gap, which provides consistent performance for the devices. In one embodiment, the magnets with different P_{c} values can cause enough LD to build novel devices and systems, such as an in-situ magnetic patterner assembly that produces a multipole-patterned magnet without an external power source.

Described herein are devices and magnetic assemblies where the functions of locking, switching, vibration, and propelling can be realized by utilizing the temporary LD, as well as devices and magnetic assemblies implementing the TP rule. As discussed above, the TP is the turning point on the force v. gap curve, and it corresponds to a minimal variation of the force relative to the distance. By providing a magnetic device or assembly to operate near the TP point, a more stable performance than the devices made of equally sized magnet pairs can be achieved. The permanent LD may also be used to build some example devices and magnetic assemblies, such as an in-situ magnetic patterner assembly without external power sources.

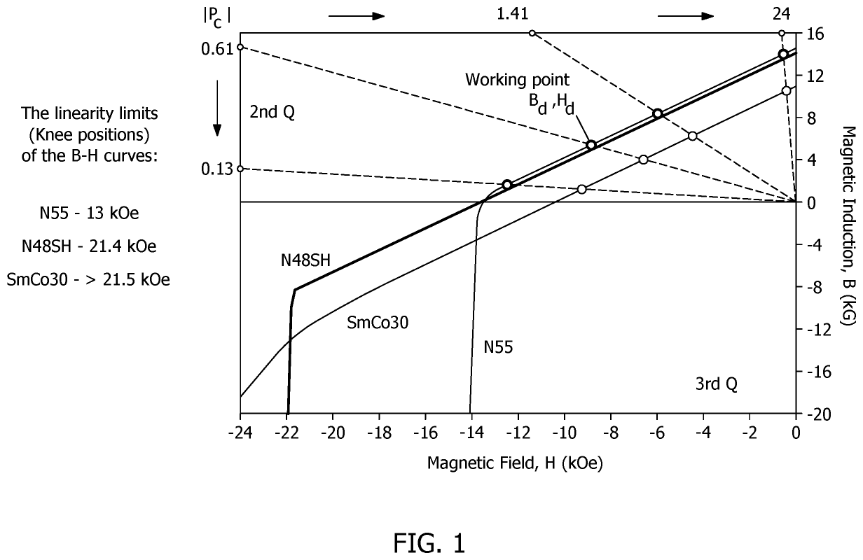

With reference to FIGS. 1-24, magnetic forces and other properties were tested for Neodymium (Nd—Fe—B) and Samarium Cobalt (Sm₂Co₁₇) magnet pairs. For the Nd—Fe—B magnets, N55 and N48SH grades were used. For the Sm₂Co₁₇ magnets, SmCo30 grade was used. SmCo30 magnets were tested to eliminate biases caused by surface degradation, which may be more pronounced for small or thin Nd—Fe—B magnets as described, for example, by Nishio et al., “Effects of machining on magnetic properties of Nd—Fe—B system sintered magnets,” IEEE Trans. Magn. 26(1), 257-61 (January 1990), the disclosure of which is hereby incorporated by reference in its entirety.

Table 1 below provides a summary of the physical dimensions of the magnets used in each pairing, where OD is the outer diameter (in mm) of the magnet, and L is the length (in mm) of the magnet relative to the magnetization direction of the magnet. The length L is also referred to herein as the thickness of the magnet. The permeance coefficient P_{c} is also provided for each magnet. Each magnet used had a cylindrical shape, and the P_{c} values ranged from 0.13 to 24. As shown, the P_{c} is correlated with the ratio OD:L, where the P_{c} increases as the ratio OD:L decreases. In other words, at a fixed L, a magnet with a larger OD has a lower P_{c}, and at a fixed OD, a magnet with a larger L has a higher P_{c}.

TABLE 1
Summary of magnet pairs tested

| | Magnet 1 (Top) | | | Magnet 2 (Bottom) | | | | | |
|---|---|---|---|---|---|---|---|---|---|
| Pair ID | OD | L | Pc [symbol] | OD | L | Pc [symbol] | N55 | N48SH | SmCo30 |
| 1-A | 4 | 2 | 1.41 | 32 | 2 | 0.13 | ✓ | ✓ | ✓ |
| 2-A | 8 | 2 | 0.61 | | | | ✓ | ✓ | ✓ |
| 3-A | 16 | 2 | 0.28 | | | | ✓ | ✓ | |
| A-A | 32 | 2 | 0.13 | | | | ✓ | | ✓ |
| 4-A | 4 | 16 | 24 | 32 | 2 | 0.13 | ✓ | ✓ | ✓ |
| 4-B | | | | 32 | 4 | 0.28 | ✓ | ✓ | |
| 4-C | | | | 32 | 8 | 0.61 | ✓ | ✓ | |
| 4-D | | | | 32 | 16 | 1.41 | ✓ | ✓ | ✓ |

[symbol]

indicates data missing or illegible when filed

FIG. 1 shows the demagnetization B-H curves for N55 magnets, N48SH magnets and SmCo30 magnets, in the 2^{nd} quadrant and part of the 3^{rd} quadrant. B-H curves describe magnetic properties of a material, specifically, how the magnetic induction or magnetic flux density (B) responds to a magnetizing force (H), or external magnetic field. The demagnetization of the materials in response to magnetic force applied in the opposite direction of magnetization is shown in the second and third quadrants defined by the B-axis and H-axis. For the types of magnets disclosed, N55 magnets have a nonlinear B-H curve in the 2^{nd} quadrant, while N48SH magnets and SmCo30 magnets have linear B-H curves in the 2^{nd} and even in part of the 3^{rd} quadrant. The turning point defining the point along the B-H curve at which the curve becomes non-linear may also be referred to as the “knee” position, or the linearity limit. The knee positions or linearity limits are as follows: about 13 kilo-oersted (kOe) for N55 magnets, about 21.4 kOe for N48SH magnets, and greater than about 21.5 kOe for SmCo30 magnets. The working points (B_{d}, H_{d}) are marked on the B-H curves of N55 magnets and SmCo30 magnets for four load lines with P_{c}=0.13, 0.61, 1.41, and 24, where P_{c}=|B_{d}/H_{d}|.

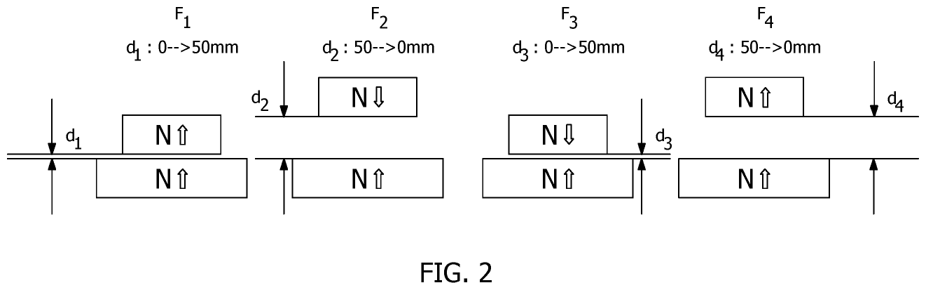

FIG. 2 is a schematic diagram illustrating a testing process for generating force v. gap curves for the magnetic pairs described in Table 1. These magnet pairs were tested for repelling and attracting forces at gaps d between 0 and 50 millimeters (mm) at a center position (i.e., where the magnets are axially aligned) using an Instron 5944 force tester. To observe what happened during the test process, four forces were recorded and marked by their testing sequence, F₁, F₂, F₃, and F₄, as shown in FIG. 2. F₁ and F₄ were recorded for an N→S pairing of the unlike poles at respective gaps d₁ and d₄, and F₂ and F₃ were recorded for an N→←N pairing of the like poles at respective gaps d₂ and d₃. As shown in FIG. 2, the forces F₁ and F₃ were recorded while the gaps d₁ and d₃, respectively, between the magnets changed from 0 to 50 mm; and the forces F₂ and F₄ were recorded while the gaps d₂ and d₄, respectively, between the magnets changed from 50 to 0 mm.

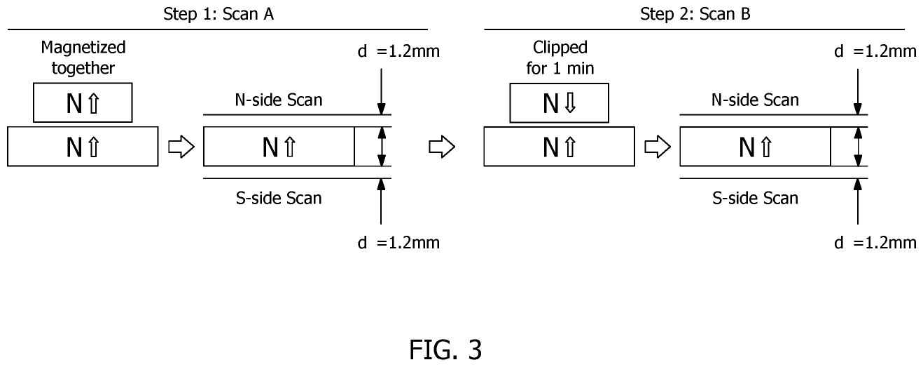

In addition to the force test, some of the magnets with OD=32 mm were also tested for flux density on the surface to estimate the level of the localized demagnetization LD using a Brockhaus XYZ Scanner. FIG. 3 is a schematic of a testing sequence for scanning the surface flux at an N side and an S side of these magnets. The Hall sensor was 1.2 mm above the magnet surface due to the Hall probe construction and clearance, and this gap was maintained throughout the experiment. The surface scanning was conducted with 0.5 mm intervals. There were two steps in sequence to test the surface flux, as shown in FIG. 3. In Step 1, the pair of magnets were magnetized together (i.e., the unequally sized magnets were N→S paired) and the magnets were aligned at their respective centers (i.e., axially aligned). The surfaces of both sides (N pole and S pole) on the bottom magnet were scanned after the top magnet was removed. In Step 2, the top magnet was turned upside down and the unequally sized magnets were N→←N paired, aligned at their respective centers, placed into engagement with one another for 1 minute, and then separated. The top magnet was removed and the bottom magnet was scanned at the surface of both sides (N pole and S pole).

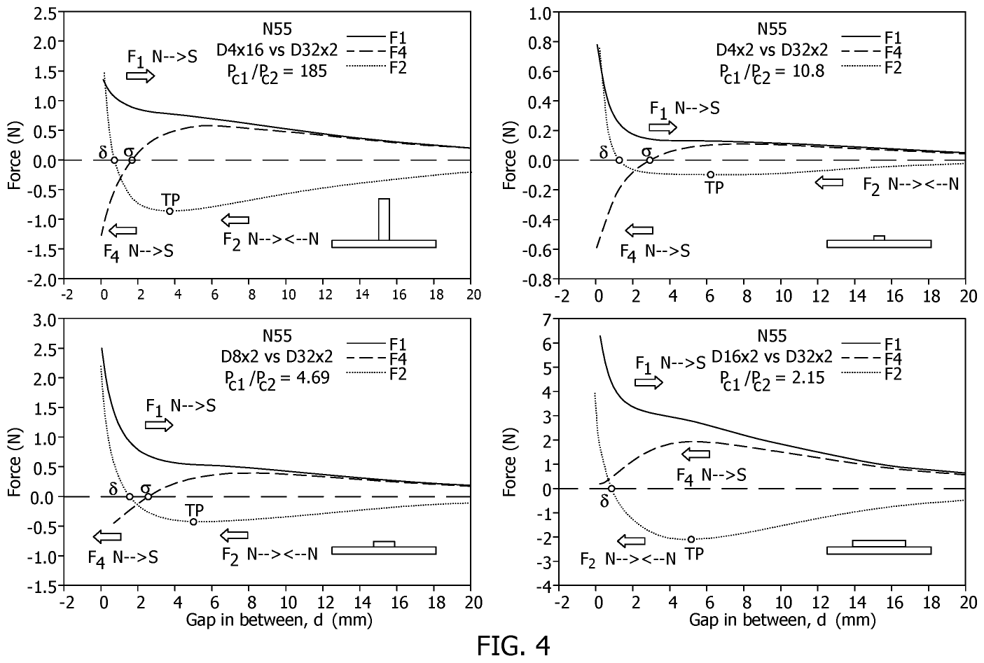

FIG. 4 plots force (forces F₁, F₂, and F₄ from FIG. 2) v. gap (d) curves for four pairs of unequally sized N55 magnets (pair IDs 4-A, 1-A, 2-A, and 3-A in Table 1) having a permeance coefficient ratio (P_{c1}/P_{c2} or P_{c1}:P_{c2}) as shown. In the graphs illustrated in FIG. 4, a negative force value indicates a magnetic repelling force and a positive force value indicates magnetic attractive force. The symbol 8 represents the point where F₂=0, and σ represents the point where F₄=0. F₃ is not plotted as F₃ is the same as F₂. The curves were generated using the testing process shown in FIG. 2, and d collectively represents the gaps d₁, d₂, and d₄. Two unusual behaviors are observed in the plots. First, a turning point TP appears on the curve of F₂ v. d for the N→<N pairing of the unequally sized magnets. Normally, F₂ is a repelling force (F₂<0), and |F₂| increases when the gap decreases, but this TP results in nonmonotonic curves, and even a magnetic attractive force. When the gap reduces to d<d_{@TP}, |F₂| starts to decrease and eventually transforms from magnetic repulsion to magnetic attraction (F₂>0) at gap d<δ (˜1 mm). It should be noted that the TP is caused by a localized demagnetization LD, which effects the force v. gap curve well before the TP (i.e., at d_{@TP}). Second, for some Nd—Fe—B magnets with a low coercivity and nonlinear B-H curve in the 2^{nd} quadrant, repulsion can occur between the unlike poles of the unequally sized magnets (e.g., when the magnets are N→S paired) after the magnets have been previously N→←N paired. This is because the N→←N pairing of the unequally sized magnets left an unrecoverable LD and reversed polarity area. A force difference ΔF occurs to the unlike poles of the unequally sized magnets, demonstrated by testing before and after pairing with their like poles (e.g., N→<N pairing). F₄<F₁ and even F₄<0 are observed for unequally sized N55 magnets when N→S paired after having been N→←N paired. Normally, F₁ and F₄ have the same attracting force (F₁=F₄>0), as they were tested on the same N→S pairs. The only difference is that F₄ was tested after F₂, and F₂ was tested with the magnets being N→<N paired, which caused the LD. When gap d reduces to a range (˜15 to 8 mm), the LD starts playing its role to cause an unusual behavior of F₄<F₁. As shown in FIG. 4, three pairs of N55 magnets with P_{c1}/P_{c}2=4.69, 10.8 and 185 have F₄<0 when the gap d<σ (˜2-3 mm), where the force transforms from attraction to repulsion, and only one pair (P_{c1}/P_{c2}=2.15) does not have F₄<0. This unusual F₄<F₁ does not occur for N48SH magnets and SmCo30 magnets, which have linear B-H curves in the 2^{nd} quadrant.

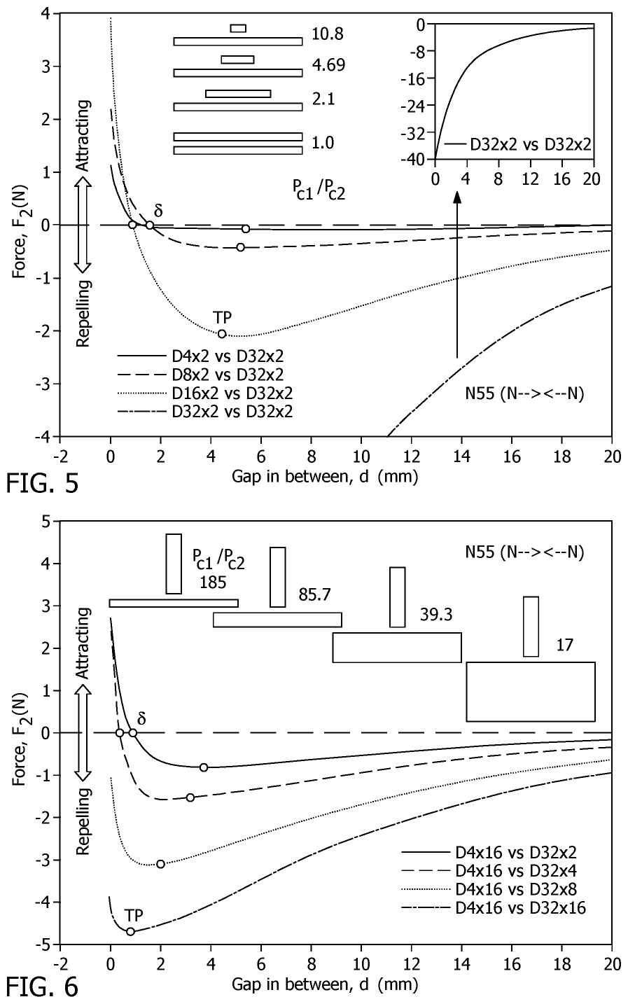

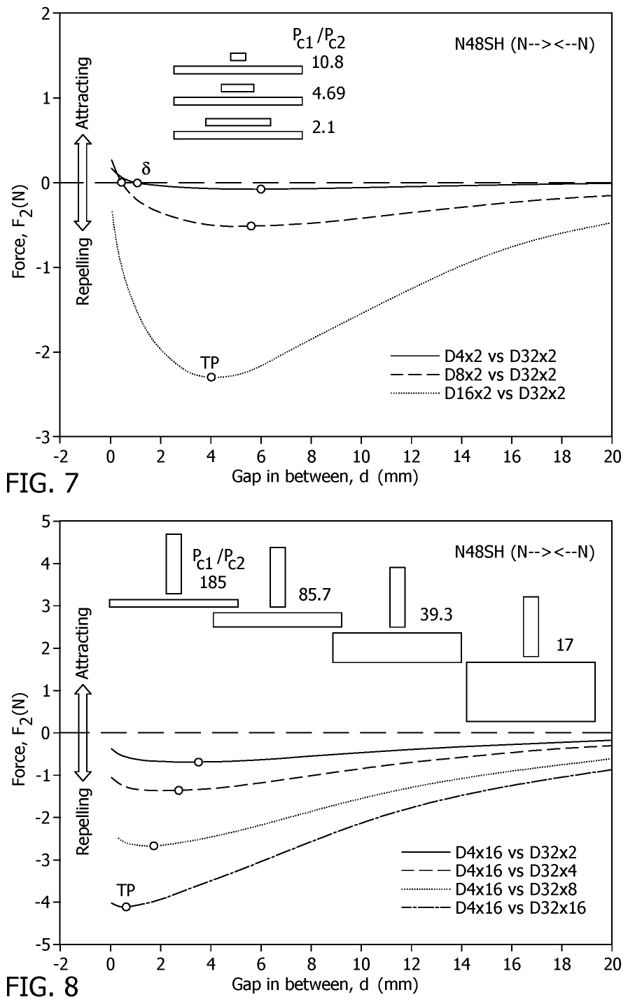

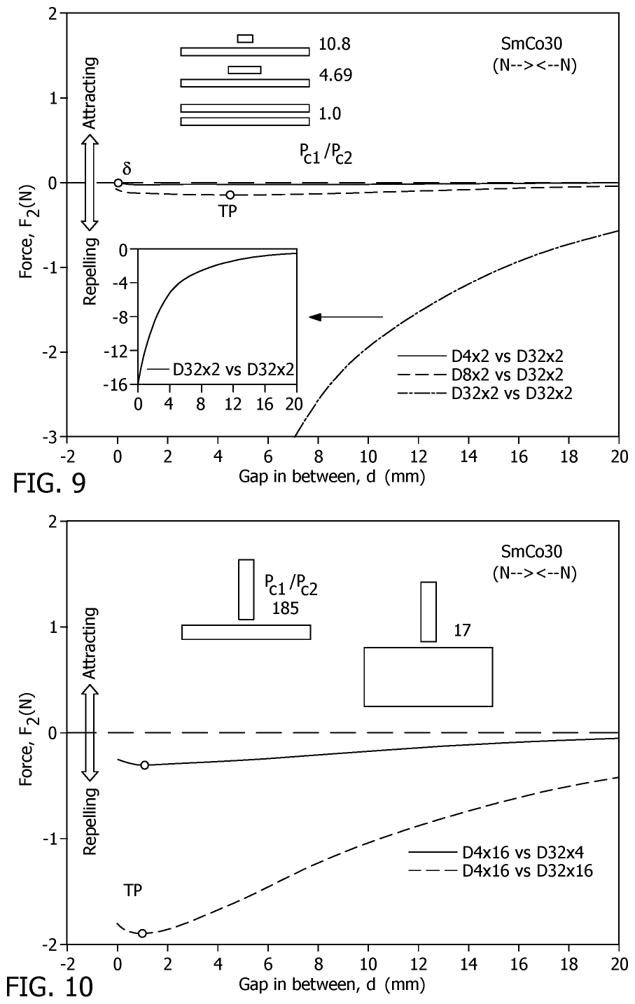

FIGS. 5 and 6 are graphs illustrating F₂ v. d curves of the N→←N pairings of N55 magnets, for both unequally sized and equally sized pairs. FIGS. 7 and 8 are graphs illustrating F₂ v. d curves of the N→←N pairings of N48SH magnets, for unequally sized pairs. FIGS. 9 and 10 show F₂ v. d curves of the N→←N pairings of SmCo30 magnets, for both unequally sized and equally sized pairs. As discussed above, TP is the turning point and δ is the point where F₂=0. An unusual TP is observed for all the magnet pairs, except the equally sized pairs with P_{c1}=P_{c2}.

In FIG. 5, F₂ v. d curves of four pairs of N55 magnets with a fixed size of the bottom magnet (in the orientation shown in FIG. 5) and P_{c1}/P_{c2}=10.8, 4.69, 2.1, and 1.0 are shown. In FIG. 6, F₂ v. d curves of four pairs of N55 magnets with a fixed size of the top magnet (in the orientation shown in FIG. 6) and P_{c1}/P_{c2}=185, 85.7, 39.3, and 17 are shown. As shown in FIGS. 5 and 6, for the N55 magnets, five out of the eight tested pairs (P_{c1}/P_{c2}=185, 85.7, 10.8, 4.69, and 2.1) have F₂>0 at d<δ (˜1 mm).

In FIG. 7, F₂ v. d curves of three pairs of N48SH magnets with a fixed size of the bottom magnet (in the orientation shown in FIG. 7) and P_{c1}/P_{c2}=10.8, 4.69, and 2.1 are shown. In FIG. 8, F₂ v. d curves of four pairs of N48SH magnets with a fixed size of the top magnet (in the orientation shown in FIG. 8) and P_{c1}/P_{c2}=185, 85.7, 39.3, and 17 are shown. As shown in FIGS. 7 and 8, for the N48SH magnets, two pairs (P_{c1}/P_{c2}=10.8 and 4.69) have F₂>0 at d<8.

In FIG. 9, F₂ v. d curves of three pairs of SmCo30 magnets with a fixed size of the bottom magnet (in the orientation shown in FIG. 9) and P_{c1}/P_{c2}=10.8, 4.69, and 1.0 are shown. In FIG. 10, F₂ v. d curves of two pairs of SmCo30 magnets with a fixed size of the top magnet (in the orientation shown in FIG. 10) and P_{c1}/P_{c2}=185 and 17 are shown. As shown in FIGS. 9 and 10, for the SmCo30 magnets, one pair (P_{c1}/P_{c2}=10.8) has F₂=0 at d=δ (0.05 mm), which indicates that certain SmCo30 pairs can also have F₂>0 at a small gap. It can be observed from FIGS. 5-10 that a higher P_{c} ratio (P_{c1}/P_{c2}) results in a force value being less negative at the TP and/or the gap being larger at the TP. In the graphs shown in FIGS. 5-10, the TP ranges from 0.4 to 6 mm with P_{c1}/P_{c2} ranging from 2.1 to 185. When P_{c}/P_{c2}=1 for the equal sized pairs, the TP disappears (or TP→0).

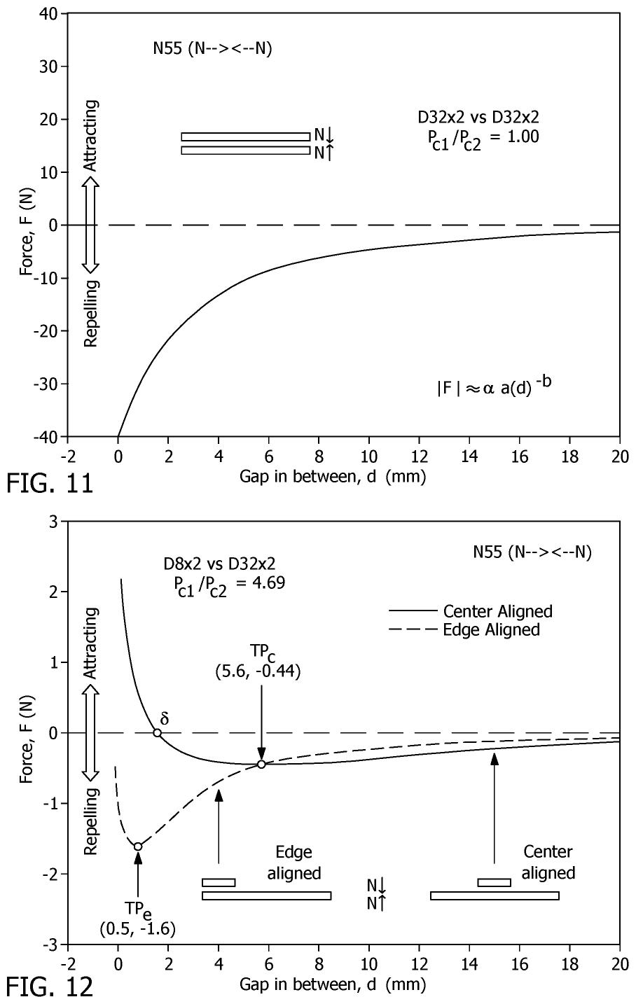

FIGS. 11 and 12 are graphs illustrating F₂ v. d curves of the N→←N pairings of N55 magnets, for both equally sized (FIG. 11) and unequally sized pairs (FIG. 12). FIG. 12 also illustrates the affects of LD and TP for axially-aligned (i.e., center aligned) unequal pairs and edge-aligned unequal pairs. As illustrated in FIG. 11, the repelling force F of the equal sized pair of magnets is inversely proportional to the gap d. In FIG. 12, F₂ v. d curves of one pair of N55 magnets having P_{c1}/P_{c2}=4.69 are shown for both center-aligned and edge-aligned orientations. As illustrated in FIG. 12, for unequal sized magnets with like poles facing one another (e.g., N→←N paired), the higher P_{c} magnet (the bottom magnet, as illustrated in FIG. 12) locally/partially demagnetizes the lower P_{c} magnet and, as the gap d decreases, the affects of LD increases and a turning point TP appears on the curve. As further illustrated in FIG. 12, the affects of LD are stronger for center aligned magnet pairs (i.e., magnet pairs that are aligned along their respective center axes) than for magnet pairs that are axially offset from one another. For example, for the center-aligned magnet pair, the force transitions from a repelling force to an attracting force when the gap d is less than about 1.5 mm, whereas for the edge-aligned magnet pair, the TP appears at a much smaller gap d and the force remains a repulsive force even at a gap of d=0.

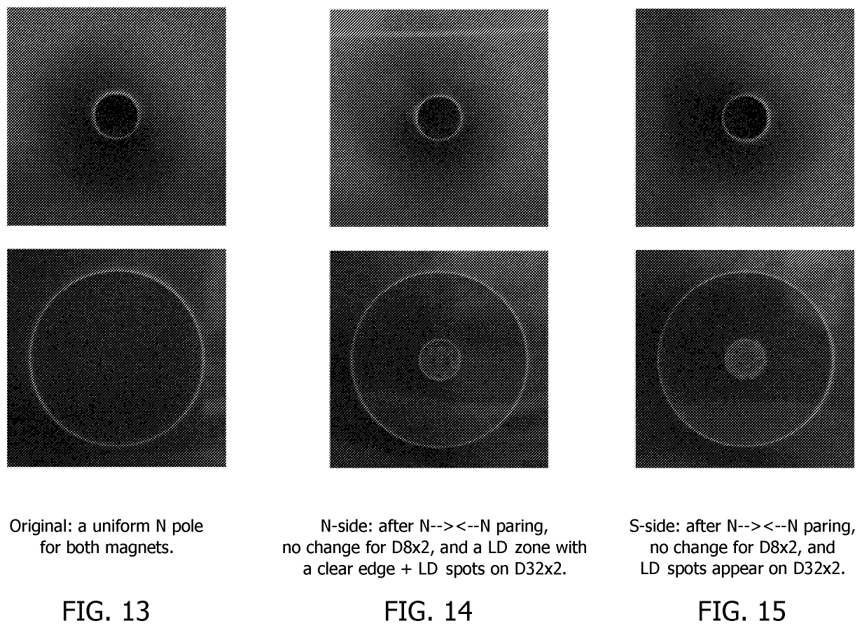

FIGS. 13-15 illustrate views of magnetic field display film for the N55 magnets of Pair ID 2-A from Table 1 (P_{c} ratio of 4.69) before and after the N→←N pairing. The view of the D8×2 magnet is shown on top, and that of the D32×2 magnet on bottom. As shown in FIG. 11, a uniform N pole is observed for both magnets before the N→←N pairing. FIGS. 14 and 15 show the N and S sides, respectively, of the magnets after the N→<N pairing. No change on either the N side or the S side for the D8×2 magnet (top) was observed. However,

FIG. 14 shows that a clear edge and LD spots are observed on the N side of the D32×2 magnet. FIG. 15 also shows LD spots on the S side of the D32×2 magnet.

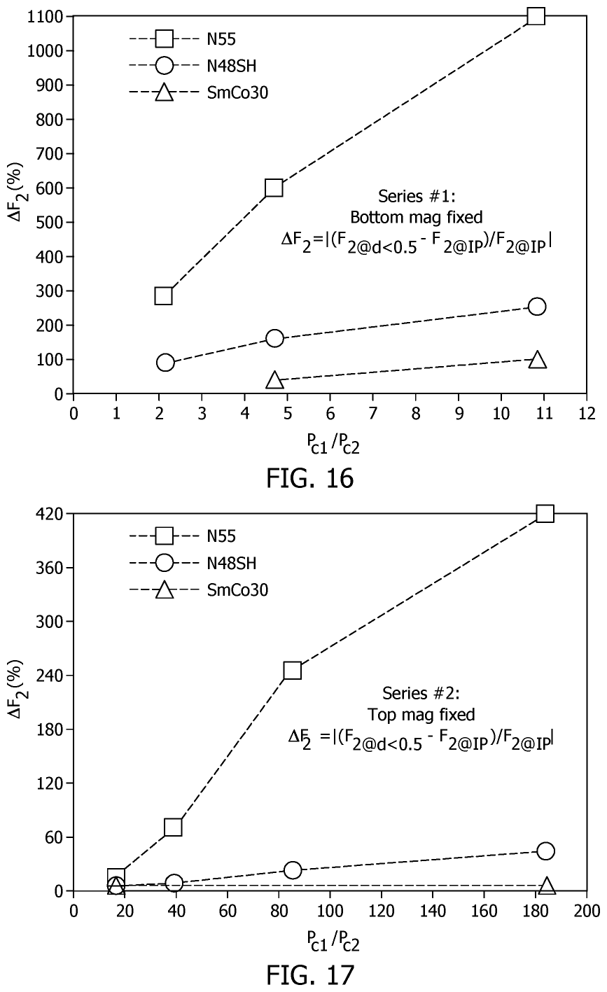

Table 2 below summarizes the results discussed above for the magnet pairs from Table 1. For each pair of N55 magnets, N48SH magnets, and SmCo30 magnets, the force difference ΔF₂ is calculated as ΔF₂=|(F_{2@d<0.5}−F_{2@TP})/F₂@TP|. FIGS. 16 and 17 show the plots of ΔF₂ v. P_{c1}/P_{c2} for the unequally sized pairs of each material. The plots of Pair IDs 1-A, 2-A and 3-A (fixed bottom magnet geometry) are shown in FIG. 16 (Series #1), and the plots of Pair IDs 4-A, 4-B, 4-C and 4-D (fixed top magnet geometry) are shown in FIG. 17 (Series #2). In general, a higher P_{c} ratio results in a larger ΔF₂, which is as high as 1100% for N55 with P_{c1}/P_{c2}=10.8 in Series #1 and 400% for N55 with P_{c1}/P_{c2}=185 in Series #2. The ΔF₂ is 2%-250% for N48SH pairs and 4%-100% for SmCo30 pairs. All pairs with ΔF₂>100% show attraction when N→←N paired. A larger ΔF₂ indicates a greater localized demagnetization LD.

TABLE 2
Unusual behaviors observed for magnet pairs

| | | | | | | | | For N→S pairs | | | |
|---|---|---|---|---|---|---|---|---|---|---|---|
| | | | | | | | | Unusual Force: F₄ < F₁ | | | |
| | Magnet 1 | | | Magnet 2 | | | | (Usually F₄ = F₁) | | | |
| | (Top) | | | (Bottom) | | | | N55 | | | |
| Pair | L₁ | OD | | L₂ | OD | | | F₁ (N)@ | F₄ (N)@ | | N48SH & |
| ID | (mm) | (mm) | \|P_{c1}\| | (mm) | (mm) | \|P_{c2}\| | P_{c1}/P_{c2} | d = 0.1 mm | d = 0.1 mm | ΔF %* | SmCo30 |
| 1-A | 2 | 4 | 1.41 | 2 | 32 | 0.13 | 10.8 | 0.8 | −0.6 | 175 | N/A |
| 2-A | 2 | 8 | 0.61 | | | | 4.69 | 2.5 | −0.5 | 120 | |
| 3-A | 2 | 16 | 0.28 | | | | 2.15 | 6.4 | 0.2 | 97 | |
| A-A | 2 | 32 | 0.13 | | | | 1 | 61 | 61 | 0 | |
| 4-A | 16 | 4 | 24 | | | | 185 | 1.4 | −1.3 | 193 | |
| 4-B | | | | 4 | 32 | 0.28 | 85.7 | 2.3 | 0.2 | 91 | |
| 4-C | | | | 8 | | 0.61 | 39.3 | 3.7 | 3.7 | 0 | |
| 4-D | | | | 16 | | 1.41 | 17 | 5.8 | 5.8 | 0 | |

| | For N→←N pairs | | | | | | | | |
|---|---|---|---|---|---|---|---|---|---|
| | Unusal Force: F₂ vs gap d has a Turning Point TP | | | | | | | | |
| | when d < TP, \|F₂\|↓ as d ↓, F₂ may > 0 (Normally F₂ < 0) | | | | | | | | |
| | N55 | | | N48SH | | | SmCo30 | | |
| Pair | F₂ (N)@ | F₂ (N) | | F₂ (N)@ | F₂ | | F₂ (N)@ | F₂ | |
| ID | d < 0.5 mm | @IP | ΔF₂ % | d < 0.5 mm | @IP | ΔF₂ %* | d < 0.5 mm | @IP | ΔF₂ %* |
| 1-A | 1.0 | −0.10 | 1100 | 0.15 | −0.10 | 250 | 0.00 | −0.05 | 100 |
| 2-A | 2.2 | −0.4 | 650 | 0.3 | −0.5 | 160 | −0.10 | −0.16 | 38 |
| 3-A | 3.8 | −2.1 | 281 | −0.3 | −2.3 | 87 | | | |
| A-A | −39.4 | N/A | | | N/A | | −14.9 | N/A | |
| 4-A | 2.7 | −0.9 | 400 | −0.4 | −0.7 | 43 | −0.327 | −0.34 | 4.7 |
| 4-B | 2.3 | −1.6 | 244 | −1.1 | −1.4 | 21 | | | |
| 4-C | −1.0 | −3.2 | 69 | −2.5 | −2.7 | 7 | | | |
| 4-D | −4.1 | −4.7 | 13 | −4.0 | −4.1 | 2 | −1.86 | −1.94 | 4.3 |

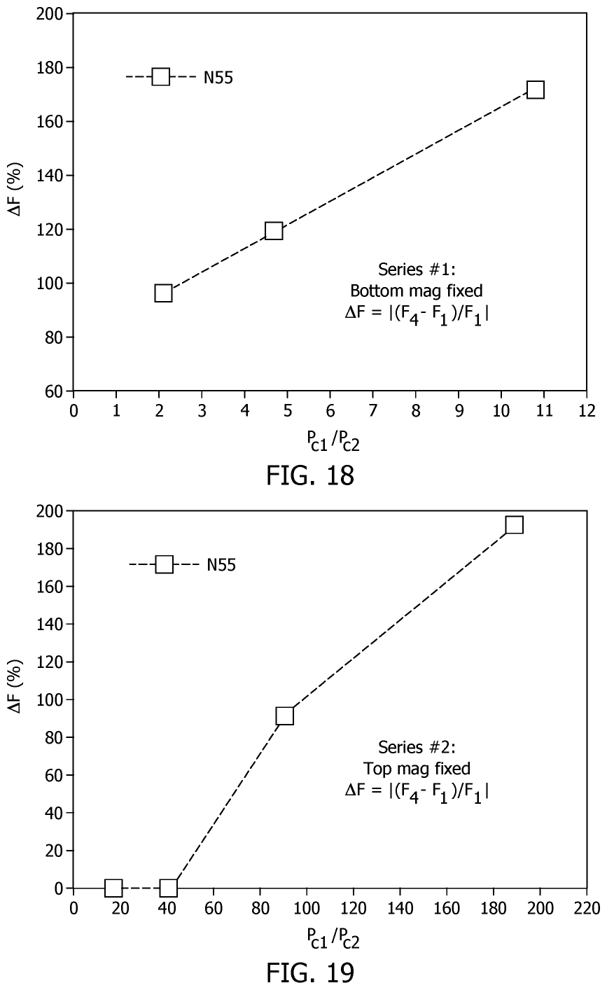

FIGS. 18 and 19 demonstrate the force difference ΔF=| (F₄−F₁)/F₁| v. P_{c1}/P_{c2} for pairs of N55 magnets only, as N48SH magnets and SmCo30 magnets do not have this unusual behavior of F₄<F₁. As illustrated in FIGS. 18 and 19, a higher P_{c1}/P_{c2} results in a larger ΔF for both Series #1 and Series #2. The ΔF is as high as 193% for P_{c1}/P_{c2}=185 in Series #2 and 175% for P_{c1}/P_{c2}=10.8 in Series #1. All pairs with ΔF>100% show repulsion when N→S paired after having been N→←N paired. A larger ΔF indicates a greater localized demagnetization LD.

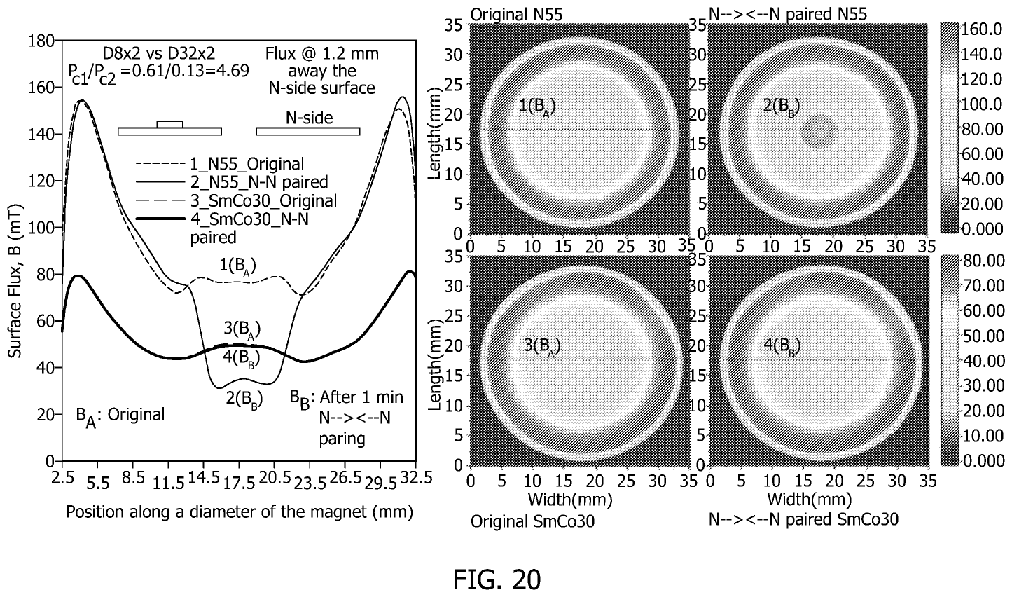

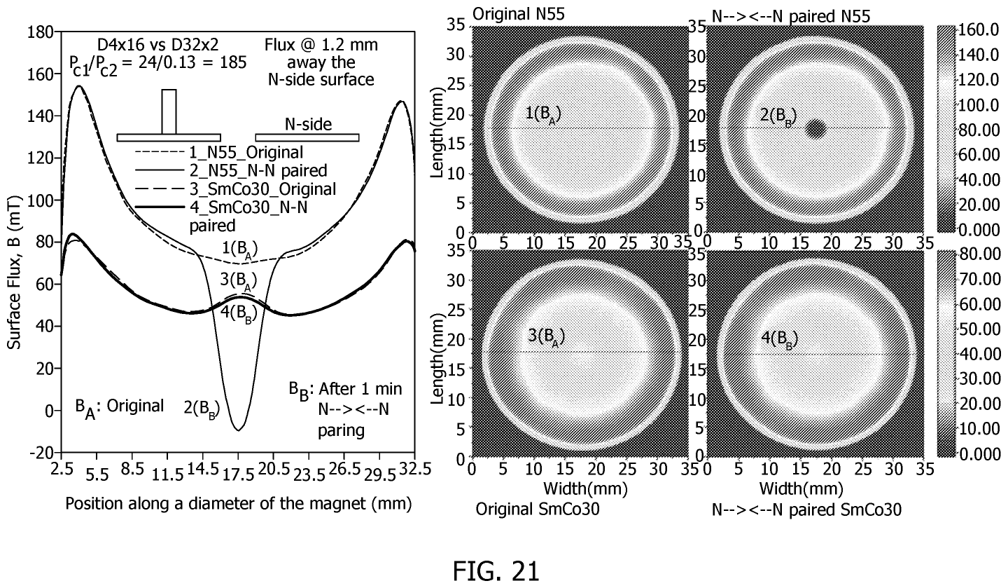

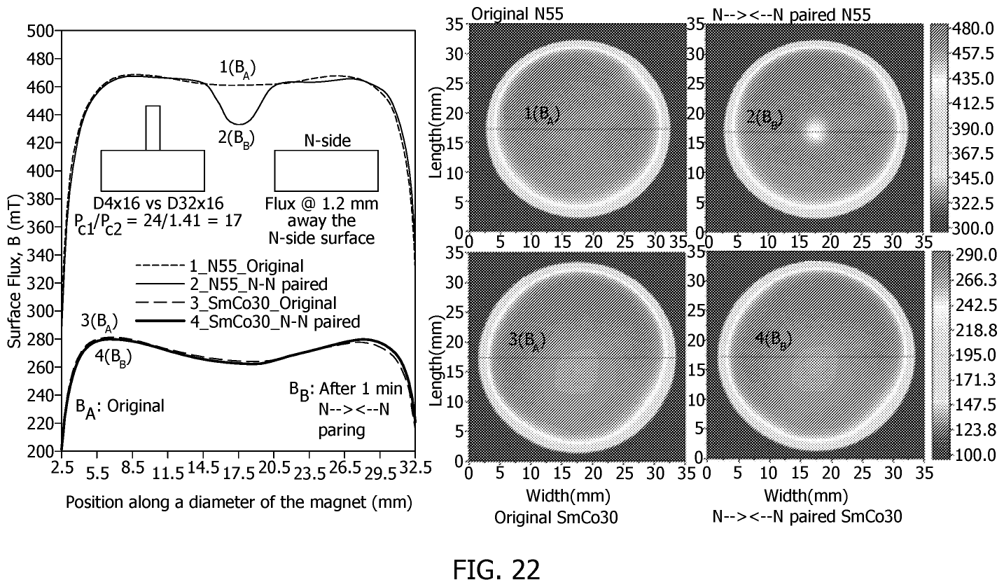

With reference to FIGS. 20-22, the LD can be visualized using a surface flux density test (e.g., using the testing sequence shown in FIG. 3), from which the LD level can be determined. In particular, FIGS. 20-22 show the flux density at 1.2 mm above the N-side of the bottom magnets of N55 magnet pairs and SmCo30 magnet pairs after N→←N pairing with P_{c1}/P_{c2}=4.69, 185, and 17, respectively. The 2D magnetic flux maps are shown on the right, and the curves of surface flux or flux density v. position and the magnet size are shown on the left. Curves 1 and 2 represent the flux density v. position along a diameter for the bottom N55 magnet, curves 3 and 4 represent the flux density v. position along a diameter for the bottom SmCo30 magnet. Curves 1 and 3 are the original fluxes after magnetization (labelled “BA”), corresponding to Step 1 (Scan A in FIG. 3). Curves 2 and 4 are the fluxes after 1 minute of repulsion (i.e., N→←N pairing) with the top magnet (labelled “BB”), corresponding to Step 2 (Scan B in FIG. 3). The flux densities at the surface of the magnets with OD=32 mm, as well as the LD values (calculated as LD=100%× (BB−BA)/BA) for various pairs, are summarized in Table 3. FIG. 20 shows Pair ID 2-A (from Table 1) with P_{c1}/P_{c2}=4.69, in which the N55 magnet exhibits a relatively large LD (−55%) at the center of curve 2, while the SmCo30 magnet exhibits a relatively small LD (−2.1%). FIG. 21 shows Pair ID 4-A (from Table 1) with P_{c1}/P_{c2}=185, where the N55 magnet exhibits a relatively large LD with its polarity totally reversed at the center (−114%) of curve 2, while the SmCo30 magnet exhibits a relatively small LD (−2.9%). FIG. 22 shows Pair ID 4-D with P_{c1}/P_{c2}=17; the N55 exhibits a LD of −6.1%, while the SmCo30 exhibits a LD of −0.64%. In general, the LD on the N-side is higher than that on the S-side. When the P_{c1}/P_{c2} ratio=1 for the #A-A pairs, the LD for both the N55 magnet and the SmCo30 magnet is approximately “0”, and the small difference is within the expected measurement error. Since the flux density was tested at 1.2 mm above the surface, the actual LD at the surface is expected to be higher than the levels measured herein.

TABLE 3
LD detected at 1.2 mm above the surface of bottom magnets

| Surface Field, B (mT) | | #2-A (P_{c}_{¹}/P_{c}_{²} = 4.69) | | | #4-A (P_{c}_{¹}/P_{c}_{²} = 185) | | | #4-D (P_{c}_{¹}/P_{c}_{²} = 17) | | | #A-A (P_{c}_{¹}/P_{c}_{²} = 1) | | |
|---|---|---|---|---|---|---|---|---|---|---|---|---|---|
| @1.2 mm above | | B_{A} | B_{B} | LD | B_{A} | B_{B} | LD | B_{A} | B_{B} | LD | B_{A} | B_{B} | LD |
| N55 | N-side | 76.7 | 34.8 | −55% | 70.1 | −10.0 | −114% | 462 | 434 | −6.1% | 68.3 | 68 | −0.44% |
| | S-side | −80.8 | −38.7 | −52% | −72.3 | −13.7 | −81% | −440 | −440 | −0.07% | −73.3 | −73.6 | 0.41% |
| SmCo30 | N-side | 50.3 | 49.24 | −2.1% | 55.2 | 53.6 | −2.9% | 264 | 263 | −0.64% | 48.1 | 48 | −0.21% |
| | S-side | −49.2 | −48.2 | −2.0% | −59.7 | −58.4 | −2.2% | −288 | −287 | −0.31% | −47.9 | −47.8 | −0.21% |

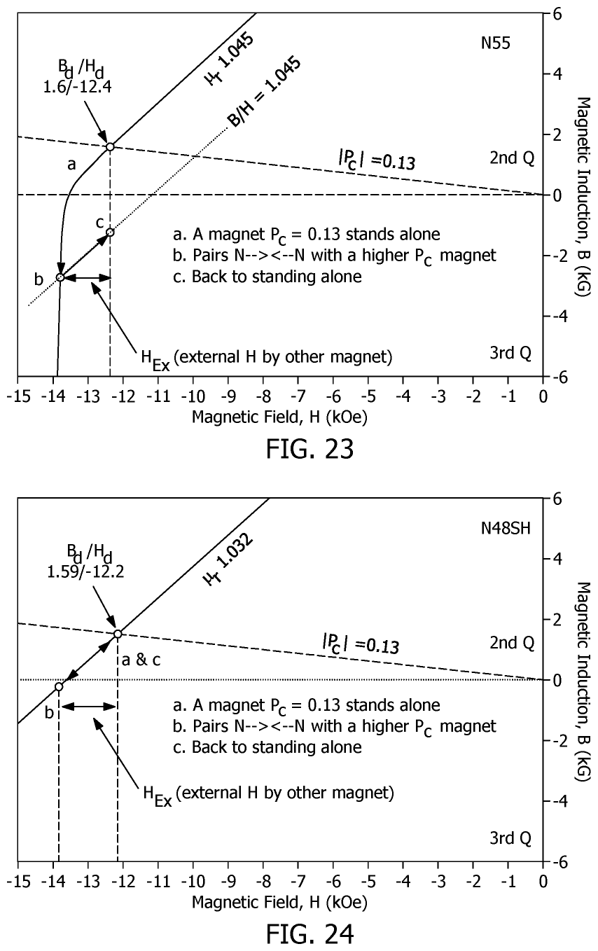

As discussed herein, the LD level is related to the P_{c} ratio, and it is also linked to the linearity of the B-H curves in the 2^{nd} and part of the 3^{rd} quadrant. Referring to FIG. 1, the B-H curves of N55 magnets, N48SH magnets, and SmCo30 magnets are shown, and the linearity limits (knee positions) of the B-H curves are approximately 13 kOe, 21.4 kOe, and >21.5 kOe, respectively. Among all three magnets, the B-H curve of the SmCo30 magnets has the best linearity in the 2^{nd} and 3^{rd} quadrants. The small circles at the cross points of the load lines (P_{c} or |B_{d}/H_{d}|) and the B-H curves in FIG. 1 are the working points (B_{d}, H_{d}). The working points are marked on the N55 and SmCo30 curves in FIG. 1 for four load lines with P_{c}=0.13, 0.61, 1.41, and 24. Table 4 below also lists the working points for N55 magnets, N48SH magnets, and SmCo30 magnets tested in this investigation for the four load lines with P_{c}=0.13, 0.61, 1.41, and 24. When two unequally sized magnets with different P_{c} are paired with the like poles facing one another (e.g., are N→←N paired), the magnet with a lower P_{c}, which has an internal self-demagnetization field Ha, will be affected by an external field Hex from the magnet with a higher P_{c}. The total demagnetizing field is the sum of Ha and Hex, as shown in FIGS. 23 and 24. If the sum exceeds the linearity limits, the flux (B) loss will be unrecoverable. FIG. 23 shows how an N55 magnet with P_{c}=0.13 loses its flux (B) after the magnet is N→←N paired with a magnet having a higher P_{c}. The stand-alone magnet has working point “a”, and it drops to point “b” while pairing with the magnet having a higher P_{c}. After the pair separates, the magnet having the lower P_{c} can only return to point “c”, as it needs to return to its stand-alone condition along the line parallel to its relative permeability μᵣ=1.045. This large flux (B) loss is due to the nonlinear B-H curve of N55 magnets, and the working point “a” of this magnet is very close to the knee of the B-H curve. In this aspect, N48SH magnets and SmCo30 magnets would not be expected to exhibit such unrecoverable losses, provided the total demagnetizing field is well below the linearity limits, 21.4 kOe and 21.5 kOe, respectively (see FIG. 1 for details of the B-H curve). FIG. 24, for example, illustrates how an N48SH magnet with P_{c}=0.13 maintains its flux (B) after being N→←N paired with a magnet with a higher P_{c}. This explains why N48SH magnets and SmCo30 magnets do not show the unusual behavior of F₄<F₁ at a small gap, and this recoverable LD is a unique characteristic to be utilized in some novel applications discussed in more detail herein.

TABLE 4
Working points B_{d} and H_{d} for various tested
magnets (see FIG. 1 for the B—H curves)

| Pc or | Working point, B_{d} (kG) & H_{d} (kOe) | | | | | |
|---|---|---|---|---|---|---|
| load-line | N55 | | N48SH | | SmCo30 | |
| \|B_{d}/H_{d}\| | B_{d} | H_{d} | B_{d} | H_{d} | B_{d} | H_{d} |
| 0.13 | 1.6 | −12.4 | 1.59 | −12.2 | 1.2 | −9.2 |
| 0.61 | 5.4 | −8.8 | 5.3 | −8.7 | 4.1 | −6.7 |
| 1.41 | 8.5 | −6.0 | 8.0 | −5.7 | 6.1 | −4.3 |
| 24 | 14.2 | −0.59 | 13.7 | −0.57 | −10.8 | 0.45 |

The concepts used in this analysis have previously been reported, for example, in B. D. Cullity et al., Introduction to Magnetic Materials, 2^{nd} Edition, IEEE Press, ISBN 978-0-47147741-9, pp. 478-484; Rollin J. Parker, Advances in permanent magnetism, ISBN 0-471-82293-0, 1990, pp. 22-25, pp. 149-154; Peter Campbell, Permanent magnet materials and their application, ISBN 0-521-24996-1, 1994, pp. 88-97; and D. Egorov et al., “Linear recoil curve demagnetization models for ferrite magnets in rotating machinery”, FIG. 4, DOI: 10.1109/IECON.2017.8216344, IECON 2017—43^{rd} Conference of the IEEE Industrial Electronics Society, the disclosures of which are hereby incorporated by reference in their entirety. From the foregoing, it can be observed that the linearity of the B-H curve and the magnet's load line or permeance coefficient play important roles in the LD level and recoverability after the magnet separates from the N→←N pairing.

As described above, localized demagnetization (LD) is identified for pairs of unequally sized magnets when paired by their like poles (e.g., N→<N paired) as their P_{c} values are different, in which the pole of the magnet with a higher P_{c} causes a LD to the pole of the magnet with a lower P_{c}. If the LD is large enough, the polarity of the localized area can be reversed, resulting in an attraction between two like poles in the LD area at a small gap between the pair of magnets. Two unusual behaviors are observed in this investigation. First, a turning point, TP, appears on the curves of the force v. gap for the like poles of the unequally sized magnets. The TP results in nonmonotonic curves, even an attraction for some like poles. Second, for some Nd—Fe—B magnets with a low coercivity and nonlinear B-H curve in the 2^{nd} quadrant, a repulsion can occur between the unlike poles of a pair of unequally sized magnets after having been previously paired with their like poles that left an unrecoverable LD and reversed polarity area. The unusual behaviors are not contradictory to the basic law of magnetism, and they are caused by the localized demagnetization LD, as the localized attracting area corresponds to unlike poles resulting from LD. A higher P_{c} ratio results in a greater LD; the linearity of the B-H curves and the load line or permeance coefficient also play important roles in the LD level. The LD level can be visualized and determined by mapping the surface flux.

The linearity of the B-H curve and the magnet's load line or permeance coefficient play important roles in the LD level and its recoverability after the magnet separates from the N→←N (or S→←S) pairing. For N55 magnets that have a nonlinear B-H curve in the 2^{nd} quadrant, especially for N55 magnets with a small length L or thickness, the LD is mostly unrecoverable. Similar to N55 magnets, Alnico magnets may also show the same unusual phenomena. For N48SH magnets and SmCo30 magnets that have linear B-H curves in the 2^{nd} quadrant and part of the 3^{rd} quadrant, the LD is mostly recoverable after the pair is separated after having been paired by their like poles. If pairs of SmCo30 magnets or N48SH magnets have a proper P_{c} ratio, the like poles can also appear to attract each other. Since the LD is recoverable, some novel applications may be developed for utilizing these newly discovered unique characteristics, examples of which will become more apparent by reference to the embodiments described in more detail below.

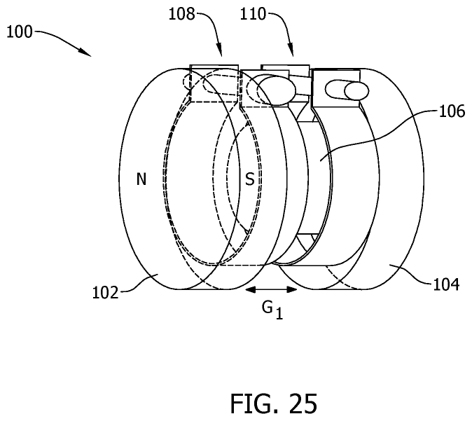

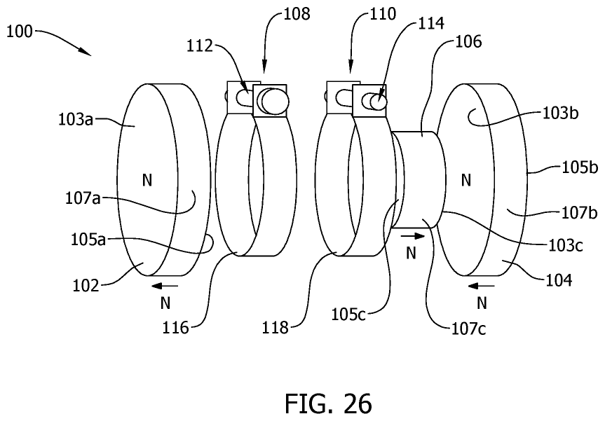

With reference to FIGS. 25 and 26, an example magnetic assembly 100 illustrated in the form of a vibrating magnetic assembly or device (or, simply, a vibrator) is shown. The assembly 100 includes stationary magnets 102 and 104, a movable magnet 106, and actuators 108 and 110. The stationary magnets 102 and 104 are arranged such that the N side of the stationary magnet 104 faces the S side of the stationary magnet 102. The moveable magnet 106 is positioned between the stationary magnets 102 and 104. The N side of the moveable magnet 106 is oriented toward, or faces, the N side of magnet 104, and the S side of the moveable magnet 106 is oriented toward, or faces, the S side of magnet 102. As used herein, the term “N side” refers to the magnetic north (N) side of the magnet, also called the magnetic north (N) pole, and the term “S side” refers to the magnetic south (S) side of the magnet, also called the magnetic south (S) pole.

The stationary magnets 102 and 104 are spaced apart by a distance G₁. The distance G₁ can be any suitable distance that enables the magnetic assembly 100 to function as described herein. In some embodiments, the distance G₁ is in the range of about 5 mm to about 200 mm. The term “stationary” used to describe the magnets 102 and 104 means that the magnets 102 and 104 are translationally fixed in terms of spatial relation to one another, such that the distance G₁ remains substantially unchanged during operation of the magnetic assembly. It should be appreciated, however, that some movement of the magnets 102 and 104 relative to one another, as well as rotational movement of the magnets 102 and 104, may occur during operation of the magnetic assembly without departing from the scope of this embodiment.

The moveable magnet 106 is reciprocable between the stationary magnet 102 and the stationary magnet 104 to cause vibration of the magnetic assembly 100. More specifically, the moveable magnet 106 reciprocates between a position where the N side of the moveable magnet 106 is positioned adjacent to the N side of the magnet 104, and a position where the S side of the moveable magnet 106 is positioned adjacent to the S side of the magnet 102. As such, the moveable magnet 106 traverses the distance G₁ as the moveable magnet 106 reciprocates between the stationary magnets 102 and 104.

The magnets 102, 104 and 106 are suitably sized and shaped to use the LD phenomena and TP rule, as described in detail herein, to alternate the attraction and repulsion between the movable magnet 106 and each of the stationary magnets 102 and 104. The geometry (e.g., outer diameter and length or thickness) of the magnets 102, 104 and 106, and the type of magnets used, are such that, for the alternating pairings between like poles of the moveable magnet 106 and each of the stationary magnets 102 and 104, an attracting force is created when the center of moveable magnet 106 is axially aligned with the center of the respective stationary magnet 102 and 104 and the moveable magnet 106 is within a threshold distance from the respective stationary magnet 102 and 104. The threshold distance corresponds to the point on the force F₂ v. gap curve of the moveable magnet 106 and the stationary magnet 102 or 104 pairing at which the repulsive force between the magnets 102 and 106 or 104 and 106 transitions to an attractive force due to the LD phenomena and the TP rule, as described in detail herein. In this regard, the threshold distance may vary based on the geometry and type of magnets used. In some examples, the threshold distance may be less than about 2 mm. Moreover, the geometry of the magnets 102, 104, and 106, and the type of magnets used, may vary based on design requirements to any geometry or type of magnet that enables the magnet assembly 100 to function as described herein. For example, the magnets 102, 104, and 106 may be any type of magnet that facilitates a magnetic attractive force between the moveable magnet 106 and the respective stationary magnet 102 and 104 when the magnets 102 and 106 or the magnets 104 and 106 are like-pole paired and brought within a threshold distance of each other while axially aligned. In some examples, each of the magnets 102, 104, and 106 is an Nd—Fe—B magnet.

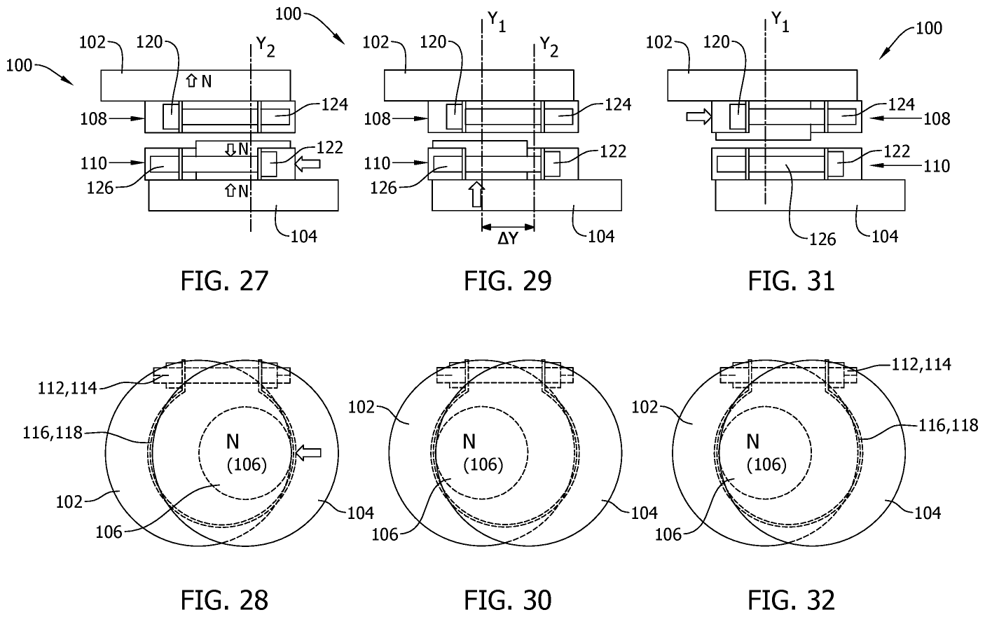

In the example embodiment, each of the magnets 102, 104, and 106 is a cylindrically-shaped magnet (i.e., the magnets 102, 104, and 106 are disc magnets). As shown in FIG. 26, the magnets 102, 104, and 106 each have, respectively, a first or front surface 103a, 103b, and 103c, a second or back surface 105a, 105b, and 105c, and a circumferential surface 107a, 107b, and 107c joining the respective front surface 103a, 103b, and 103c and back surface 105a, 105b, and 105c. The front surface 103a, 103b, and 103c is the N side of the respective magnet 102, 104, and 106, and the back surface 105a, 105b, and 105c is the S side of the respective magnet 102, 104, and 106. Accordingly, the front surface 103b of the stationary magnet 104 is oriented toward, or faces, the back surface 105a of the stationary magnet 102. The front surface 103c of the moveable magnet 106 faces the front surface 103b of the stationary magnet 104, and the back surface 105c of the moveable magnet 106 faces the back surface 105a of the stationary magnet 102. The front surface 103a, 103b, and 103c of each magnet 102, 104, and 106 is planar and generally parallel to the respective back surface 105a, 105b, and 105c, which is also planar. Each magnet 102, 104, and 106 also includes a center or central axis extending through a center of the respective magnet 102, 104, and 106 and substantially perpendicular to the respective front surface 103a, 103b, and 103c and back surface 105a, 105b, and 105c. The center axes Y₁ and Y₂ of the stationary magnets 102 and 104, respectively, are shown in FIGS. 27-32. The center axis of the moveable magnet 106 is not shown, but shifts between axial alignment with the center axis Y₁ and the center axis Y₂ as the moveable magnet 106 moves between the stationary magnets 102 and 104, as described in further detail below. Each magnet 102, 104, and 106 includes an outer diameter, measured as a straight line between opposing sides of the magnet 102, 104, and 106 and perpendicular to the center axis, and a length or thickness measured between the front surface 103a, 103b, and 103c and the back surface 105a, 105b, and 105c. The outer diameter may be referred to herein as “OD” and the length or thickness may be referred to herein as “L.” The terms “length” and “thickness” may be used interchangeably when describing the geometric dimensions of a magnet unless specifically described otherwise.

The magnets 102, 104, and 106 may have any suitable outer diameter and thickness that enable the magnetic assembly 100 to function as described herein. As described above, for example, the geometry of magnets 102, 104, and 106 are suitably selected, in combination with the type of magnet, to induce localized demagnetization and the turning point phenomenon when the moveable magnet 106 is oriented in a like pole orientation and axially aligned with and positioned within a threshold distance of one of stationary magnets 102 or 104. In some embodiments, the moveable magnet 106 may have an outer diameter in the range of about 2 mm to about 100 mm and a thickness in the range of about 2 mm to about 20 mm. In some examples, the outer diameter of the moveable magnet 106 is in the range of about 3 mm to about 10 mm and the thickness of the moveable magnet 106 is in the range of about 1.5 mm to about 5 mm. In some embodiments, the stationary magnets 102 and 104 may each have an outer diameter in the range of about 8 mm to about 250 mm and a thickness in the range of about 0.5 mm to about 20 mm. In some examples, the stationary magnets 102 and 104 each have an outer diameter in the range of about 8 mm to about 20 mm and a thickness in the range of about 1.5 mm to about 10 mm. In some examples, the stationary magnets 102 and 104 suitably have the same geometry (i.e., the same outer diameter and/or thickness).

The geometries are such that each of the magnets 102, 104, and 106 has a suitable permeance coefficient P_{c,102}, P_{c,104}, and P_{c,106}, respectively, to induce localized demagnetization and like-pole attraction. That is, the moveable magnet 106 is unequally sized with each of the stationary magnets 102 and 104 such that P_{c,106} is greater than each of P_{c,102} and P_{c,104} to achieve ratios P_{c,106}/P_{c,102} and P_{c,106}/P_{c,104} greater than 1 and, more suitably, greater than 2. For example, in some embodiments, each of the ratios P_{c,106}/P_{c,102} and P_{c,106}/P_{c,104} is suitably in the range of 2 to about 300, in the range of about 10 to about 250, in the range of about 50 to about 225, or in the range of about 100 to about 200. In some embodiments, the stationary magnets 102 and 104 have the same permeance coefficient P_{c,102}=P_{c,104}, such that P_{c,106}/P_{c,102}=P_{c,106}/P_{c,104}. Permeance coefficient ratios P_{c1}/P_{c2} may also be represented as P_{c1}:P_{c2}. An LD effect based on the P_{c} ratios (P_{c,106}:P_{c,102} and P_{c,106}:P_{c,104}) of the respective magnet pairings 102 and 106 and 104 and 106 is such that a TP can be observed on the force v. gap curves of each of these pairings when the magnets 102 and 106 or 104 and 106 are axially aligned (i.e., are aligned along their respective center axes) and brought to within a threshold distance of each other. Moreover, the LD effect based on the P_{c} ratios is such that, when axially aligned and brought within the threshold distance, the force between the like poles (i.e., N—N or S—S) of the magnets 102 and 106 or 104 and 106 transitions from magnetic repulsion to magnetic attraction. Accordingly, when the moveable magnet 106 is in axial alignment with the stationary magnet 102 or 104 and the located within the threshold distance from magnet 102 or 104, the moveable magnet 106 is held in position relative to the stationary magnet 102 or 104 by a magnetic attractive force. When the moveable magnet 106 is brought out of axial alignment with the stationary magnet 102 or 104, that is, when the center axes are no longer aligned, the like poles repel one another. This is because the LD phenomena occurs at a localized area in the center of the like pole side of the magnet that has the lower P_{c}, that is, the stationary magnets 102 and 104. As such, the moveable magnet 106 may be propelled away from the respective stationary magnet 102 or 104 due to the repulsion between the like N—N poles or like S—S poles outside of the localized area at which the LD phenomena occurs. The geometry of the magnets 102, 104, and 106 may be suitably selected such that, when the moveable magnet 106 is brought out of axial alignment with the stationary magnet 102 or 104, the repulsive force between the like poles is great enough to cause the moveable magnet 106 to accelerate from one of the stationary magnets 102 or 104 toward the other one of the stationary magnets 102 or 104 and strike the other stationary magnet with sufficient force to cause vibration of the magnetic assembly 100.

The moveable magnet 106 can be moved out of axial alignment with the stationary magnet 102 or 104 via the actuators 108 or 110, respectively. In the example embodiment, the actuators 108 and 110 are embodied as spring clips 108 and 110, although other embodiments may include actuators other than spring clips. The spring clips 108 and 110 are coupled to the stationary magnets 102 and 104, respectively (e.g., directly, or indirectly, for example, by holders 112 and 114). In the example embodiment, the spring clip 108 is positioned adjacent to the S side, and coupled to the back surface 105a, of the stationary magnet 102, and the spring clip 110 is positioned adjacent to the N side, and coupled to the front surface 103b, of the stationary magnet 104. As shown in FIG. 26, each of the spring clips 108 and 110 includes, respectively, a holder 112 and 114 and a flat spring 116 and 118. Each of the holders 112 and 114, respectively, has a head 120 and 122 and a shaft 124 and 126 (shown in FIGS. 27-32). The respective shafts 124 and 126 of the holders 112 and 114 extend through holes (not shown) located at ends of the flat spring 116 and 118. The flat springs 116 and 118 are generally U-shaped, with the ends joined by the respective shaft 124 and 126, and the flat springs 116 and 118 are configured to deflect in response to a load applied to the respective spring clips 108 and 110. In some embodiments, the width of the flat springs 116 and 118, defining the distance that the flat springs 116 and 118 extend outward from the respective stationary magnet 102 and 104, may be substantially the same as the thickness of the moveable magnet 106. The heads 120 and 122 prevent deflection of the respective flat springs 116 and 118 in an outward direction, causing the unconnected or free ends of the flat springs 116 and 118 to compress toward each other about the respective shaft 124 and 126. The U-shaped configuration of the flat spring 116 and 118 defines an opening configured to receive the moveable magnet 106 as the moveable magnet 106 moves toward the respective stationary magnet 102 and 104. In the example embodiment, each flat spring 116 and 118 is axial offset from (i.e., not concentrically aligned with) the respective stationary magnet 102 and 104 (i.e., the flat springs 116 and 118 are positioned out of axial alignment with the respective stationary magnets 102 and 104). In this configuration, as the moveable magnet 106 moves toward either the stationary magnet 102 or 104, and the moveable magnet 106 is received into the opening of the respective flat spring 116 and 118, the moveable magnet 106 is positioned near a wall of the flat spring 116 and 118, for example, on the side of the head 120 and 122 of the holder 112 and 114. When the flat spring 116 and 118 deflects inward relative to the holder 112 and 114, for example in response to an external load applied to the holder 112 and 114, the moveable magnet 106 is moved out of axial alignment with the respective stationary magnet 102 and 104. Except for the three magnets 102, 104, and 106, all other parts and components of the magnetic assembly 100 can be constructed made of non-magnetic materials, so the magnetic fluxes of the three magnets will not be disturbed.

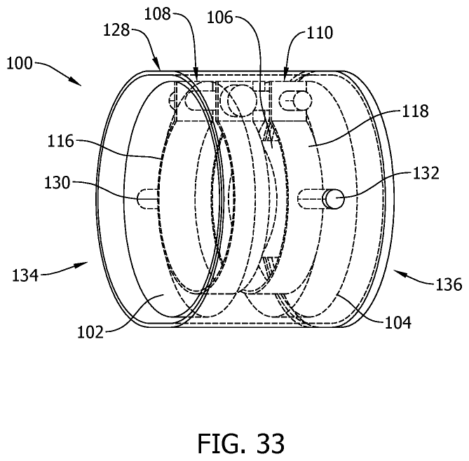

FIGS. 27-32 illustrate movement of the moveable magnet 106 between the stationary magnets 102 and 104 of the magnetic assembly 100. In the initial position (FIGS. 27 and 28), the moveable magnet 106 is positioned against the stationary magnet 104, and the center of the moveable magnet 106 is axially aligned with the center of the stationary magnet 104, such that the center axis of the moveable magnet 106 is aligned with the center axis Y₂ of the stationary magnet 104. Due to the LD phenomena as described above, the moveable magnet 106 is held in position against the stationary magnet 104 by a magnetic attractive force, even though the N pole of the moveable magnet 106 faces the N pole of the stationary magnet 104. The spring clip 110 is arranged such that the moveable magnet 106 is positioned within the opening of the flat spring 118 with the circumferential surface 107c of the moveable magnet 106 near or in contact with a wall of the flat spring 118. As shown in FIGS. 29 and 30, the moveable magnet 106 can be moved out of axial alignment with the stationary magnet 104 by the spring clip 110 (e.g., via a suitable trigger or actuator pin 132, shown in FIGS. 33-35) such that the center axis of the moveable magnet 106 is moved out of axial alignment with the center axis Y₂ of the stationary magnet 104. Suitably, the moveable magnet 106 is thereby moved outside of the localized area of the N side of the stationary magnet 104 at which the LD phenomena occurs.

As shown in FIGS. 31 and 32, when the moveable magnet 106 is moved out of axial alignment with the stationary magnet 104, the magnetic attractive force between the stationary magnet 104 and the moveable magnet 106 transitions to a magnetically repulsive force, and the moveable magnet 106 is repelled by the stationary magnet 104. As a result, the moveable magnet 106 is accelerated toward the stationary magnet 102 and strikes the stationary magnet 102 to cause vibration of the magnetic assembly 100. At this stage, the center axis of the moveable magnet 106 is axially aligned with the center axis Y₁ of the stationary magnet 102. Thus, as the moveable magnet 106 moves toward the stationary magnet 102 and the distance between the magnets 102 and 106 reduces to within the threshold distance, the magnetic repulsive force between the like S poles of the magnets 102 and 106 transitions to a magnetic attractive force. When the moveable magnet 106 strikes the stationary magnet 102, the moveable magnet 106 is received in the opening of the flat spring 116 of the spring clip 108. The spring clip 108 is arranged such that when the moveable magnet 106 is in axial alignment with the stationary magnet 102, the circumferential surface 107c of the moveable magnet 106 is near or in contact with a wall of the flat spring 116. In this configuration, the flat spring 116 will be impacted by vibrational force caused when the moveable magnet 106 strikes the stationary magnet 102. This acts as a force on the spring clip 108, causing the flat spring 116 to compress and push the moveable magnet 106 from the center to the edge of the stationary magnet 102, and outside of the localized area of the S side of the stationary magnet 102 at which the LD phenomena occurs. The center axis of the moveable magnet 106 is thereby axially offset with the center axis Y₁ of the stationary magnet 102, and the S pole of the moveable magnet 106 is repelled by the S pole of the stationary magnet 102. Additionally, the center axis of the moveable magnet 106 is again axially aligned with the center axis Y₂ of the stationary magnet 104, and the repelling force between the moveable magnet 106 and the stationary magnet 102 causes the moveable magnet 106 to accelerate toward and strike the stationary magnet 104, again causing a vibrational force of the magnetic assembly. The moveable magnet 106 and the stationary magnet 104 again attract each other as the distance between the magnets 104 and 106 reduces to within the threshold distance. At this stage, the flat spring 118 deflects to move the moveable magnet 106 out of axial alignment with the stationary magnet 104, and movement of the magnet 106 repeats to cause vibration of the magnetic assembly 100. During the course of operation, the magnetic assembly 100 may experience energy losses in the form of frictional losses. Additionally, operation of assembly 100 may result in abrasion and fatigue of the components (e.g., spring clip 108), as well as abrasion and heat-related demagnetization of magnets 102, 104 and 106. Accordingly, replacement of parts may be necessary over the lifetime of assembly 100.

As shown in FIGS. 29 and 30, the stationary magnets 102 and 104 are axially offset relative to each other, such that the center axis Y₁ of the stationary magnet 102 and the center axis Y₂ of the stationary magnet 104 are parallel but spaced apart by a distance ΔY. The distance ΔY is suitably greater than the outer radius of stationary magnet 106 and less than the radius of the stationary magnets 102 and 104, i.e.,

$$( \frac{OD ( 106 )}{2} < Δ Y < \frac{OD ( 102 , 104 )}{2} ) .$$

In this configuration, movement of the moveable magnet 106 away from the center of one of the stationary magnets 102 and 104 allows the moveable magnet 106 to be axially aligned with the other one of the stationary magnets 102 and 104. In FIGS. 29 and 30, this can be observed as the moveable magnet 106 is moved out of axial alignment with the stationary magnet 104 and the moveable magnet 106 is moved a distance ΔY such that the center axis of the moveable magnet 106 is in axial alignment with the center axis Y₁ of the stationary magnet 102.

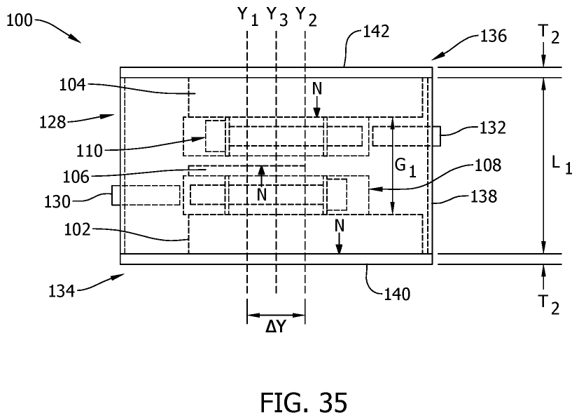

With reference to FIGS. 33-35, the magnetic assembly can also include a housing 128 and one or more actuator pins 130, 132. The housing 128 defines a cavity (not labeled), and is sized and shaped to enclose each of the magnets 102, 104, and 106 therein. The housing 128 is shaped as a flattened cylinder in this example, although the housing 128 may have any other suitable shape that enables the magnetic assembly 100 to function as described herein. The housing 128 extends from a first end 134 to a second end 136 along a center axis Y₃ (FIG. 35). The stationary magnet 102 is located at the first end 134 and the stationary magnet 104 is located at the second end 136. As described above, the N side of the stationary magnet 104 is oriented toward, or faces, the S side of the stationary magnet 102. In the example embodiment, the housing 128 includes a tubular body 138 that is open at the first end 134 and the second end 136. The tubular body 138 defines the interior cavity and surrounds the magnets 102, 104, and 106 and the spring clips 108 and 110. A first cover 140 is attached to the tubular body 138 at the first end 134 and a second cover 142 is attached to the tubular body 138 at the second end 136. The first and second covers 140 and 142 enclose the interior cavity defined by the tubular body 138. The housing 128 and pins 130 and 132 are suitably made from non-magnetic material(s). In one example, the housing 128 (i.e., the body 138 and the covers 140 and 142) are made from 304 stainless steel, and the pins 130 and 132 are made from titanium.

As shown in FIG. 35, each of the center axes Y₁ and Y₂ of the stationary magnets 102 and 104, respectively, extend substantially parallel to the center axis Y₃ of the housing 128. Additionally, in the example embodiment, each of the stationary magnets 102 and 104 are axially offset with the center of the housing 128, such that the axes Y₁ and Y₂ are spaced apart from the axis Y₃. For example, each of the stationary magnets 102 and 104 are positioned such that the axes Y₁ and Y₂ are spaced apart from the axis Y₃ by an equal distance, i.e., ΔY/2. The stationary magnets 102 and 104 may have any other suitable position to enable the magnetic assembly 100 to function as described herein. For example, in some embodiments, one of the stationary magnets 102 or 104 may be axially aligned with the center of the housing such that the respective axis Y₁ or Y₂ overlaps the axis Y₃.

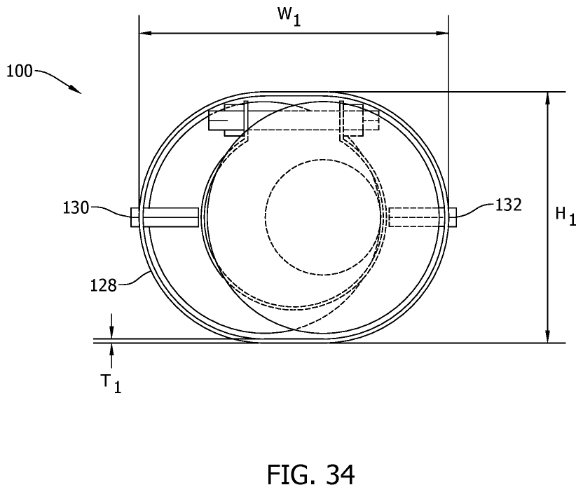

The housing 128 is suitably sized and shaped to enable the stationary magnets 102 and 104 to be positioned as described above. In the example embodiment, the body 138 of the housing 128 has a pseudo-cylindrical shape with an oval or oblong cross-section (shown in FIG. 34). As shown in FIGS. 34 and 35, the body 138 has a width W₁, a height H₁, and a length L₁. In general, the dimensions of the body 138 can be selected based on the size and shape of the magnets 102, 104, and 106. The width W₁ is a suitable size to enable the stationary magnets 102 and 104 to be positioned in axial offset relation to one another, as described above. In some embodiments, for example, the width W₁ may be in the range of about 14 mm to about 26 mm. The height H₁ is a suitable size to provide clearance for the stationary magnets 102 and 104, and can be selected based on the outer diameter of the magnets 102 and 104. In some embodiments, for example, the height H₁ may be in the range of about 10 mm to about 22 mm. In general, the height H₁ is smaller than the width W₁ due to the oval cross-section of the body 138. The height H₁ and width W₁ are each measured at the outer side of the body 138, which has a thickness T₁, for example, in the range of about 0.2 mm to about 1 mm. The length L₁ is a suitable size to enable movement of the moveable magnet 106 between the stationary magnets 102 and 104, and therefore can be selected based on the distance G₁ between the stationary magnets 102 and 104. The ends of the body 138 may be flush with the front surface 103a of the stationary magnet 102 and the back surface 105b of the stationary magnet 104, in which case the length L₁ is the sum of the distance G₁ and the thickness of the stationary magnets 102 and 104. In some embodiments, for example, the length L₁ is in the range of about 6 mm to about 28 mm. A total axial length of the housing 128 is the sum of the length L₁ and a thickness T₂ of the covers 140 and 142. The thickness T₂ is the same for both covers 140 and 142, and may be, for example, in the range of about 0.5 mm to about 2 mm. The total axial length of the housing 128 may be, for example, in the range of about 7 mm to about 30 mm. The covers 140 and 142 are both oval discs, and may suitably have substantially the same height and width as the body 138.

The pins 130 and 132 each extend through a hole (not shown) on a side of the body 138 of the housing 128, and are configured to contact the flat springs 116 and 118, respectively. The pins 130 and 132 are cylindrically shaped, and are suitably dimensioned, for example, with a length extending through the housing 128 a suitable distance to contact the side of the respective flat spring 116 and 118. In some embodiments, each pin 130 and 132 has a length of at least about 4 mm, and an outer diameter in the range of about 1 mm to about 2 mm. Suitably, each pin 130 and 132 is configured to contact the side of the respective flat spring 116 and 118 that the moveable magnet 106 is positioned near to or in contact with when the moveable magnet 106 is received by the flat spring 116 and 118, as described above. In this configuration, the pins 130 and 132 are located on opposite sides of the housing 128. The pins 130 and 132 may be biased by a user or by an external actuator (not shown) to cause the respective flat spring 116 and 118 to deflect radially inward to cause the moveable magnet 106 to move out of axial alignment with the respective stationary magnet 102 and 104. In this regard, the pins 130 and 132 may be utilized to initiate operation of the magnetic assembly 100. Additionally, the pins 130 and 132 may be used to cease operation (i.e., vibration) of the magnetic assembly 100, for example, by selectively preventing the respective flat spring 116 and 118 from deflecting when the moveable magnet 106 strikes the respective stationary magnet 102 and 104. In some embodiments, the flat springs 116 and 118 may not sufficiently deflect when the moveable magnet 106 strikes the respective stationary magnet 102 and 104, and the pins 130 and 132 are utilized to initiate each stroke of the moveable magnet 106 between the stationary magnets 102 and 104.

The magnetic assembly 100 described above and illustrated in FIGS. 25-35 can have various physical implementations to provide technical advantages over existing magnetic assemblies. Example magnetic assemblies 100 in accordance with the present disclosure can be used, for example, for various products, including for example and without limitation, health products, household kitchen devices, portable electronic devices, and lab mixers. Conventional electromagnetic vibrators are based on the alternative attraction and repulsion between the permanent magnet and electromagnet or both electromagnets induced by the electromagnet polarity change from the AC current directional change. Therefore, AC power supplies and electromagnetic coils are needed in these conventional vibrators, imposing weight, volume, and cost challenges in portable electronic devices such as cell phones and game machines which use the vibrators for vibrating alert. The above-described embodiments use the LD phenomena and TP rule to alternate the attraction and repulsion between a moveable magnet and two stationary magnets by changing the position of the moveable magnet relative to the stationary magnets (for example with an aid from non-magnetic flat springs), without the need for AC power supplies.

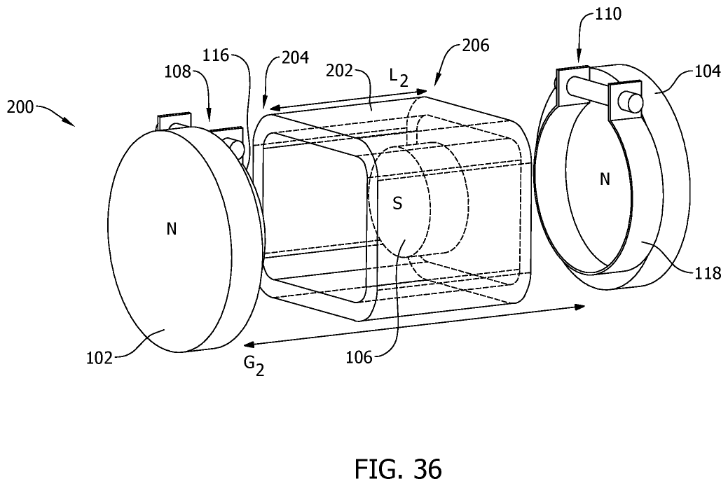

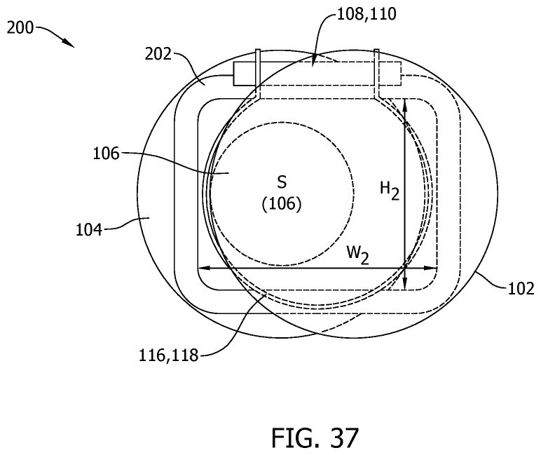

With reference to FIGS. 36 and 37, an example embodiment of an electric generator device 200 in accordance with the present disclosure is shown. The electric generator device 200 can include the same features and components as the magnetic assembly 100 shown and described above with reference to FIGS. 25-35. For example, the illustrated electric generator device 200 includes the stationary magnets 102 and 104, the movable magnet 106, and the spring clips 108 and 110 coupled to the stationary magnets 102 and 104, respectively. The positioning and orientation of the magnets 102, 104, and 106, and the geometric and magnetic properties of the magnets 102, 104 and 106 are as described above and shown in FIGS. 25-35. In particular, as described above, the geometries of the magnets 102, 104, and 106 are such that each of the magnets 102, 104, and 106 has a suitable permeance coefficient P_{c,102}, P_{c,104}, and P_{c,106}, respectively, where P_{c,106} is greater than each of P_{c,102} and P_{c,104} to achieve ratios P_{c,106}/P_{c,102} and P_{c,106}/P_{c,104} above 1 and, more suitably, above 2. For example, in some embodiments, each of the ratios P_{c,106}/P_{c,102} and P_{c,106}/P_{c,104} is suitably the range of about 2 to about 300, in the range of about 10 to about 250, in the range of about 50 to about 225, or in the range of about 100 to about 200. In addition, the spring clips 108 and 110 are configured as described above and include flat springs 116 and 118, respectively. In some embodiments, the magnets 102 and 104 have the same permeance coefficient P_{c,102}=P_{c,104}, such that P_{c,106}/P_{c,102}=P_{c,106}/P_{c,104}. In the example embodiment, as described above, the stationary magnets 102 and 104 are axially offset with one another, and the S side of the stationary magnet 102 is oriented toward, or faces, the N side of the stationary magnet 104. The spring clip 108 is positioned adjacent the S side of the magnet 102, and the spring clip 110 is positioned adjacent the N side of the magnet 104, respectively. The N side of the moveable magnet 106 is oriented toward, or faces, the N side of the stationary magnet 104 and the S side of the moveable magnet 106 faces the S side of the stationary magnet 102. The moveable magnet 106 is reciprocable between the stationary magnets 102 and 104, and the electric generator device 200 implements the LD phenomena and TP rule to alternate magnet repulsion and attraction between the like poles of the magnet 102 and 106 or 104 and 106, as described above.

The electric generator device 200 also includes an electrically conductive coil 202 positioned between stationary magnets 102 and 104. The coil 202 may be made of any conductive material, including, for example and without limitation, copper, aluminum, and combinations thereof. The coil 202 extends around a path of motion traversed by the moveable magnet 106 when the moveable magnet 106 reciprocates between the stationary magnets 102 and 104. The coil 202 may have any shape known in the art (e.g., coil, spiral, helix) that enables the moveable magnet 106 to reciprocate through the coil 202. The coil has an inner height H₂ and an inner width W₂, which are suitably sized to provide clearance as the moveable magnet 106 reciprocates through the coil 202. The height H₂ and width W₂ can be selected based on the outer diameter of the moveable magnet 106. In some embodiments, for example, the height H₂ and width W₂ may each be in the range of about 10 mm to about 40 mm. In one example, the coil 202 has a square cross-section such that the height H₂ and width W₂ are the same size. In embodiments where the coil has a circular cross-section, the inner diameter may be within the same size range as the height H₂ and width W₂. The coil 202 extends a length L₂ from a first end 204 proximate the stationary magnet 102 to a second end 206 proximate the stationary magnet 104. In some embodiments, the length L₂ can be in the range of about 8 mm to about 100 mm, such as in the range of about 10 mm to about 40 mm.

When the electric generator device 200 is assembled, the stationary magnets 102 and 104 are spaced a distance or gap G₂ that defines a total stroke of the moveable magnet 106 as it reciprocates between the stationary magnets 102 and 104. The distance G₂ is suitably greater than the length L₂ of the coil 202. In some embodiments, for example, the distance G₂ is in the range of about 15 mm to about 300 mm. In the example embodiment, the distance G₂ is greater than the sum of the widths of the springs 116 and 118 and the length L₂ of coil 202. As such, a gap exists between the first end 204 of the coil 202 and the spring clip 108 and a gap exists between the second end 206 of the coil 202 and the spring clip 110.

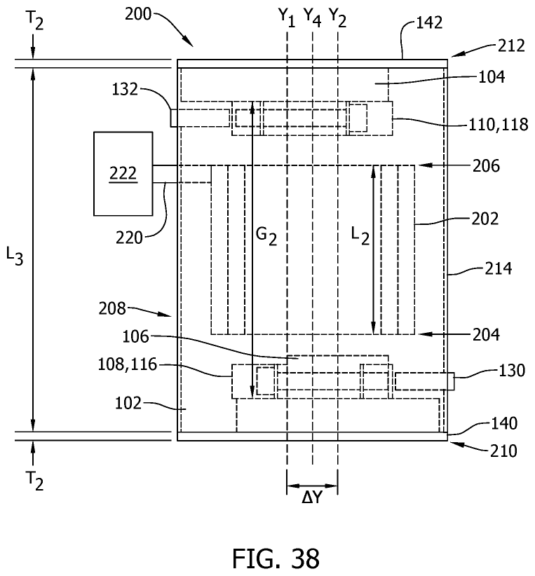

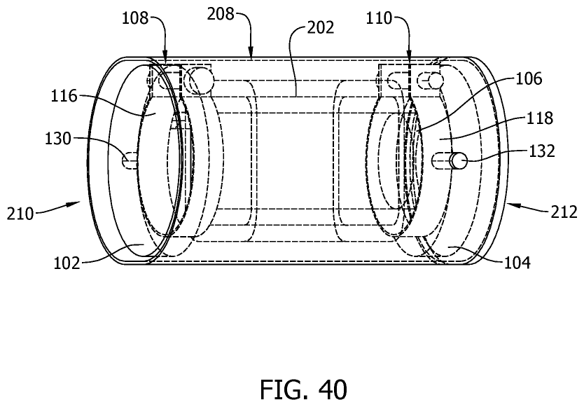

With reference to FIGS. 38-40, the electric generator device 200 can also include a housing 208, as well as the actuator pins 130 and 132. The housing 208 defines a cavity (not labeled), and is sized and shaped to enclose each of the magnets 102, 104, and 106 as well as the coil 202 therein. The housing 208 is shaped as a flattened cylinder in this example, although the housing 208 may have any other suitable shape that enables the electric generator device 200 to function as described herein. The housing 208 extends from a first end 210 to a second end 212 along a center axis Y₄. The stationary magnet 102 is located at the first end 210 and the stationary magnet 104 is located at the second end 212. In the example embodiment, the housing 208 includes a tubular body 214 that is open at the first end 210 and the second end 212. The tubular body 214 defines the interior cavity and surrounds the magnets 102, 104, and 106 and the coil 202. The first cover 140 is attached to the tubular body 214 at the first end 210 and the second cover 142 is attached to the tubular body 214 at the second end 212. The first and second covers 140 and 142 enclose the interior cavity defined by the tubular body 214. The housing 208 and pins 130 and 132 are suitably made from non-magnetic material(s). In one example, the housing 208 (i.e., the body 214 and the covers 140 and 142) are made from 304 stainless steel, and the pins 130 and 132 are made from titanium. The pins 130 and 132 are configured as described above to be utilized to initiate operation of the electric generator device 200 and to cease operation of the electric generator device 200. The pins 130 and 132 have the same positioning and dimensions as described above.

As shown in FIG. 38, each of the center axes Y₁ and Y₂ of the stationary magnets 102 and 104, respectively, extend substantially parallel to the center axis Y₄ of the housing 208. Additionally, in the example embodiment, each of the stationary magnets 102 and 104 are axially offset from the center of the housing 208, such that the axes Y₁ and Y₂ are spaced apart from the axis Y₄. For example, each of the stationary magnets 102 and 104 are positioned such that the axes Y₁ and Y₂ are spaced apart from the axis Y₄ by an equal distance, i.e., ΔY/2. The stationary magnets 102 and 104 may have any other position suitable to enable the electric generator device 200 to function herein. For example, in some embodiments, one of the stationary magnets 102 or 104 may be axially aligned with the center of the housing such that the respective axis Y₁ or Y₂ overlaps the axis Y₄.

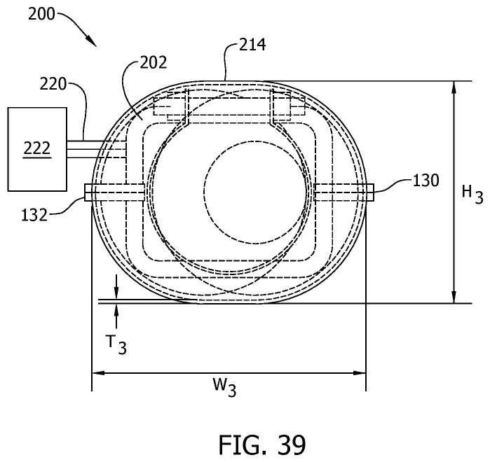

The housing 208 is suitably sized and shaped to enable the stationary magnets 102 and 104 and the coil 202 to be positioned as described above. In the example embodiment, the body 214 of the housing 208 has a pseudo-cylindrical shape with an oval or oblong cross-section (shown in FIG. 39). As shown in FIGS. 38 and 39, the body 214 has a width W₃, a height H₃, and a length L₃. In general, the dimensions of the body 214 can be selected based on the size and shape of the magnets 102, 104, and 106, and the coil 202. Additionally, the body 214 has generally the same cross-section dimensions as the body 138 of the magnetic assembly 100 as described above. The width W₃ is a suitable size to enable the stationary magnets 102 and 104 to be positioned axial offset from one another, as described above. In some embodiments, for example, the width W₃ may be in the range of about 14 mm to about 26 mm. The height H₃ is a suitable size to provide clearance for the stationary magnets 102 and 104, and can be selected based on the outer diameter of the magnets 102 and 104. In some embodiments, for example, the height H₃ may be in the range of about 10 mm to about 22 mm. In general, the height H₃ is smaller than the width W₃ due to the oval cross-section of the body 214. The height H₃ and width W₃ are each measured at the outer side of the body 214, which has a thickness T₃, for example, in the range of about 0.2 mm to about 1 mm. The length L₃ is a suitable size to enable movement of the moveable magnet 106 between the stationary magnets 102 and 104 and through coil 202, and can be selected based on the distance G₂ between the stationary magnets 102 and 104 and the length L₂ of the coil 202. In general, the length L₃ of the body 214 is greater than the length L₁ of the body 138 described above, due to the coil 202. The ends of the body 214 may be flush with the front surface 103a of the stationary magnet 102 and the back surface 105b of the stationary magnet 104, in which case the length L₃ is the sum of the distance G₂ and the thickness of the stationary magnets 102 and 104. In some embodiments, for example, the length L₃ is in the range of about 20 mm to about 50 mm. A total axial length of the housing 208 is the sum of the length L₃ and a thickness T₂ of the covers 140 and 142. The thickness T₂ is the same for both covers 140 and 142, and is the same as described above, for example, in the range of about 0.5 mm to about 2 mm. The total axial length of the housing 208 can be, for example, in the range of about 22 mm to about 54 mm. The covers 140 and 142 are both oval discs, and may suitably have substantially the same height and width as the body 214.

In the example electric generator device 200, the moveable magnet 106 reciprocates between the stationary magnets 102 and 104 as described above with reference to the magnetic assembly 100. In particular, the moveable magnet 106 is reciprocable due to its magnetic interaction with the stationary magnets 102 and 104 and mechanical interaction with the flat springs 116 and 118 of the respective spring clips 108 and 110, as described above with respect to FIGS. 27-32. As the moveable magnet 106 reciprocates between the stationary magnets 102 and 104 and through the coil 202, the movement of the magnet 106 creates a change in magnetic flux, generating an electrical current through the coil 202 according to Faraday's Law. In this regard, the moveable magnet 106 is initially held in axial alignment against one of the stationary magnets 102 and 104 by an attractive force, and by pushing the moveable magnet 106 out of axial alignment with the respective stationary magnet 102 or 104 via a first trigger force (e.g., biasing pin 130 into contact with flat spring 116 or biasing pin 132 into contact with flat spring 118, as described above) and breaking the attractive force, the moveable magnet 106 is repelled by the like pole of the respective stationary magnet 102 or 104. The moveable magnet 106 is then propelled through the coil 202 to the other one of the stationary magnets 102 or 104 with an acceleration and velocity that generates an electrical current through the coil 202. The moveable magnet 106 is then held in axial alignment against the other one of the stationary magnets 102 or 104 by a like pole attracting force, until a pushing force from flat spring 116 or 118 (e.g., caused by biasing the pin 130 or 132) moves the magnet 106 out of axial alignment with the stationary magnet 102 or 104, causing the same effect.

The coil 202 can be electrically coupled to a load 222 via coil leads 220. The load 222 consumes and/or converts the electrical current that is generated through the coil 202 by reciprocating the magnet 106 therethrough. The load 222 can include, for example and without limitation, a portable electronic device, a light, a power tool, a battery, and combinations thereof. The electric generator device 200 may thereby serve as the power source for the load 222.

The embodiment described above and illustrated in FIGS. 36-40 can have various physical implementations to provide technical advantages therein. Example devices include, without limitation, portable electronic devices, lights, power tools, batteries, and combinations thereof. Conventional electric generators convert mechanical energy (from steam, gas, water, and wind turbines, and internal combustion engine) to electric energy based on the Faraday effect. For miniature devices, the need for turbines imposes weight, volume and cost challenges. The above-described embodiments uses the movement of permanent magnets based on the LD phenomena and TP rule to create a changing magnetic field to generate electricity in induction coils. The permanent magnets in this embodiment are dual-functional to provide both magnetic field and mechanical energy necessary to generate electricity.

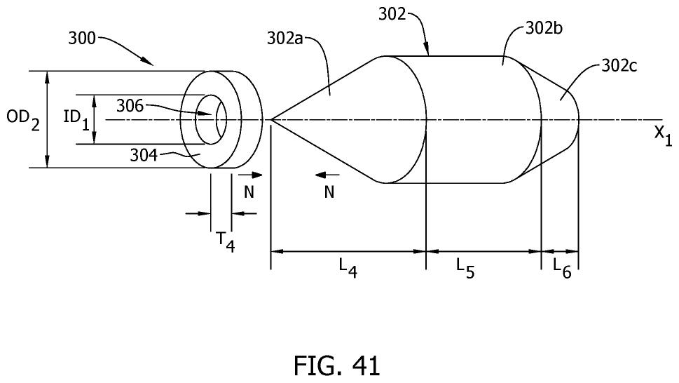

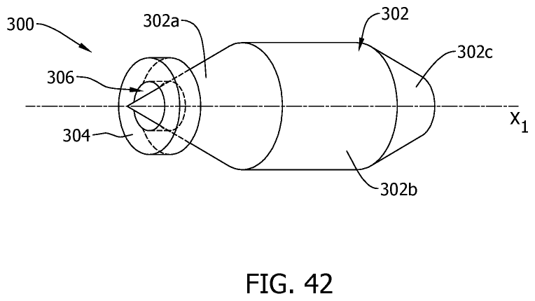

With reference to FIGS. 41 and 42, an example embodiment of a propulsion device 300 in accordance with the present disclosure is shown. The propulsion device 300 includes a tapered magnet 302 and a ring magnet 304. The tapered magnet 302 includes a tapered tip portion 302a, a cylindrical base portion 302b, and a truncated tapered portion 302c. The tapered tip portion 302a has a conical shape and the truncated tapered portion 302c has a frustoconical shape however, other tapered shapes may be used. For example, the tapered tip portion 302a may have a pyramidal shape and/or the truncated tapered portion 302c may have a frustopyramidal shape. The ring magnet 304 defines a center hole 306. The tapered magnet 302 and ring magnet 304 are paired with their like poles oriented of facing towards one another (e.g., N→←N as shown in FIG. 41).

In accordance with the present disclosure, the tapered magnet 302 and the ring magnet 304 are sized and shaped to implement the LD phenomena and TP rule, as described in detail herein, to transition a repulsive force between the like poles of the tapered magnet 302 and the ring magnet 304 to an attractive force as the center axes of the tapered magnet 302 and the ring magnet 304 are axially aligned and the magnets 302 and 304 are brought within a threshold distance to one another. As described in detail herein, the threshold distance corresponds to the point on the force F₂ v. gap curve of the tapered magnet 302 and the ring magnet 304 at which the repulsive force between the magnets 302 and 304 transitions to an attractive force due to the LD phenomena and the TP rule. In this regard, the threshold distance may vary based on the geometry and type of magnets used. Additionally, the threshold distance in this example embodiment may be described as a threshold depth, or length along the tapered tip portion 302a, to which the ring magnet 304 is moved relative to the tapered magnet 302. In some examples, the threshold depth may be about one third of a length L₄ of the tapered tip portion 302a. Moreover, the geometry of the magnets 302 and 304, and the type of magnets used, may vary based on design requirements to any geometry or type of magnet that enables the magnets to function as described herein. For example, the magnets 302 and 304 may be any type of magnet that facilitates an attracting force between the tapered magnet 302 and the ring magnet 304 when the magnets 302 and 304 are like-pole paired and brought within a threshold distance of each other. In some examples, the magnets 302 and 304 are suitably each Nd—Fe—B magnets.

Moreover, the geometry of the tapered magnet 302 and the ring magnet 304 is such that the tapered magnet 302 and ring magnet 304 are attracted to one another when the tapered tip portion 302a of the tapered magnet 302 is positioned within the center hole 306 of ring magnet 304 (as shown in FIG. 42), and the tapered magnet 302 and the ring magnet 304 are axially aligned along the center axis X₁. The center axis X₁ extends axially through the center of the tapered magnet 302. In some embodiments, the geometry of the tapered magnet 302 is such that: the tapered tip portion 302a extends a length L₄ in the range of about 6 mm to about 50 mm, such as from 15 mm to about 30 mm; the outer diameter OD₁ of the tapered magnet 302 at the base portion 302b is in the range of about 6 mm to about 100 mm, such as in the range of about 15 mm to about 30 mm and the base portion 302b extends a length L₅ in the range of about 5 mm to about 5 mm, such as in the range of about 20 to about 35 mm; and the truncated tapered portion 302c extends a length L₆ in the range of about 0 mm to about 50 mm. In some embodiments, the tapered magnet 302 does not include the truncated tapered portion 302c.

The ring magnet 304 has an inner diameter ID₁ defining center hole 306 that is large enough to allow hole 306 to receive about one third of the length L₄ of tapered tip portion 302a, for example, about 2 mm to about 33 mm of the length L₄ of the tapered tip portion 302a. As described above, the threshold distance or depth of the tapered tip portion 302a along which the ring magnet 304 must move in order to transition from a repulsive force to an attractive force between the like poles of the magnets 302 and 304 may be about one third of the length L₄ of the tapered tip portion 302a. In some embodiments, the ring magnet 304 may have the following example dimensions: an outer diameter OD₂ in the range of about 5 mm to about 50 mm, an inner diameter ID₁ in the range of about 3 mm to about 15 mm, and a thickness T₄ in the range of about 0.5 mm to about 20 mm. In one particular example, the tapered magnet 302 has a 1 inch (25.4 mm) outer diameter OD₁ and the base portion 302b extends 1 inch (25.4 mm) in length, and the ring magnet 304 has the dimensions of 0.75 inches (19.1 mm) OD₂×0.375 inches (9.53 mm) ID₁×0.25 inches (6.35 mm) thick (T₄).

The geometries of the tapered magnet 302 and ring magnet 304 are such that the tapered magnet 302 has a suitable permeance coefficient P_{c,302}, and the ring magnet 304 has a suitable permeance coefficient P_{c,304}, where P_{c,302} is greater than P_{c,304} to achieve a ratio P_{c,302}/P_{c,304} above 1 and, more suitably, above 2. For example, in some embodiments, the ratio P_{c,302}/P_{c,304} is suitably in the range of about 2 to about 300, in the range of about 10 to about 250, in the range of about 50 to about 225, or in the range of about 100 to about 200. The ratio P_{c,302}/P_{c,304} may also be represented as P_{c,302}:P_{c,304}. In this regard, an LD effect based on the P_{c} ratio of the tapered magnet 302 and ring magnet 304 is such that a TP can be observed on the force v. gap curves of this pairing, and the repulsive force between the magnets 302 and 304 transitions to an attractive force the tapered tip portion 302a of the tapered magnet 302 is inserted beyond a threshold depth into the ring magnet 304. For example, the transition of repulsive force to attractive force may occur at the point where the tapered tip portion 302a is inserted into the center hole 306 of the ring magnet 304 a threshold depth of about one third of the length L₄ of the tapered tip portion 302a. Accordingly, as the tapered tip portion 302a of the tapered magnet 302 is inserted into the center hole 306 of ring magnet 304, with the tapered magnet 302 and ring magnet 304 in axial alignment along axis X₁, the force between the like poles transitions from repulsion to attraction. When the ring magnet 304 is brought out of axial alignment with the tapered magnet 302 (e.g., by translating and/or rotating the tapered magnet 302 and the ring magnet 304 relative to one another), the like poles repel one another. Additionally or alternatively, the ring magnet 304 may be brought toward the end of the tapered tip portion 302a, opposite the base portion 302b, where the attractive force becomes a repulsive force between the like poles of the magnets 302 and 304. This repelling force can be used to propel or launch ring magnet 304, with potentially considerable force depending on the selected geometries of the magnet 302 and 304. This provides a forceful propulsion that can be used for certain mechanical actions.

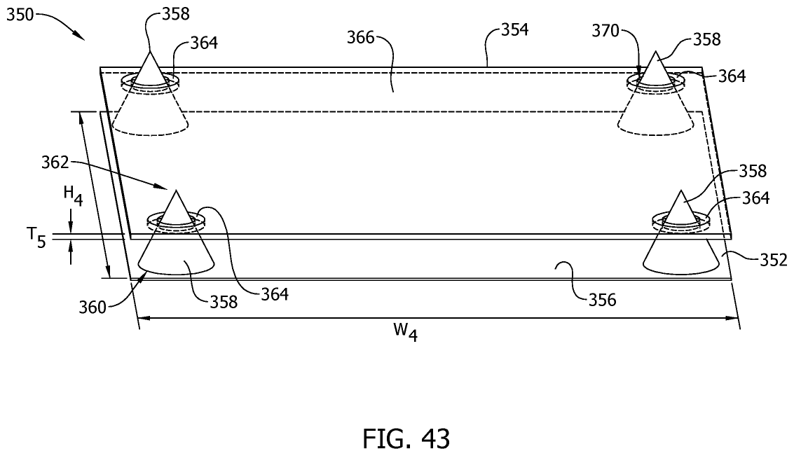

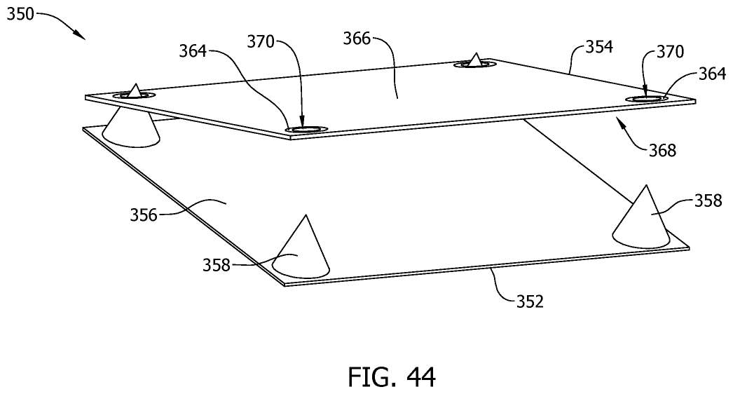

With reference to FIGS. 43 and 44, a magnetic assembly 350 illustrated in the form of a quick-release platform assembly utilizing the features described above for the propulsion device 300 is shown. The magnetic assembly 350 includes a first plate 352 and a second plate 354 releasably securable to the first plate 352. The first plate 352 and the second plate 354 are similarly sized, square-shaped boards in this example. In the example embodiment, each of the first and second plate 352 and 354 has a height H₄ and a width W₄, which can be, for example and without limitation, in the range of about 30 mm to about 200 mm, and a thickness T₅, which can be, for example and without limitation, in the range of about 0.5 mm to about 2.5 mm. However, the first and second plates 352 and 354 may have any size and shape depending on the desired application for magnetic assembly 350. The first plate 352 has a planar surface 356 that is oriented toward, or faces, a planar surface 368 of the second plate 354. The second plate 354 also has a planar surface 366 opposite the planar surface 368 that faces the planar surface 356 of the first plate 352. Each of the first and second plates is suitably made of a non-magnetic material, and the type of non-magnetic material may vary depending upon the desired application of the magnetic assembly 350.

The first plate 352 includes at least one tapered magnet 358 extending between a base 360 and a tip 362. The base 360 of each tapered magnet 358 is secured to the planar surface 356 of the first plate 352, and each tapered magnet 358 extends from the planar surface 356 to the tip 362. In the example embodiment, the first plate 352 includes four tapered magnets 358. Moreover, the base 360 of each tapered magnet 358 is secured to the planar surface 356 at or adjacent a respective corner of the first plate 352, and each of the tapered magnets 358 is equally spaced from the tapered magnets 358 secured at adjacent corners. Each of the tapered magnets 358 has the same size and shape in the illustrated embodiment. In some examples, the tapered magnets 358 have a conical shape, a pyramidal shape, a frustoconical shape, or a frustopyramidal shape. In some embodiments, the base 360 of each tapered magnet 358 has an outer diameter in the range of about 6 mm to about 20 mm, and each tapered magnet 358 extends a length between the base 360 and the tip 362 in the range of about 6 mm to about 20 mm.

The second plate 354 includes at least one ring magnet 364 that receives the tip 362 of the at least one tapered magnet 358 to removably secure the first plate 352 to the second plate 354. In the example embodiment, the second plate 354 includes four ring magnets 364 at respective corners of the second plate 354, and each of the four ring magnets 364 aligns with and receives the tip 362 of one of the tapered magnets 358. More specifically, each ring magnet 364 defines a central opening 370 that extends through the second plate 354 from the planar surface 366 through the planar surface 368. Each ring magnet 364 is suitably positioned such that the ring magnet 364 is configured to axially align with the corresponding tapered magnet 358 when the second plate 354 is releasably secured to the first plate 352. In accordance with the present disclosure, the like poles of each aligning tapered magnet 358 and ring magnet 364 are oriented toward each other. For example, where the N pole of each tapered magnet 358 is at the tip 362, the tip 362 is received into the N side of the ring magnet 364 which is on the side of the planar surface 368. Alternatively, wherein the S pole of each tapered magnet 358 is at the tip 362, the tip 362 is received into the S side of the ring magnet 364 which is on the side of the planar surface 368. Moreover, each ring magnet 364 has a suitable size to implement the LD phenomena and TD rule such that the like poles of each pair of one of the tapered magnets 358 and one of the ring magnets 364 attract each other when the tip 362 of the tapered magnet 358 is inserted beyond a threshold depth, for example, beyond about one third of the length of the tapered magnet 358, measured from the tip 362. In some embodiments, each ring magnet 364 has an outer diameter in the range of about 5 mm to about 20 mm, an inner diameter in the range of about 3 mm to about 15 mm, and a thickness in the range of about 0.5 mm to about 2.5 mm.

The geometry of the magnets 358 and 364, and the type of magnets used, may vary based on design requirements to any geometry or type of magnet that enables the magnets to function as described herein. For example, the magnets 358 and 364 may be any type of magnet that facilitates an attractive force between the tapered magnet 358 and the aligning ring magnet 364 when each pair of magnets 358 and 364 are like-pole paired and brought within a threshold distance of each other (i.e., when the tapered magnet 358 is inserted beyond a threshold depth, for example, about one third of the length of the tapered magnet 358 measured from the tip 362). In some embodiments, each of the magnets 358 and 364 is an Nd—Fe—B.

For each pair of aligning tapered magnet 358 and ring magnet 364, the geometries of the tapered magnet 358 and ring magnet 364 are such that the tapered magnet 358 has a suitable permeance coefficient P_{c,358}, and the ring magnet 364 has a suitable permeance coefficient P_{c,364}, where P_{c,358} is greater than P_{c,364} to achieve a ratio P_{c,358}/P_{c,364} above 1 and, more suitably, above 2. For example, in some embodiments, the ratio P_{c,358}/P_{c,364} is suitably in the range of about 2 to about 300, in the range of about 10 to about 250, in the range of about 50 to about 225, or in the range of about 100 to about 200. The ratio P_{c,358}/P_{c,364} may also be represented as P_{c,358}:P_{c,364}. In this regard, an LD effect based on the P_{c} ratio of the tapered magnet 358 and ring magnet 364 pairing is such that a TP can be observed on the force v. gap curves of this pairing, and the repulsive force between the magnets 358 and 364 transitions from a repulsive force to an attractive force as the tapered magnet 358 is inserted a threshold distance or length into the ring magnet 364, measured from the tip 362. For example, the transition of repulsive force to attractive force may occur at the point where the tip 362 is inserted into the opening 370 of the ring magnet 364 a threshold depth of about one third of the length of the tapered magnet 358, measured from the tip 362. Accordingly, as the tip 362 of each of the tapered magnets 358 is inserted into the opening 370 of the aligning ring magnet 364, with the tapered magnet 358 and the ring magnet 364 in axial alignment, the force between the like poles transitions from repulsion to attraction. Thereby, the second plate 354 is secured to the first plate 352 by magnetic attractive forces. When the ring magnet 364 is brought out of axial alignment with the aligning tapered magnet 358 (e.g., by translating and/or rotating the tapered magnet 358 and the ring magnet 364 relative to one another), the like poles repel one another. When the like poles of one or more pairs of an aligning tapered magnet 358 and ring magnet 364 repel one another, the second plate 354 may be released from the first plate 352. Additionally or alternatively, the ring magnet 364 may be brought toward the end of the tapered magnet 358, to the tip 362, where the attractive force transitions to a repulsive force between the like poles of the magnets 358 and 364. This repelling force between one or more pairs of the magnets 358 and 364 can be used to release the second plate 354 from the first plate 352.

The magnetic assembly 350 described above and shown in FIGS. 43 and 44 may have various implementation to achieve advantages over existing magnetic assemblies. For example, the magnetic assembly 350 may be implemented as a circuit board to be mounted firmly but removed for quick replacement or testing. This embodiment achieves both objectives using a plurality of tapered magnets 358, such as cones or pyramids, each being magnetized from the base 360 to the tip 362 and suitably arranged to provide firm support for the second plate 354 when secured to the first plate 352. When removal of the second plate 354 from the first plate 352 is desired, a user or actuator (not shown) may simply apply pressure to the second plate 354 to move one or more of the ring magnets 364 relative to the aligning tapered magnet 358 from the base 360 of the tapered magnet 358 towards the tip 362, or out of axial alignment with the tapered magnet 358, or both, which will cause the second plate 354 to pop off safely. The tapered magnets 358 are suitably mounted and positioned on the surface 356 of the first plate 352, and the tapered magnets 358 are aligned to match the openings 370 defined by the ring magnets 364 of the second (removable) plate 354. The ring magnets 364 are of suitable size and shape to facilitate an attractive force between like poles of each pair of a tapered magnet 358 and a ring magnet 364, based on the LD phenomena and TP rule, once the tip 362 of the tapered magnet 358 is inserted into the opening beyond a threshold depth to thereby apply the desired holding force between the first plate 352 and the second plate 354. The more force that is desired to hold the first and second plates 352 and 354 together, the farther the tip 362 of the tapered magnet 358 will need to be inserted into the ring magnet 364. The shape, size, and type of magnet used for the tapered magnets 358 and the ring magnets 364 are determined based on the desired force to hold the first and second plates 352 and 354 together and the force required to release the second plate 354 from the first plate 352.

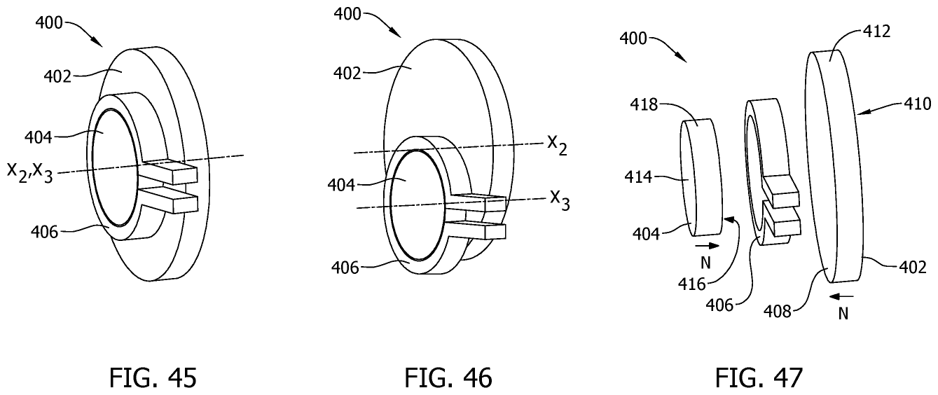

With reference to FIGS. 45-47, another example embodiment of a propulsion device 400 in accordance with the present disclosure is shown. The propulsion device 400 includes a pair of unequally sized magnets 402 and 404. The magnets 402 and 404 are sized and shaped to use the LD phenomena and TP rule, as described in detail herein, to alternate the attraction and repulsion between the like poles of magnets 402 and 404. In this example, magnet 404 is movable relative to the magnet 402, and the magnet 402 is stationary in this example. In accordance with the present disclosure, the like poles of the magnets 402 and 404 are oriented toward each other. In this example, the N pole of the magnet 402 is oriented toward the N pole of the magnet 404.

The magnets 402 and 404 are suitably sized and shaped to use the LD phenomena and TP rule, as described in detail herein, to alternate the attraction and repulsion between the movable magnet 404 and the stationary magnet 402. In this example, each of the magnets 402 and 404 is disc shaped, although the magnets 402 and 404 may have any suitable shape to enable the propulsion device 400 to function as described herein. The geometry (e.g., outer diameter and length or thickness) of the magnets 402 and 404, and the type of magnets used, are such that, when the magnets 402 and 404 are axially aligned and the magnets 402 and 404 are brought to within a threshold distance of one another, the like poles of the magnets 402 and 404 attract each other. The threshold distance corresponds to the point on the force F₂ v. gap curve of the moveable magnet 404 and the stationary magnet 402 pairing at which the repulsive force between the magnets 402 and 404 transitions to an attractive force due to the LD phenomena and the TP rule, as described in detail herein. In this regard, the threshold distance may vary based on the geometry and type of magnets used. In some examples, the threshold distance may be less than about 2 mm, such as about 0.5 mm. Moreover, the geometry of the magnets 402 and 404, and the type of magnets used, may vary based on design requirements to any geometry or type of magnet that enables the magnets to function as described herein. For example, the magnets 402 and 404 may be any type of magnet that facilitates an attractive force between the moveable magnet 404 and the stationary magnet 402 when the magnets 402 and 404 are like-pole paired and brought within a threshold distance of each other. In some examples, the magnets 402 and 404 are suitably each Nd—Fe—B magnets.

In the example embodiment, each of the magnets 402 and 404 is a cylindrically shaped magnet (i.e., the magnets 402 and 404 are disc magnets). As shown in FIG. 47, the magnets 402 and 404 each have, respectively, a first or front surface 408 and 414, a second or back surface 410 and 416, and a circumferential surface 412 and 418 joining the respective front surface 408 and 414 and back surface 410 and 416. The front surface 408 of the stationary magnet 402 is on the N side of the magnet 402. The front surface 414 of the moveable magnet 404 is on the S side of the magnet 404. As such, the front surface 408 of the stationary magnet 402 is not oriented toward the front surface 414 of the moveable magnet 404. In the example embodiment, the front surface 408 (i.e., the N side) of the stationary magnet 402 is oriented toward the back surface 416 (i.e., the N side) of the moveable magnet 404. The back surface 410 of the magnet 402 is on the S side of the magnet 402. In some embodiments, the back surface 410 (i.e., the S side) of the stationary magnet 402 is oriented toward the front surface 414 (i.e., the S side) of the moveable magnet 404. The front surface 408 and 414 of the respective magnet 402 and 404 is planar and generally parallel to the respective back surface 410 and 416, which is also planar. Each magnet 402 and 404 also includes a center or central axis X₂ and X₃, respectively (shown in FIGS. 45 and 46), extending through a center of the respective magnet 402 and 404 and substantially perpendicular to the respective front surface 408 and 414 and the back surface 410 and 416. Each magnet 402 and 404 includes an outer diameter, measured as a straight line between opposing sides of the magnet 402 and 404 and perpendicular to the center axis X₂ and X₃, respectively, and a length or thickness measured between the front surface 408 and 414 and the back surface 410 and 416.

In some embodiments, the moveable magnet 404 may have an outer diameter in the range of about 3 millimeters (mm) to about 30 mm and a thickness in the range of about 2 mm to about 30 mm, and the stationary magnet 402 may have an outer diameter in the range of about 10 mm to about 90 mm and a thickness in the range of about 2 mm to about 20 mm. The outer diameter of the stationary magnet 402 is suitably greater than the outer diameter of the moveable magnet 404. In some embodiments, the outer diameter of the stationary magnet 402 is suitably at least three times larger than the outer diameter of the moveable magnet.

The geometries of the stationary magnet 402 and the moveable magnet 404 are such that the magnet 402 has a suitable permeance coefficient P_{c,402}, and the magnet 404 has a suitable permeance coefficient P_{c,404}, where P_{c,404} is greater than P_{c,402} to achieve a ratio P_{c,404}/P_{c,402} above 1 and, more suitably, above 2. For example, in some embodiments, the ratio P_{c,404}/P_{c,402} is suitably in the range of about 2 to about 300, in the range of about 10 to about 250, in the range of about 50 to about 225, or in the range of about 100 to about 200. The ratio P_{c,404}/P_{c,402} may also be represented as P_{c,404}:P_{c,402}. Accordingly, an attractive force between the like poles of the magnets 402 and 404 can be created when the magnet 404 is axially aligned with the magnet 402, and the magnets 402 and 404 are positioned within a threshold distance of one another. That is, magnet 404 is unequally sized with magnet 402 where an LD effect based on the ratio P_{c,404}/P_{c,402} is such that a TP can be observed on the force v. gap curves of this pairing, and the force between the like poles of these magnets transitions from a repulsive force to an attractive force as the magnets 402 and 404 are moved, in axial alignment, to within a threshold distance of one another (e.g., less than 0.5 mm). When the magnet 404 is brought out of axial alignment with the magnet 402, the like poles repel one another, and the magnet 404 may be propelled away from the stationary magnet 402.

To control the repulsive and attractive forces between the magnets 402 and 404 based on the LD phenomena and the TP rule, the propulsion device 400 also includes an actuator 406, illustrated as a machine arm in this embodiment, sized and shaped to receive the magnet 404 therein, and configured to move magnet 404 relative to magnet 402. In some embodiments, the actuator 406 can be manually controlled by an operator or automatically controlled by a suitable controller. As shown in FIG. 45, the actuator 406 is configured to position the moveable magnet 404 in a first position, in which the magnet 404 is in axial alignment with the stationary magnet 402, such that the center axis X₂ of the stationary magnet 402 and the center axis X₃ of the moveable magnet 404 are aligned. Additionally, in the first position, the actuator 406 holds the moveable magnet 404 near or adjacent the stationary magnet 402 such that a gap therebetween is within a threshold distance as described above (e.g., less than 0.5 mm). The actuator 406 can be configured to move magnet 404 to the first position in response to a first trigger or condition. When the magnets 402 and 404 are in axial alignment, with axes X₂ and X₃ aligned, and brought within the threshold distance to one another, the repulsive force between the like poles of the magnets 402 and 404 transitions to an attractive force. As shown in FIG. 46, in response to a second trigger or condition, the actuator 406 can move the magnet 404 out of axial alignment with the magnet 402, to a second position. In the second position, the distance between the magnets 402 and 404 may be the same or similar as the distance therebetween in the first position (FIG. 45). With the magnet 404 out of axial alignment with the magnet 402 in the second position, such that the axes X₂ and X₃ are offset, the like poles of the magnets 402 and 404 repel one another and magnet 404 is propelled away from magnet 402 as a result. The size and shape of the magnets 402 and 404 may be selected to generate a sufficient force to propel the magnet 404 at a desired acceleration in the second position.

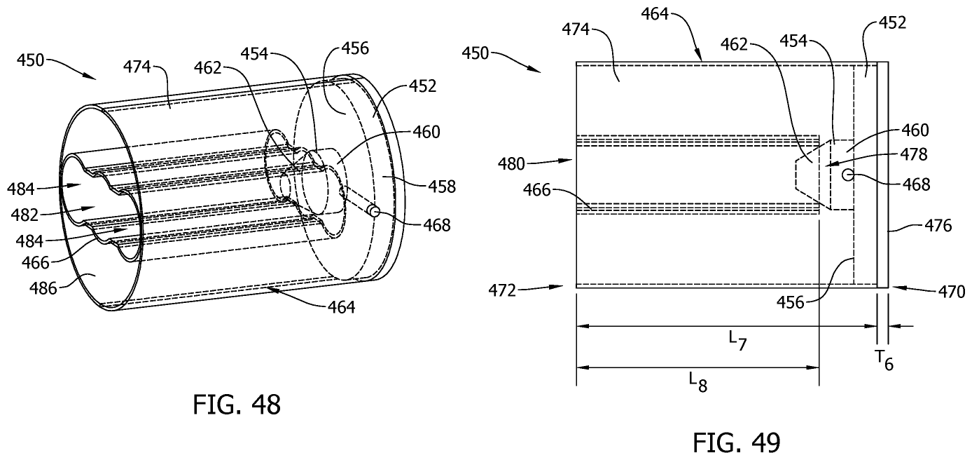

With reference to FIGS. 48-55, another example propulsion device 450 is shown. The propulsion device includes a magnet 452 and a moveable magnetic body 454 including at least one permanent magnet 460. The magnet 452 and moveable magnetic body 454 are unequally sized and shaped to use the LD phenomena and TP rule, as described in detail herein, to alternate the attraction and repulsion between the like poles of magnet 452 and the moveable magnetic body 454. In accordance with the present disclosure, the like poles of the magnet 452 and the moveable magnetic body 454 are oriented toward each other. In this example, the N pole of the magnet 452 is oriented toward the N pole of the moveable magnetic body 454.

The magnet 452 and moveable magnetic body 454 are suitably sized and shaped to use the LD phenomena and TP rule, as described in detail herein, to alternate the attraction and repulsion between the moveable magnetic body 454 and the magnet 452. The geometry (e.g., outer diameter and length or thickness) of the magnet 452 and the moveable magnetic body 454, and the type of magnets used therefor, are such that, when the magnet 452 and moveable magnetic body 454 are axially aligned and brought to within a threshold distance of one another, the like poles of the magnet 452 and the moveable magnetic body 454 attract each other. The threshold distance corresponds to the point on the force F₂ v. gap curve of the moveable magnetic body 454 and the magnet 452 pairing at which the repulsive force between the magnet 452 and the moveable magnetic body 454 transitions to an attractive force due to the LD phenomena and the TP rule, as described in detail herein. In this regard, the threshold distance may vary based on the geometry and type of magnets used. In some examples, the threshold distance may be less than about 2 mm, such as about 0.5 mm. Moreover, the geometry of the magnet 452 and the moveable magnetic body 454, and the type of magnets used, may vary based on design requirements to any geometry or type of magnet that enables the propulsion device 450 to function as described herein. For example, the magnets 452 and 460 may be any type of magnet that facilitates an attracting force between the moveable magnetic body 454 and the magnet 452 when the magnet 452 and the moveable magnetic body 454 are like-pole paired and brought within a threshold distance of each other. In some examples, the magnets 452 and 460 are suitably each Nd—Fe—B magnets.

In the example embodiment, the magnet 452 is a cylindrically shaped magnet (i.e., a disc magnet). The magnet 452 has a first or front surface 456, a second or back surface (not labeled), and a circumferential surface 458 joining the front surface 456 and the back surface. The front surface 456 of the magnet 452 is on the N side of the magnet 452 in this example. The magnet 460 is also a cylindrically shaped magnet (i.e., a disc magnet) in the example embodiment, and is suitably constructed of permanent magnetic materials, including, for example and without limitation, Nd—Fe—B, SmCo30, and combinations thereof. In addition to the permanent magnet 460, the moveable magnetic body 454 includes a tapered portion or body 462 fixedly coupled to the magnet 460. The tapered portion 462 may be utilized to further increase a permeance coefficient of the moveable magnetic body 454 and to facilitate improving a mechanical strength of the moveable magnetic body 454 during operation of the propulsion device 450. The tapered portion 462 can be constructed of permanent magnetic materials, such as those listed above, or non-permanent magnetic materials. In some embodiments, for example, the tapered portion 462 is constructed of soft magnetic material or magnetic material with a high saturation of magnetization, including, for example and without limitation, cold rolled steel.

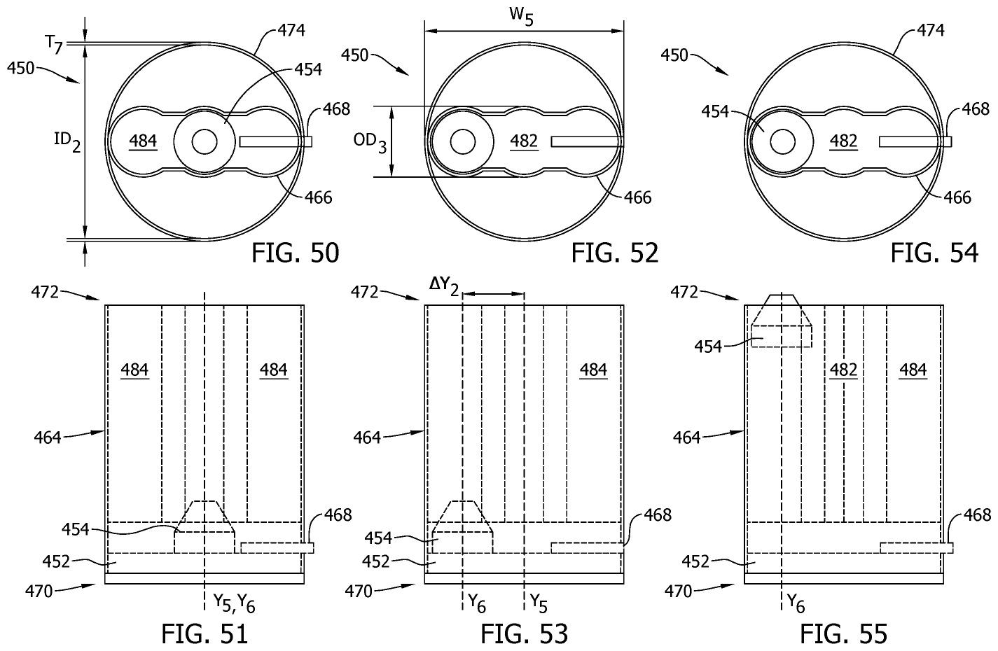

The moveable magnetic body 454 is oriented such that the magnet 460 faces the front surface 456 of the magnet 452, and the tapered portion 462 extends from the magnet 460 opposite the magnet 452. As such, the end of the magnet 460 opposite the tapered portion 462 is the N side of the moveable magnetic body 454, and the end of the tapered portion 462 opposite the magnet 460 is the S side of the body 454. In the example embodiment, the tapered portion 462 of the moveable magnetic body 454 has a frustoconical shape, although in other embodiments the tapered portion 462 may have, for example and without limitation, a conical shape, a pyramidal shape, or a frustopyramidal shape. Each of the magnet 452 and the moveable magnetic body 454 includes a center axis Y₅ and Y₆, respectively (shown in FIGS. 50-55), extending through a center of the respective magnet 452 and moveable magnetic body 454. Each of the magnet 452 and the moveable magnetic body 454 includes an outer diameter, measured as a straight line between opposing sides of the magnet 452 and moveable magnetic body 454 and perpendicular to the center axis Y₅ and Y₆, respectively. The magnet 452 has a length or thickness defined as the extent of the circumferential surface 458 between the front surface 456 and the back surface. The moveable magnetic body 454 has a total length or thickness defined as the sum of the axial length of the magnet 460 and the tapered portion 462 along the axis Y₆.

The moveable magnetic body 454 may have a main outer diameter in the range of about 3 millimeters (mm) to about 30 mm. The main outer diameter of the moveable magnetic body 454 corresponds to the outer diameter of the magnet 460. The outer diameter of the moveable magnetic body 454 at the end of the tapered portion 462 opposite the magnet 460 is in the range of about 2 to about 20 mm. The magnet 460 of the moveable magnetic body 454 has a thickness in the range of about 2 mm to about 30 mm. The tapered portion 462 of the moveable magnetic body 454 has a thickness in the range of about 2 mm to about 200 mm. The magnet 452 may suitably have an outer diameter that is at least three times larger than the main outer diameter of the moveable magnetic body 454. For example, the magnet 452 may have an outer diameter in the range of about 10 mm to about 90 mm. The magnet 452 may have a thickness in the range of about 1 mm to about 20 mm.

The geometries of the magnet 452 and the moveable magnetic body 454 are such that the magnet 452 has a suitable permeance coefficient P_{c,452}, and the body 454 has a suitable permeance coefficient P_{c,454}, where P_{c,454} is greater than P_{c,452} to achieve a ratio P_{c,454}/P_{c,452} above 1 and, more suitably, above 2. For example, in some embodiments, the ratio P_{c,454}/P_{c,452} is suitably in the range of about 2 to about 300, in the range of about 10 to about 250, in the range of about 50 to about 225, or in the range of about 100 to about 200, In one example, the ratio P_{c,454}/P_{c,452} is above 5. In some examples, the permeance coefficient of the magnet 460 of the moveable magnetic body 454 is sufficient to achieve a ratio of above 2, and the additional tapered portion 462 further increases the P_{c,454} and, accordingly, the ratio P_{c,454}/P_{c,452} (e.g., to above 5). The ratio P_{c,454}/P_{c,452} may also be represented as P_{c,454}:P_{c,452}. Accordingly, an attracting force between the like poles of the magnet 452 and the moveable magnetic body 454 can be created when the center axis Y₆ of moveable magnetic body 454 is axially aligned with the center axis Y₅ of the magnet 452, and the magnet 452 and moveable magnetic body 454 are positioned within a threshold distance of one another. That is, moveable magnetic body 454 is unequally sized with magnet 452 where an LD effect based on the ratio P_{c,454}/P_{c,452} is such that a TP can be observed on the force v. gap curves of this pairing, and the force between the like poles of the magnet and magnetic body transitions from a repulsive force to an attractive force as the magnet 452 and moveable magnetic body 454 are moved, in axial alignment, to within a threshold distance of one another (e.g., less than 0.5 mm). When the moveable magnetic body 454 is brought out of axial alignment with the magnet 452, the like poles repel one another, and the moveable magnetic body 454 may be propelled away from the magnet 452.

The propulsion device 450 can also include a housing 464, a guide 466 positioned within the housing 464, and a trigger or pin 468. Each of the housing 464, the guide 466, and the pin 468 are suitably made of non-magnetic material(s). The housing 464 defines a cavity (not labeled), and is sized and shaped to enclose the magnets 452 and 454 therein. The housing 464 is cylindrically shaped in this example, although the housing 464 may have any other suitable shape that enables the propulsion device 450 to function as described herein. The housing 464 extends from a first end 470 to a second end 472. The magnet 452 is positioned at the first end 470 of the housing 464, and the housing 464 and the magnet 452 are axially aligned along the center axis Y₅. In the example embodiment, the housing 464 includes a tubular body 474 that is open at the first end 470 and the second end 472. The tubular body 474 defines an interior and surrounds the magnet 452, the moveable magnetic body 454, and the guide 466. A cover 476 is attached to the tubular body 474 at the first end 470 and the cover 476 covers the back surface of the magnet 452. The tubular body 474 is uncovered at the second end 472, which provides an egress for the moveable magnetic body 454 during operation of the propulsion device 450.

In the example embodiment, the cylindrical body 474 of the housing 464 has a circular cross-section (shown in FIGS. 50-55). The body 474 extends a length L₇. The total axial length of the housing 464 is the sum of the length Ly and the thickness T₆ of the cover 476. The thickness T₆ may be, for example, in the range of about 0.5 mm to about 2 mm. The total axial length of the housing 464 may be, for example, in the range of about 30 mm to about 200 mm. The covers 476 is a circular disc, and may suitably have substantially the same outer diameter as the body 474. The body 474 has an inner diameter ID₂ that is substantially the same as the outer diameter of the magnet 452. The outer diameter of the body 474 is the sum of the inner diameter ID₂ and the thickness T₇ of the body 474. The thickness Ty of the body 474 may be, for example, in the range of about 0.5 mm to about 5 mm.

The guide 466 extends a length L₈ from a first end 478 proximate the front surface 456 of the magnet 452 to a second end 480. The length La may be, for example, in the range of about 25 mm to about 100 mm. The first end 478 may be spaced from the front surface 456 of the magnet 452, which provides a space for the pin 468 to be biased and operatively coupled to the moveable magnetic body 454. The guide 466 is tubular and open at both ends 478 and 480. The guide has three channels which are sized and shaped to enable the moveable magnetic body 454 to move therethrough during operation of the propulsion device 450. In particular, the guide 466 has a central channel 482 that extends coaxially with the center axis Y₅. The guide 466 has two side channels 484 that extend on opposite sides of the central channel 482. Suitably, the side channels 484 each axially align with the center axis Y₆ of the moveable magnetic body 454 when the moveable magnetic body 454 is moved out of axial alignment with the magnet 452, described in more detail below. The inner diameter of each channel 482 and 484 depends on the main outer diameter of the moveable magnetic body 454 to provide clearance for the moveable magnetic body 454. The outer diameter OD₃ of each channel 482 and 484 may be, for example, in the range of about 4 mm to about 30 mm. The guide 466 has a width W₅ within the housing 464 that is substantially the same as the inner diameter ID₂. For example, the W₅ may be in the range of about 10 mm to about 90 mm.

Each of the guide 466 and the magnet 452 may be rotatable relative to the housing 464 about the center axis Y₅. For example, bearing balls (not shown) may be inserted between the circumferential surface 458 of the magnet 452 and an inner surface 486 of the body 474 to enable the magnet 452 to rotate within the housing 464 about the center axis Y₅. Additionally, bearing balls (not shown) may be inserted between opposing outer edges of the guide 466 (which define the width W₅ of the guide 466) and the inner surface 486 of the body 474 to enable the guide 466 to rotate within the housing 464 about the center axis Y₅. The pin 468 may also be moveable depending on the orientation of the guide 466 so that biasing the pin 468 moves the moveable magnetic body 454 into axial alignment with one of the side channels 484 of the guide 466. Rotating the magnet 452 and/or the guide 466 may facilitate reducing friction heat and demagnetization at a single location on the front surface 456 of the magnet 452 over an operational lifetime of the propulsion device 450. In some examples, the guide 466 and the magnet 452 may be connected to enable the guide 466 and the magnet 452 to rotate in unison. For example, the first end 478 of the guide 466 may extend to and be connected to the front surface 456 of the magnet 452.

The pin 468 extends through a hole (not labeled) on a side of the body 474 of the housing 464, and the pin 468 is configured to move the moveable magnetic body 454 out of axial alignment with the magnet 452. The pin 468 is cylindrically shaped and extends through the housing 464, for example, a length within the range of about 5 mm and 40 mm. The pin 468 may have an outer diameter, for example, in the range of about 1 mm to about 5 mm. Suitably, the pin 468 extends through a space between the magnet 452 and the first end 478 of the guide 466. Alternatively, in examples where the guide 466 is connected to the magnet 452, the pin 468 also extends through the guide 466. The pin 468 is configured to be biased and operatively coupled to the circumferential surface of the magnet 460 of the moveable magnetic body 454. The pin 468 may be biased by a user or by an external actuator (not shown) to cause the moveable magnetic body 454 to move out of axial alignment with the magnet 452. In this regard, the pin 468 may be utilized to initiate operation of the propulsion device 450.

With reference to FIGS. 50-55, movement of the moveable magnetic body 454 during operation of the propulsion device 450 is shown. In the initial position (FIGS. 50 and 51), the moveable magnetic body 454 is positioned against the magnet 452, and the center of the moveable magnetic body 454 is axially aligned with the center of the magnet 452. As such, the center axis Ye of the moveable magnetic body 454 is aligned with the center axis Y₅ of the magnet 452. Due to the LD phenomena as described above, the moveable magnetic body 454 is held in position against the magnet 452 by an attractive force, even though the N pole of the moveable magnetic body 454 faces the N pole of the magnet 452. The pin 468 is biased to cause the moveable magnetic body 454 to move toward an edge of the magnet 452, such that the center axis Y₆ of the moveable magnetic body 454 is moved out of axial alignment with the center axis Y₅ of the magnet 452. Suitably, the moveable magnetic body 454 is thereby moved outside of the localized area of the N side of the stationary magnet 452 at which the LD phenomena occurs.

As shown in FIGS. 52 and 53, the moveable magnetic body 454 is moved by the pin 468 to a position axially offset with the magnet 452, such that the center axis Y₆ of the moveable magnetic body 454 and the center axis Y₅ of the magnet 452 are substantially parallel but spaced apart by a distance ΔY₂. In this configuration, movement of the moveable magnetic body 454 away from the center of the magnet 452 positions the moveable magnetic body 454 in axial alignment with one of the side channels 484 of the guide 466. As shown in FIGS. 54-55, the moveable magnetic body 454 is repelled by the magnet 452 once the moveable magnetic body 454 is moved out of axial alignment with the magnet 452. The moveable magnetic body 454 is accelerated toward the second end 472 of the housing 464 through one of the side channels 484 coaxially aligned with the center axis Y₆ of the moveable magnetic body 454. Thereby, a propulsion action is generated by the propulsion device 450. The size and shape of the magnet 452 and the moveable magnetic body 454 may be selected to generate a sufficient force to propel the moveable magnetic body 454 at a desired acceleration through the side channel 484. At this stage, the moveable magnetic body 454 may be returned to the initial position (shown in FIGS. 50 and 51) by an external actuator (not shown) through the central channel 482.

The example propulsion devices 300, 350, 400, and 450 described above and illustrated in FIGS. 41-55 can have various physical implementations to provide technical advantages therein. The embodiments can be used, for example, in certain mechanical impacting actions. This technology facilitates storing energy for quick release. Similar to a mechanical spring, this magnetic coupling stores the energy required to overcome the repelling force and hold that position until triggered with a minimal force to push a movable smaller magnet (e.g., magnet 304 in FIGS. 41 and 42, magnet 404 in FIGS. 45-47, or magnet 454 in FIGS. 48-55) out of axial alignment with a different sized stationary magnet of lower P_{c} (e.g., magnet 302 in FIGS. 41 and 42, magnet 402 in FIGS. 45-47, or magnet 452 in FIGS. 48-55) after an attraction has been established due to the LD phenomenon and the TP rule. The repelling force can launch or propel the movable smaller magnet with considerable force. Such an effect can be implemented into applications such as mechanisms for opening and/or holding open refrigerator doors or other types of doors, tight-fitting adaptor connections and disconnections, game shooting, and other toys. The moving magnet in these embodiments can additionally or alternatively be used to generate electricity, for example, by passing the magnet through an electrically conductive coil (e.g., a copper coil or an aluminum coil). The electricity generated is proportional to the square of the velocity of the movable magnet. The energy to overcome the repelling force is equal to the stored energy but the difference is the speed it travels when it is released.

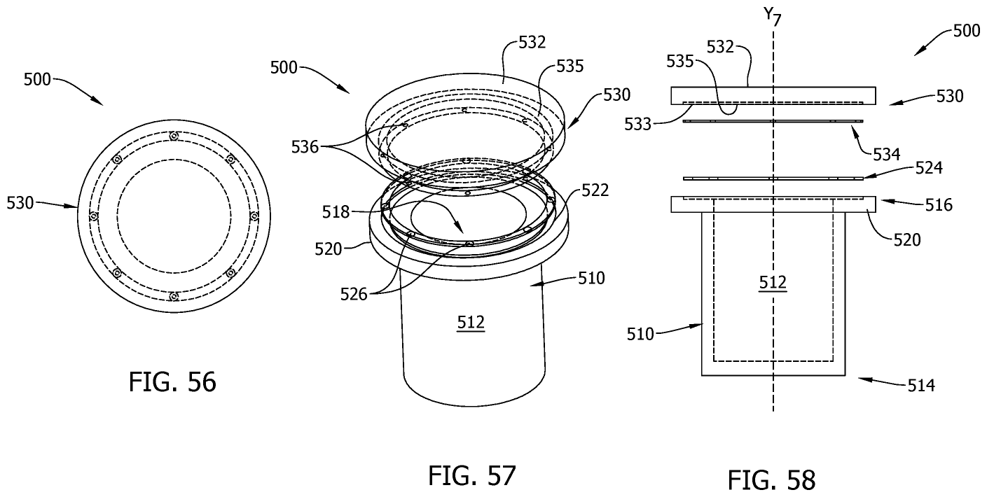

With reference to FIGS. 56-58, an example embodiment of a container assembly 500 is shown. The example container assembly 500 is illustrated in the form of a lab desiccator 500 including a vessel 510 and a cap 530, although the container 500 may be embodied in containers other than a lab desiccator. When assembled, the vessel 510 and the cap 530 share a common central axis Y₇. The vessel 510 and the cap 530 are suitably made from a non-magnetic material. The vessel 510 has an outer body 512 extending from a first end 514 to a second, open end 516. The outer body 512 extends a length from the first end 514 to the second end 516 in the range of about 50 mm to about 400 mm. The outer body 512 has an outer diameter in the range of about 70 mm to about 280 mm. The outer body 512 defines a hollow interior 518 accessible from the second end 516. The inner diameter of the outer body 512 defining the interior 518 is in the range of about 60 mm to about 270 mm. An annular flange 520, also referred to as a lip, extends radially outward from the outer body 512 at the second end 516. The outer diameter of the lip 520 is in the range of about 90 mm to about 310 mm, and the lip 520 has an inner diameter substantially the same as the inner diameter of the outer body 512. The lip 520 also has a thickness or length in the range of about 4 mm to about 20 mm. An annular recess 522 is defined along a top edge of the lip 520 and receives a first magnet ring 524. The first magnet ring 524 includes a plurality of magnets 526 (e.g., disc magnets) spaced circumferentially about the first magnet ring 524 and coupled thereto. In the illustrated embodiment, the magnets 526 are equally or substantially equally spaced about the first magnet ring 524, although the magnets 526 may be spaced other than equally or substantially equally about the first magnet ring 524 in other embodiments.

The cap 530 includes a base 532 and a second magnet ring 534. The base 532 of the cap 530 has a surface 533 that faces the top edge of the lip 520 of the vessel 510 when the cap 530 is secured to the vessel 510 to form an enclosure. An annular recess 535 is formed in the surface 533 of the base 532, and the annular recess 535 is sized and shaped to receive the second magnet ring 534. The cap 530 is disc shaped and has an outer diameter in the range of about 85 mm to about 300 mm. The thickness of the cap 530 is in the range of about 4 mm to about 20 mm. The second magnet ring 534 includes a plurality of magnets 536 (e.g., disc magnets) spaced circumferentially about the second magnet ring 534 and coupled thereto. The magnets 526 are spaced such that each magnet 536 is positioned to be axially aligned with and corresponds to a respective one of the magnets 526. The first and second magnet rings 524 and 534 are both made from a non-magnetic material and are configured to sealingly engage one another when the cap 530 is releasably secured to the vessel 510, described further below. The outer diameter of the first and second magnet rings 524 and 534 is substantially the same and is in the range of about 80 mm to about 300 mm. The first magnet ring 524 has a thickness in the range of about 1.5 mm to about 5 mm, and the second magnet ring 534 has a thickness in the range of about 2.5 mm to about 10 mm. In some examples, the first magnet ring 524 includes the magnets 526 circumferentially spaced uniformly about the ring 524, and the second magnet ring 534 includes the magnets 536 circumferentially spaced uniformly about the ring 524. In some examples, the first magnet ring 524 includes six or more magnets 526 and the second magnet ring 534 includes six or more magnets 536. For example, the first magnet ring 524 includes eight magnets 526 and the second magnet ring 534 includes eight magnets 536.

The like poles of the magnets 526 and magnets 536 face each other (i.e., N→←N or S→←S) when the cap 530 is positioned on top of the vessel 510. In accordance with the present disclosure, each of the magnets 536 is unequally sized with the respective one of the magnets 526 where an LD effect based on the P_{c} ratio of these magnets is such that a TP can be observed on the force v. gap curves of these pairings. In some examples, the magnets 526 and 536 are suitably each Nd—Fe—B magnets. For each pair of a magnet 526 and a magnet 536, the magnet 536 has a permeance coefficient P_{c,536} that is greater than a permeance coefficient P_{c,526} of the magnet 526, to achieve a ratio P_{c,536}/P_{c,526} above 1 and, more suitably, above 2. For example, in some embodiments, the ratio P_{c,536}/P_{c,526} is suitably in the range of about 2 to about 300, in the range of about 10 to about 250, in the range of about 50 to about 225, or in the range of about 100 to about 200. The ratio P_{c,536}/P_{c,526} may also be represented as P_{c,536}:P_{c,526}. In the example embodiment, the magnets 526 have a larger area with an outer diameter in the range of about 3 mm to about 20 mm and a length or thickness in the range of about 1 mm to about 5 mm. The magnets 536 have an outer diameter in the range of about 2 mm to about 15 mm and a length or thickness in the range of about 2 mm to about 10 mm. Accordingly, as the magnets 536 are moved in axial alignment with the magnets 526 and the gap between the magnets 536 and the magnets 526 is reduced to within a threshold distance (e.g., less than 0.5 mm) as defined above, the force between the like poles transitions from repulsion to attraction. As a result, the cap 530 is attracted towards the vessel 510 and the cap 530 is releasably secured to the vessel 510. The magnet ring 524 of the vessel 510 can thereby form a seal with the magnet ring 536 of the cap 530. When the magnets 536 are brought out of axial alignment with the magnets 526 (e.g., by rotating cap 530), the like poles of the magnets 526 and the magnets 536 repel each other and the seal between vessel 510 and cap 530 is broken.

The embodiments described above and illustrated in FIGS. 56-58 can have various physical implementations to provide technical advantages therein. In some embodiments, for example, the container 500 is implemented as a lab desiccator. At least some known lab desiccator seal switches use three-way valves to open and close the vacuum seal. It usually takes a few minutes to break and resume the vacuum to open and close the desiccators. The embodiment described herein uses magnetic repulsion and attraction to open and close the desiccator instead. In such embodiments, the desiccator may be used (i.e., opened and closed) in an inert gas environment (e.g., a glove box). As described above, the desiccator is sealed using attractive forces between like poles (i.e., N→←N or S→←S) of unequally sized magnet pairs in accordance with the present disclosure. When the cap is rotated relative to the vessel, even by a relatively small angle, the attractive forces between the magnets in the cap and the magnets in the vessel are transformed to repulsion and the cap is popped open.

As discussed in detail above, the embodiments disclosed with reference to FIGS. 25-58 each implement the LD phenomenon and the TP rule in accordance with the present disclosure. While not wishing to be limited by the magnetic material used, it is contemplated that the functions provided by these embodiments (e.g., locking, switching, vibration, and propulsion) may be realized by using either temporary or permanent LD. In this regard, the temporary LD results from the magnets with a linear B-H curve in the 2^{nd} quadrant and partially linear in the 3^{rd} quadrant, for example, N48SH and SmCo30 magnets; and the permanent LD results from the magnets with a non-linear B-H curve in the 2^{nd} quadrant, for example, N55 magnets. See FIG. 23 for a permanent LD illustration and FIG. 24 for a temporary LD illustration. Magnets that experience either permanent LD or temporary LD may be used in the above-described embodiments. In other embodiments, as will be discussed in more detail below, technical advantages in magnetic assemblies may be realized using magnets that experience permanent LD, and N55 magnets may be particularly suited for use in these embodiments.

Since 1982, Nd—Fe—B magnets' applications have spread rapidly over many sectors of industry. Nd—Fe—B magnets offer lighter weight, stronger mechanical strength, and lower cost than other rare earth magnets, because of their high remanence and high energy product. It is well known that magnets only have functions after magnetization. If Nd—Fe—B magnets are pre-magnetized before assembly of permanent magnet devices, the attracting or repelling force between the adjacent magnets exerts mechanical stresses on the magnets. This can make assembly of magnets more difficult, and may cause damage (e.g., chipping) of the magnets. Therefore, in some cases, unmagnetized Nd—Fe—B magnets are preferred for assembly of permanent magnet devices if the individual magnet parts can be magnetized conveniently after assembly. There is a design trend to use in-situ magnetic patterning devices, which magnetize several magnets at once, or magnetize one magnet into several poles, after assembly of the device. However, most in-situ magnetizers require complicated and costly coil winding fixtures with a pulse magnetizer and a large bank of capacitors. There is therefore a need to provide in-situ magnetic patterning device without the need for AC power and complicated coil winding fixtures.

Embodiments of the present disclosure include an in-situ magnetic patterner without an external power source which solve the aforementioned problems. The magnetic patterner can reverse the magnetic polarity of thin Nd—Fe—B magnets with a low permeance coefficient P_{c} in-situ and form multipole patterns on the thin Nd—Fe—B magnets. These thin magnets may include, for example and without limitation, the N-series of Nd—Fe—B magnets with intrinsic coercivity H_{cj}<13 kOe at room temperature, the M-series or the H-series, and the SH-series with their H_{cj}<13 kOe at moderated temperatures from 40° C. to 100° C., as well as bonded magnets and flexible magnets.

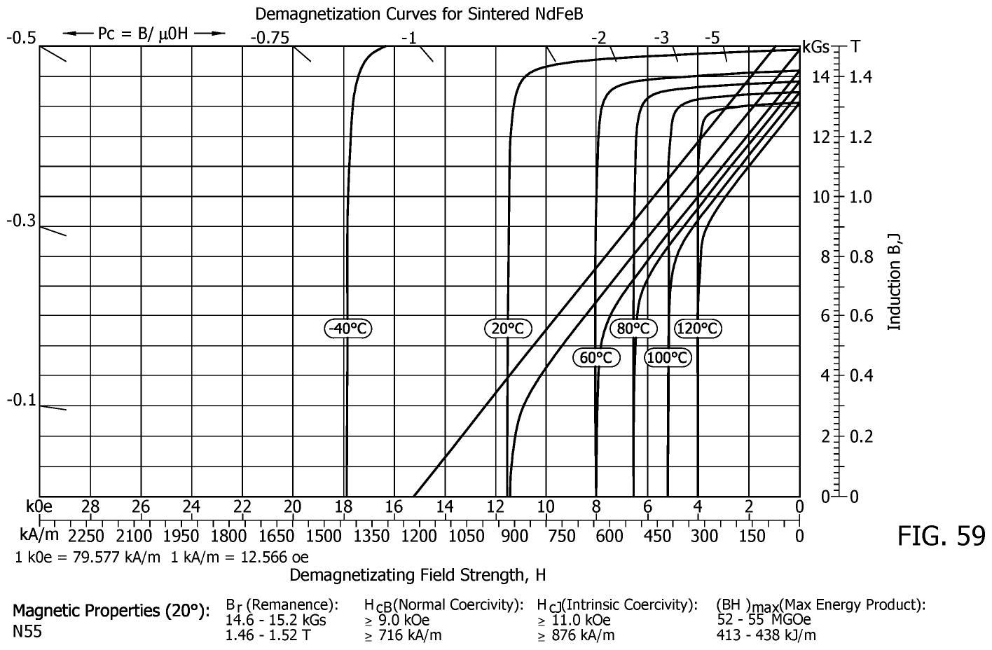

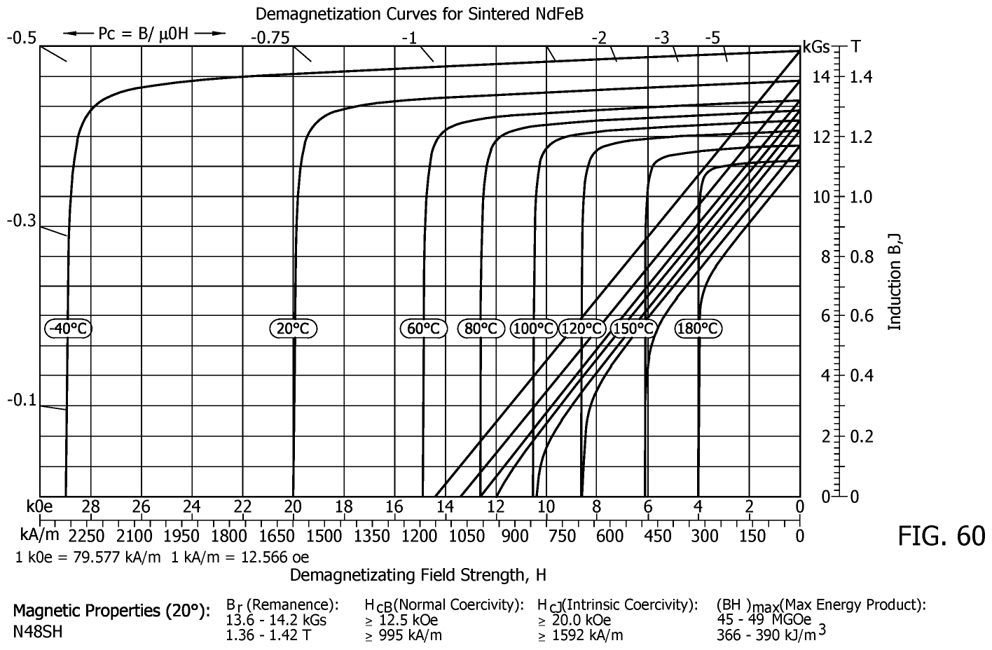

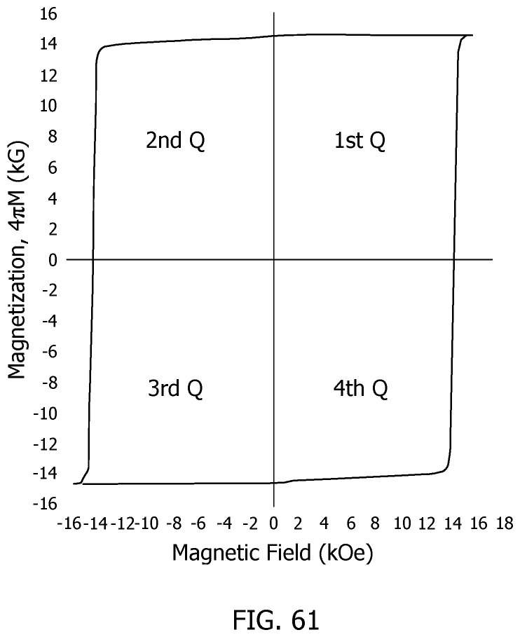

N55-type Nd—Fe—B magnets have H_{cj}<12 kOe at T=20° C. (see FIG. 59), and N48SH has H_{cj}<11 kOe at T=100° C. (see FIG. 60). It has been observed that the polarity of thin N55-type magnets with low P_{c} can be easily reversed by magnets with a high P_{c} at room temperature. An N55 magnet with a very high P_{c} as the magnetizer can therefore magnetically saturate thin magnets (low P_{c}) when the thin magnet is pre-heated at moderate temperatures, e.g., 25° C. for N55 magnets, and 100° C. for N48SH magnets. FIG. 61 shows the intrinsic magnetic hysteresis loop of N52M magnets at T=20° C., which demonstrates the demagnetization from the 2^{nd} quadrant (Q) to the 3^{rd} quadrant (Q) occurs rapidly within 1 kOe (from 13.2 to 14.2 kOe). It can be assumed that all the anisotropic Nd—Fe—B magnets with high energy product have similar demagnetization characteristics. The rapid demagnetization as well as the rapid reverse magnetization are significant as a magnetic field B higher than 14 kG at 20° C. (or a relatively lower B at 40-100° C.) can reverse the magnetic polarity of the magnets with such a demagnetization characteristic. From this, it has been found that one single magnet, or an array of magnets, with a higher P, or even a nearly closed circuit can be used for magnetizing the thin magnet with a low P_{c}. As such, the higher P_{c} magnet or magnets can be assembled into an in-situ magnetic patterner that does not require an external power source. The in-situ magnetic patterner can be used to reverse the magnetic polarity on a thin magnet with a low P_{c} in the areas away from the magnet edge, that is, to form a multipole-pattern on a thin magnet without external AC power source and complicated coil fixtures.

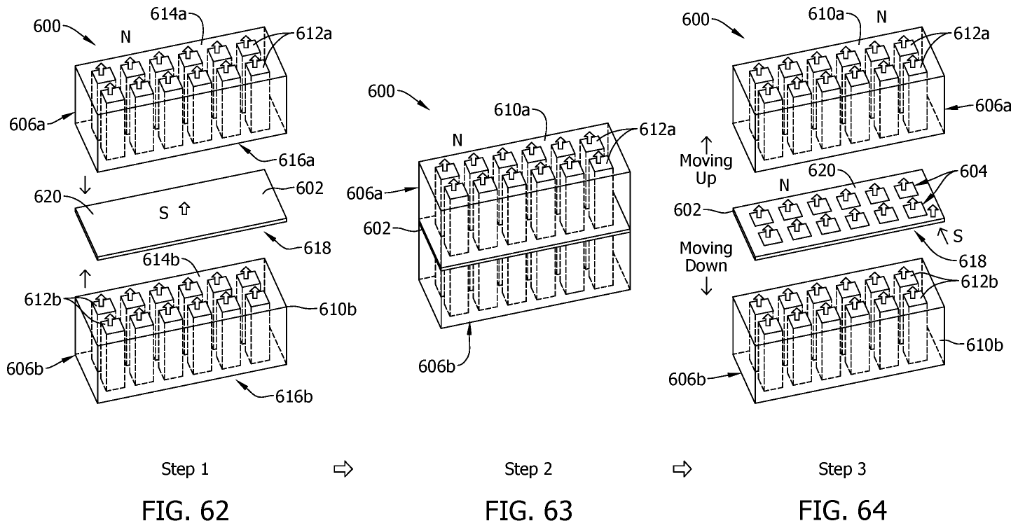

With reference to FIGS. 62-64, an example embodiment of an in-situ magnetic patterner assembly 600 is shown. The patterner assembly 600 is configured to magnetize a thin magnet 602 without the use of an external power source. In particular, the patterner assembly 600 may utilize permanent magnets 612a and 612b to create a localized area of reversed magnetic polarity on the magnet 602 and, in the example embodiment, to create a multi-pole pattern of multiple poles 604 (shown in FIG. 64 on the magnet 602 by creating a plurality of localized areas of reversed magnetic polarity on the magnet 602. Suitably, the magnetizing operation is performed at a temperature sufficient to enable the permanent magnets 612a and 612b to magnetically saturate the magnet 602 at the localized areas without using a power source. The sufficient temperature depends on the demagnetization characteristics of the magnets used as the magnet 602, 612a, and 612b. In some examples, the magnets 602, 612a, and 612b are each N55 magnets, and the magnetizing operation may suitably be performed at a temperature of about 25° C.

The patterner assembly 600 includes a first magnetic patterner 606a and a second magnetic patterner 606b. The first magnetic patterner 606a and the second magnetic patterner 606b each include, respectively, a non-magnetic holder 610a and 610b and a plurality of magnets 612a and 612b. In some embodiments, each patterner 606a and 606b may include a single magnet 612a and 612b. Each of the holders 610a and 610b is rectangularly shaped with a planar top edge 614a and 614b and a planar bottom edge 616a and 616b opposite the respective top edge 614a and 614b. The first magnetic patterner 606a and the second magnetic pattern 606b are vertically aligned such that the bottom edge 616a of the first patterner 606a faces the top edge 614b of the second patterner 606b. The bottom edge 616a of the first patterner 606a and the top edge 614b of the second patterner 606b are spaced apart and the magnet 602 is positioned in the space therebetween. Thereby, the magnet 602 can be sandwiched between the bottom edge 616a and the top edge 614b, and the bottom edge 616a and the top edge 614b are sized and shaped corresponding to the size and shape of thin magnet 602. In particular, the thin magnet 602 extends from a planar surface 618, which faces the top edge 614b, on the N pole side of the magnet 602 to a planar surface 620, which faces the bottom edge 616a, on the S pole side of the magnet 602. The top edge 614b and the bottom edge 616a are sized and shaped corresponding to the size and shape of the planar surfaces 618 and 620.

Each of the magnets 612a and 612b extends longitudinally between the top edge 614a and 614b and the bottom edge 616a and 616b of the respective patterner 606a and 606b. In the example embodiment, each of the magnets 612a and 612b has an elongate, rectangular body that extends between the top edge 614a and 614b and the bottom edge 616a and 616b. The magnetic north (N) pole of each of the magnets 612a and 612b is exposed at the top edge 614a and 614b of the respective patterner 606a and 606b, and the magnetic south (S) pole of each of the magnets is exposed at the bottom edge 616a and 616b of the respective patterner 606a and 606b. In other embodiments, only one of, or neither of, the N pole or S pole of each of the magnets 612a and 612b may be exposed. For example, in one embodiment, the S poles of the magnets 612a in the first patterner 606a are exposed through the bottom edge 616a and the N poles thereof are not exposed, and the N poles of the magnets 612b in the second patterner 606b are exposed through the top edge 614b and the S poles thereof are not exposed.

Each of the magnets 612a is axially aligned with one of the magnets 612b. The magnets 612a are oriented such that the S poles of the magnets 612a face the S pole of the magnet 602 and the magnets 612b are oriented such that the N poles of the magnets 612b face the N pole of the magnet 602. The magnets 612a are spaced apart and the magnets 612b are spaced apart such that the pairs of axially aligned magnets 612a and 612b form an array in a desired arrangement for the multi-pole patterning of the magnet 602. In the example embodiment, the first patterner 606a and the second patterner 606b each include twelve magnets 612a and 612b spaced apart and arranged in a 6×2 array. In other embodiments, any number of magnets 612a and 612b in any desired arrangement may be included in the patterner assembly 600. The area of the cross-section of each of the magnets 612a and 612b along the extension of the magnet 612a and 612b between the top edge 614a and 614b and the bottom edge 616a and 616b, respectively, is significantly smaller than the area of the respective planar surfaces 618 and 620 of the thin magnet 602. Additionally, each pair of axially aligned magnets 612a and 612b suitably have substantially the same cross-sectional area. Thereby, the magnets 612a and 612b are enabled to demagnetize localized areas on the magnet 602, shown as the multiple poles 604 after magnetization in FIG. 64, when the magnets 612a and 612b are positioned adjacent the magnet 602. Each localized area corresponds to the cross-sectional area of a pair of axially aligned magnets 612a and 612b.

The thin magnet 602 to be magnetized by the patterner assembly 600 is suitably an Nd—Fe—B magnet. For example, the magnet 602 is an N55 magnet or an N48SH magnet. In some examples, each of the magnets 612a and 612b are also suitably Nd—Fe—B magnets, such as N55 magnet or an N48SH magnet. The magnet 602 has a relatively low P_{c,602} compared to a relatively high P_{c,612a} of each of the plurality of magnets 612a and a relatively high P_{c,612b} of each of the plurality of magnets 612b. Accordingly, an LD effect based on the P_{c} ratio of these magnets occurs at each localized area when the magnets 612a and 612b are positioned adjacent to, or within a threshold distance of, the respective planar surface 620 and 618 of the magnet 602. Moreover, the type of magnet selected for the magnet 602 is such that the magnet 602 experiences a permanent LD, which is suitable to reverse the magnetic polarity of the magnet 602 at the localized areas thereon. Suitably, the ratio P_{c,612a}/P_{c,602} is above 40, and the ratio P_{c,612b}/P_{c,602} is above 40. The ratio P_{c,612a}/P_{c,602} and the ratio P_{c,612b}/P_{c,602} are not limited to an upper bound range, and each may be as high as about 3,000. The ratio P_{c,612a}/P_{c,602} may also be represented as P_{c,612a}:P_{c,602} and the ratio P_{c,612b}/P_{c,602} may also be represented as P_{c,612b}:P_{c,602}.

The ratio P_{c,612a}/P_{c,602} and the ratio P_{c,612b}/P_{c,602} is achieved by the geometry selected for the thin magnet 602 and each of the plurality of magnets 612a and 612b. The geometries of the magnet 602 and 612a and 612b are not limited and may vary between applications to enable the patterner assembly 600 to function as described herein. In the example embodiment, the magnet 602 has a rectangular shape with a height in the range of about 10 mm to about 50 mm, a width in the range of about 15 mm to about 300 mm, and a length or thickness in the range of about 0.5 mm to about 5 mm. The relatively small P_{c} is achieved by the large width and height relative to a small thickness. All of the magnets 612a and 612b have substantially the same dimensions as one another, with a length in the range of about 10 mm to about 50 mm, a width in the range of about 1 mm to about 8 mm, and a height in the range of about 1 mm to about 8 mm. The relatively large P_{c} of the magnets 612a and 612b is achieved by the large length relative to a small height and width. Accordingly, as described above, the magnets 612a and 612b each have a rectangular cross-section with a relatively small width and height such that the magnets 612a and 612b each present a small surface area at the exposed N and S poles, respectively, relative to a large surface area of the planar surfaces 618 and 620 of the magnet 602. The small surface area presented by the magnets 612a and 612b corresponds to the localized areas on the magnet 602 that are demagnetized to reverse the magnetic polarity thereof and form the poles 604.

As shown in FIG. 62, in operation, the magnet 602 is positioned between the top edge 614b of the second patterner 606b and the bottom edge 616a of the first patterner 606a. The N poles of the magnets 612b at the top edge 614b face the S poles of the magnets 612a at the bottom edge 616a. The magnet 602 has an N pole at the planar surface 618 that faces the top edge 614b, and accordingly faces the N poles of the magnets 612b, and an S pole at the planar surface 620 that faces the bottom edge 616a, and accordingly faces the S poles of the magnets 612a. As shown in FIG. 63, the first and second patterners 606a and 606b are moved vertically towards one another and the magnet 602. Thereby, the axially aligned magnets 612a and 612b contact, or are brought within a threshold distance of, the respective surfaces 620 and 618 of the magnet 602. The magnets 612a and 612b contact, or are kept within the threshold distance of, the magnet 602 for a time sufficient to magnetically saturate the magnet 602 at the localized areas on the magnet 602. The magnetization of the magnet 602 suitably is performed when the magnet 602 is at a temperature sufficient (e.g., 25° C.) to facilitate magnetic saturation of the localized areas using the magnets 612a and 612b. As shown in FIG. 64 after the magnetization as shown in FIG. 63, the first and second patterners 606a and 606b are moved vertically away from the magnet 602, on which the pattern of multiple poles 604 has been formed. In particular, the multiple poles 604 have reversed polarity, with an N pole on the surface 620 and an S pole on the surface 618.

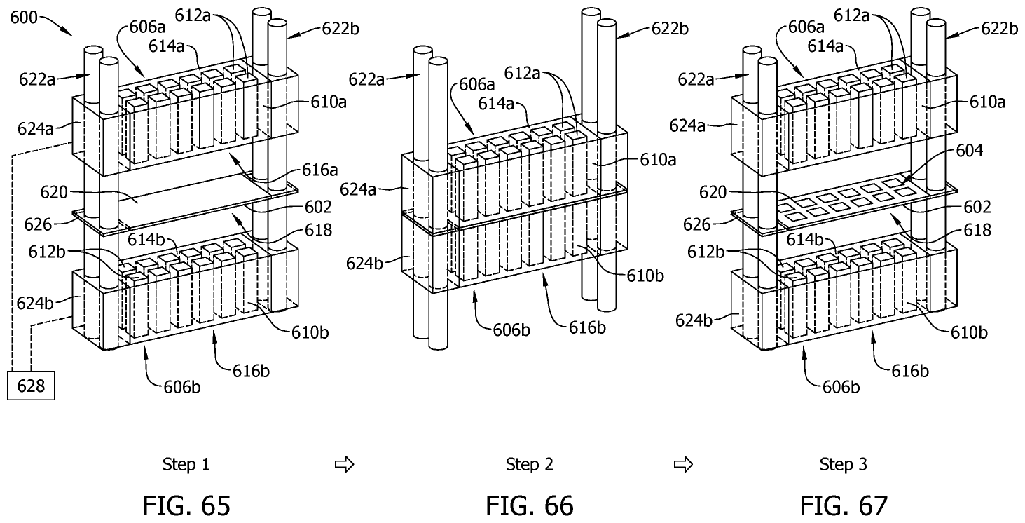

Referring to FIGS. 65-67, the patterner assembly 600 also includes side rails 622a and 622b, patterner frames 624a and 624b, and a support plate 626, each of which is suitably made of a non-magnetic material. The side rails 622a and 622b extend substantially parallel to one another and are spaced apart a distance that corresponds to a width of the magnet 602. In the example embodiment, the side rails 622a and 622b each include a pair of cylindrical rods. The side rails 622a and 622b are oriented to facilitate movement of the patterners 606a and 606b. In the example embodiment, the side rails 622a and 622b are vertically oriented. The patterner frames 624a and 624b are each slidably coupled to and extend between the side rails 622a and 622b. The patterner frame 624a is sized and shaped to receive and support the patterner 606a, and the patterner frame 624b is sized and shaped to receive and support the patterner 606b. The patterner frames 624a and 624b are thereby configured to slide along the side rails 622a and 622b and facilitate movement of the respective patterner 606a and 606b relative to the magnet 602. The support plate 626 is coupled to each of the side rails 622a and 622b and extends therebetween. The support plate 626 is adapted to receive and support the magnet 602. Suitably, the support plate 626 is fixed relative to the side rails 622a and 622b and the patterner frames 624a and 624b.

The patterners 606a and 606b can be moved, by sliding the patterner frames 624a and 624b along the side rails 622a and 622b, between a magnetizing position (shown in FIG. 66), where the magnets 612a and 612b contact, or are located adjacent to and positioned within a threshold distance of, the magnet 602, and an idle position (shown in FIGS. 65 and 67), where the magnets 612a and 612b are spaced from the magnet 602. As shown in FIG. 65, the patterner assembly 600 includes an actuator 628 operably coupled to the each of the patterner frames 624a and 624b. The actuator 628 is operable to move the patterner frames 624a and 624b along the side rails 622a and 622b, thereby selectably moving the first and second patterners 606a and 606b between the magnetizing position and the idle position. The actuator 628 may be controlled by a user via a controller (not shown). Non-limiting examples of suitable actuators 628 include hydraulic cylinders, pistons, electric rotary motors, and pneumatic linear actuators. In some embodiments, the actuator 628 may be operably coupled to one of the patterner frames 624a and 624b. Alternatively, multiple actuators 628 may be utilized, for example, a separate actuator 628 may be coupled to each of the patterner frames 624a and 624b.

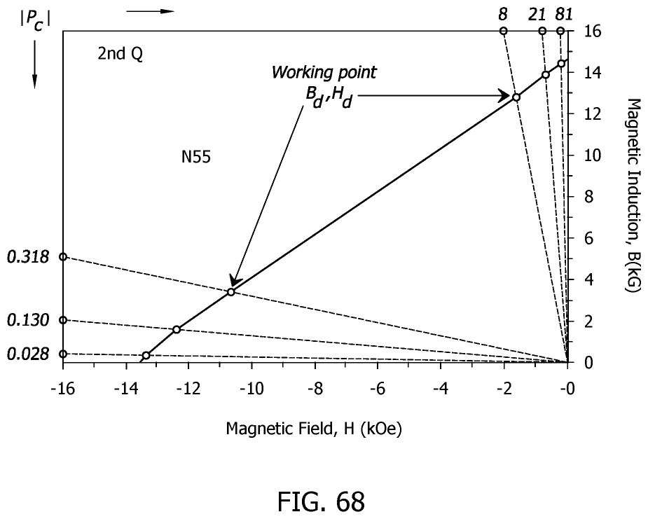

FIG. 68 shows the B-H curve for N55 magnets suitable for use as the magnet 602 and the magnets 612a and 612b. The working points (B_{d}, H_{d}) are marked on the B-H curve for six load lines with P_{c}=0.028, 0.13, 0.318, 8, 21, and 81, where P_{c}=|B_{d}/H_{d}|. The working points for the three P_{c}=0.028, 0.13, and 0.318 are for N55 magnets suitable for use as the magnet 602, and the working points for the three P_{c}=8, 21, and 81 are for N55 magnets suitable for use as the magnets 612a and 612b. For the magnet 602, N55 magnets having a P_{c}=0.028 may have a length of about 20 mm, a width of about 52 mm, and a thickness of about 0.5 mm, and the P_{c}=0.028 corresponds to a B_{d}=0.35 KG; N55 magnets having a P_{c}=0.13 may have a length of about 20 mm, a width of about 52 mm, and a thickness of about 2.2 mm, and the P_{c}=0.13 corresponds to a B_{d}=1.6 kG; and N55 magnets having a P_{c}=0.318 may have a length of about 20 mm, a width of about 52 mm, and a thickness of about 5.0 mm, and the P_{c}=0.318 corresponds to a B_{d}=3.4 kG. For the magnets 612a and 612b, N55 magnets having a P_{c}=8 may have a length of about 5 mm, a width of about 5 mm, and a thickness of about 10 mm, and the P_{c}=8 corresponds to a B_{d}=12.9 kG; N55 magnets having a P_{c}=21 may have a length of about 5 mm, a width of about 5 mm, and a thickness of about 20 mm, and the P_{c}=21 corresponds to a B_{d}=13.9 kG; and N55 magnets having a P_{c}=81 may have a length of about 5 mm, a width of about 5 mm, and a thickness of about 50 mm, and the P_{c}=81 corresponds to a B_{d}=14.4 kG.

The embodiments described above and illustrated in FIGS. 62-67 can have various physical implementations to provide technical advantages therein. Multipole magnetization can be efficiently provided in fixtures housing small, thin magnets. In devices using small, thin magnets (e.g., keyboards or small Hall effect sensors), the magnets may either be pre-magnetized prior to being positioned in the device, or may be magnetized during the manufacturing process after being installed in the device fixture. When pre-magnetized magnets are installed, problems associated with adjacent magnetic fields and mechanical stresses as described above may result. Using permanent magnets in an in-situ magnetizer facilitates process and manufacturing improvements for such devices.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense. Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-20. (canceled)

21. A magnetic assembly comprising:
a first plate comprising at least one tapered magnet having a base secured to the first plate and extending outward from the first plate to a tip, the at least one tapered magnet having a first permeance coefficient (P_{c1}) and comprising a magnetic north (N) pole and a magnetic south (S) pole; and
a second plate comprising at least one ring magnet defining an opening sized and shaped to receive the tip of the at least one tapered magnet therein, the at least one ring magnet having a second permeance coefficient (P_{c2}) and comprising an N pole and an S pole, wherein the at least one tapered magnet and the at least one ring magnet are oriented with like poles facing one another;
wherein a ratio of P_{c1}:P_{c2} is greater than 1 such that, when the tip of the at least one tapered magnet is inserted into the opening of the at least one ring magnet beyond a threshold depth, a magnetic repulsive force between the at least one ring magnet and the at least one tapered magnet transitions to a magnetic attractive force to releasably secure the second plate to the first plate.

22. The magnetic assembly of claim 21, wherein the first plate comprises four tapered magnets, and wherein the second plate comprises four ring magnets, each ring magnet defining an opening, wherein the opening of each ring magnet receives the tip of a corresponding one of the tapered magnets to releasably secure the second plate to the first plate.

23. The magnetic assembly of claim 22, wherein each of the four tapered magnets is positioned adjacent a respective corner of the first plate, and wherein each of the four ring magnets is positioned adjacent a respective corner of the second plate.

24. The magnetic assembly of claim 21, wherein the second plate is moveable relative to the first plate between:
a first position, in which the tip of the at least one tapered magnet is inserted into the opening of the at least one ring magnet beyond the threshold depth; and
a second position, in which the tip of the at least one tapered magnet is removed from the opening of the at least one ring magnet passed the threshold depth.

25. The magnetic assembly of claim 24, wherein, in the first position, the like poles of the at least one ring magnet and the at least one tapered magnet magnetically attract each other to secure the second plate to the first plate, and wherein in the second position, the like poles of the at least one ring magnet and the at least one tapered magnet magnetically repel each other to release the second plate from the first plate.

26. The magnetic assembly of claim 21, wherein the ratio of P_{c1}:P_{c2} is greater than 2.

27. The magnetic assembly of claim 21, wherein the ratio of P_{c1}:P_{c2} is within a range of 2 to 300.

28. The magnetic assembly of claim 21, wherein the at least one tapered magnet and the at least one ring magnet are each an Nd—Fe—B magnet.

29. The magnetic assembly of claim 21, wherein the at least one tapered magnet is a conical magnet.

30. The magnetic assembly of claim 21, wherein the at least one tapered magnet is a pyramidal magnet.

31. A magnetic assembly comprising:
at least one tapered magnet having a base and extending to a tip, the at least one tapered magnet having a first permeance coefficient (P_{c1}) and comprising a magnetic north (N) pole and a magnetic south (S) pole; and
at least one ring magnet having an opening sized and shaped to receive the tip of the at least one tapered magnet therein, the at least one ring magnet having a second permeance coefficient (P_{c2}) and comprising an N pole and an S pole, wherein the at least one tapered magnet and the at least one ring magnet are oriented with like poles facing one another;
wherein a ratio of P_{c1}:P_{c2} is greater than 1 such that, when the tip of the at least one tapered magnet is inserted into the opening of the at least one ring magnet beyond a threshold depth, a magnetic repulsive force between the at least one ring magnet and the at least one tapered magnet transitions to a magnetic attractive force to releasably secure the at least one ring magnet to the at least one tapered magnet.

32. The magnetic assembly of claim 31, wherein the magnet assembly is adjustable between:
a first position, in which the tip of the at least one tapered magnet is inserted into the opening of the at least one ring magnet beyond the threshold depth; and
a second position, in which the tip of the at least one tapered magnet is removed from the opening of the at least one ring magnet passed the threshold depth.

33. The magnetic assembly of claim 32, wherein, in the first position, the like poles of the at least one ring magnet and the at least one tapered magnet magnetically attract each other, and wherein in the second position, the like poles of the at least one ring magnet and the at least one tapered magnet magnetically repel each other.

34. The magnetic assembly of claim 31, wherein the magnet assembly is adjustable between:
a first position, in which the at least one tapered magnet is axially aligned with the at least one ring magnet; and
a second position, in which the at least one tapered magnet is axially offset from the at least one ring magnet.

35. The magnetic assembly of claim 34, wherein, in the first position, the tip of the at least one tapered magnet is inserted into the opening of the at least one ring magnet beyond the threshold depth and the like poles of the at least one ring magnet and the at least one tapered magnet magnetically attract each other, and wherein in the second position, the like poles of the at least one ring magnet and the at least one tapered magnet magnetically repel each other.

36. The magnetic assembly of claim 31, wherein the ratio of P_{c1}:P_{c2} is within a range of 2 to 300.

37. The magnetic assembly of claim 31, wherein the at least one tapered magnet and the at least one ring magnet are each an Nd—Fe—B magnet.

38. The magnetic assembly of claim 31, wherein the at least one tapered magnet is a conical magnet.

39. The magnetic assembly of claim 31, wherein the at least one tapered magnet is a pyramidal magnet.

40. A method of assembling a magnetic assembly, the method comprising:
providing a first plate comprising at least one tapered magnet having a base secured to the first plate and extending outward from the first plate to a tip, the at least one tapered magnet having a first permeance coefficient (P_{c1}) and comprising a magnetic north (N) pole and a magnetic south (S) pole; and
securing a second plate to the first plate, the second plate comprising at least one ring magnet defining an opening sized and shaped to receive the tip of the at least one tapered magnet therein, the at least one ring magnet having a second permeance coefficient (P_{c2}) and comprising an N pole and an S pole, wherein the at least one tapered magnet and the at least one ring magnet are oriented with like poles facing one another, wherein a ratio of P_{c1}:P_{c2} is greater than 1;
wherein securing the second plate to the first plate comprises inserting the tip of the at least one tapered magnet into the opening of the at least one ring magnet beyond a threshold depth such that a magnetic repulsive force between the at least one ring magnet and the at least one tapered magnet transitions to a magnetic attractive force to releasably secure the second plate to the first plate.

41-100. (canceled)
